(19) United States
(12) Patent Application Publication
(10) Pub. No.: US 2025/0184028 A1
(43) Pub. Date: Jun. 5, 2025

(54) SEPARATION SYSTEM

(71) Applicant: NIPPON TELEGRAPH AND TELEPHONE CORPORATION, Tokyo (JP)

(72) Inventor: Manabu YOSHINO, Musashino-shi (JP)

(73) Assignee: NIPPON TELEGRAPH AND TELEPHONE CORPORATION, Tokyo (JP)

(21) Appl. No.: 18/842,590

(22) PCT Filed: Mar. 1, 2022
(86) PCT No.: PCT/JP2022/008625

§ 371 Date: Aug. 29, 2024

(51) Int. Cl. H04J 14/02; H04B 10/079

(52) U.S. Cl. CPC H04J 14/02; H04B 10/079

(57) ABSTRACT

An aspect of the present invention is a separation system including a separation unit that separates a first signal having a first wavelength and a second signal having a second wavelength that is a wavelength excluding the first wavelength from an input optical signal, and a detection unit that detects intensity of the second signal.

### TECHNICAL FIELD

The present invention relates to a technology of a separation system.

### BACKGROUND ART

In recent years, there has been a demand for achievement of a transparent low-delay optical access network by a photonic gateway (hereinafter referred to as “PG”) (see, for example, Non Patent Literature 1). A plurality of user devices is connected to the PG, and a wavelength to be used is set for each user device. Note that, in the following description, when an optical signal flows from a transmission source to a transmission destination, a position relatively close to the transmission source is referred to as a “preceding stage”, and a position relatively close to the transmission destination is referred to as a “subsequent stage”.

### CITATION LIST

### Non Patent Literature

Non Patent Literature 1: “All photonics network no jitsugen ni muketa aratana system architecture (in Japanese) (New system architecture for achieving all photonics network”, Journal of the Institute of Electronics, Information and Communication Engineers Vol. 104 No. 5 pp. 471-477, 2021, <URL: https://www.journal.ieice.org/bin/pdf_link.php?fname=k104_5_471&lang=J&year=2021>

### SUMMARY OF INVENTION

### Technical Problem

In a transparent network, at least any light (hereinafter referred to as improper light) that is of unacceptable intensity or includes wavelengths other than configured needs to be prevented from passing.

The improper light may be input from a user device that is not under control, for example. However, it is not possible to implement a function of detecting an improper signal or a function of preventing (stopping) passage of an improper signal in the network by the PG. Such a problem is not limited to the network by the PG, but is a problem common to the entire transparent network.

In view of the above circumstances, an object of the present invention is to provide a technology capable of detecting an improper signal in a transparent network and preventing the improper signal from flowing to a device in a subsequent stage.

### Solution to Problem

An aspect of the present invention is a separation system including a separation unit that separates a first signal having a first wavelength and a second signal having a second wavelength that is a wavelength excluding the first wavelength from an input optical signal, and a detection unit that detects intensity of the second signal.

An aspect of the present invention is a separation system including a separation unit that separates a first signal having a first wavelength and a second signal having a second wavelength that is a wavelength excluding the first wavelength from an input optical signal, and a discarding unit that discards the second signal so as not to be mixed with the first signal.

### Advantageous Effects of Invention

According to the present invention, it is possible to detect an improper signal in a transparent network and prevent the improper signal from flowing to a device in a subsequent stage.

### BRIEF DESCRIPTION OF DRAWINGS

FIG. 1 is a diagram illustrating a system configuration example of a first embodiment (an optical cross-connect system 10a) of an optical cross-connect system 10 of the present invention.

FIG. 2 is a diagram illustrating an outline of intensity of an optical signal having each wavelength in a separation system 11a.

FIG. 3 is a diagram illustrating an outline of a suppression ratio of a filter in a separation unit 21.

FIG. 4 is a diagram illustrating a first specific example of a configuration of a separation system 11a.

FIG. 5 is a diagram illustrating a second specific example of the configuration of the separation system 11a.

FIG. 6 is a diagram illustrating a fifth specific example of the configuration of the separation system 11a.

FIG. 7 is a diagram illustrating a sixth specific example of the configuration of the separation system 11a.

FIG. 8 is a diagram illustrating a seventh specific example of the configuration of the separation system 11a.

FIG. 9 is a diagram illustrating a specific example of a positional relationship between devices in the first embodiment (optical cross-connect system 10a) of the optical cross-connect system 10.

FIG. 10 is a diagram illustrating a specific example of a positional relationship between devices in the first embodiment (optical cross-connect system 10a) of the optical cross-connect system 10.

FIG. 11 is a diagram illustrating a specific example of a positional relationship between devices in the first embodiment (optical cross-connect system 10a) of the optical cross-connect system 10.

FIG. 12 is a diagram illustrating a specific example of a positional relationship between devices in the first embodiment (optical cross-connect system 10a) of the optical cross-connect system 10.

FIG. 13 is a diagram illustrating a specific example of a positional relationship between devices in the first embodiment (optical cross-connect system 10a) of the optical cross-connect system 10.

FIG. 14 is a diagram illustrating a specific example of a positional relationship between devices in the first embodiment (optical cross-connect system 10a) of the optical cross-connect system 10.

FIG. 15 is a diagram illustrating a specific example of a positional relationship between devices in the first embodiment (optical cross-connect system 10a) of the optical cross-connect system 10.

FIG. 16 is a diagram illustrating a specific example of a positional relationship between devices in the first embodiment (optical cross-connect system 10a) of the optical cross-connect system 10.

FIG. 17 is a diagram illustrating a specific example of a positional relationship between devices in the first embodiment (optical cross-connect system 10a) of the optical cross-connect system 10.

FIG. 18 is a diagram illustrating a specific example of a positional relationship between devices in the first embodiment (optical cross-connect system 10a) of the optical cross-connect system 10.

FIG. 19 is a diagram illustrating a configuration example using an optical fuse.

FIG. 20 is a diagram illustrating a configuration example using an optical fuse.

FIG. 21 is a diagram illustrating a configuration example using an optical fuse.

FIG. 22 is a diagram illustrating a configuration example using an optical fuse.

FIG. 23 is a diagram illustrating a configuration example using an optical fuse.

FIG. 24 is a diagram illustrating a configuration example using an optical fuse.

FIG. 25 is a diagram illustrating a configuration example using an optical monitor.

FIG. 26 is a diagram illustrating a configuration example using an optical monitor.

FIG. 27 is a diagram illustrating a first configuration example in which the separation unit 21 is configured using fiber bragg grating (FBG).

FIG. 28 is a diagram illustrating a second configuration example in which the separation unit 21 is configured using FBGs.

FIG. 29 is a diagram illustrating a third configuration example in which the separation unit 21 is configured using FBGs.

FIG. 30 is a diagram illustrating a fourth configuration example in which the separation unit 21 is configured using FBGs.

FIG. 31 is a diagram illustrating a fifth configuration example in which the separation unit 21 is configured using FBGs.

FIG. 32 is a diagram illustrating a sixth configuration example in which the separation unit 21 is configured using FBGs.

FIG. 33 is a diagram illustrating a seventh configuration example in which the separation unit 21 is configured using FBGs.

FIG. 34 is a diagram illustrating an eighth configuration example in which the separation unit 21 is configured using FBGs.

FIG. 35 is a diagram illustrating a first configuration example in which the separation unit 21 is configured using a thin film filter (TFF).

FIG. 36 is a diagram illustrating a second configuration example in which the separation unit 21 is configured using a TFF.

FIG. 37 is a diagram illustrating a third configuration example in which the separation unit 21 is configured using a TFF.

FIG. 38 is a diagram illustrating a configuration example of a TFF 214 with oblique incidence.

FIG. 39 is a diagram illustrating a fourth configuration example in which the separation unit 21 is configured using a TFF.

FIG. 40 is a diagram illustrating a fifth configuration example in which the separation unit 21 is configured using a TFF.

FIG. 41 is a diagram illustrating a sixth configuration example in which the separation unit 21 is configured using a TFF.

FIG. 42 is a diagram illustrating a seventh configuration example in which the separation unit 21 is configured using a TFF.

FIG. 43 is a diagram illustrating an eighth configuration example in which the separation unit 21 is configured using a TFF.

FIG. 44 is a diagram illustrating a first configuration example in which the separation unit 21 is configured using an arrayed-waveguide grating (AWG).

FIG. 45 is a diagram illustrating a second configuration example in which the separation unit 21 is configured using an AWG.

FIG. 46 is a diagram illustrating a third configuration example in which the separation unit 21 is configured using an AWG.

FIG. 47 is a diagram illustrating a fifth configuration example in which the separation unit 21 is configured using AWGs.

FIG. 48 is a diagram illustrating a sixth configuration example in which the separation unit 21 is configured using AWGs.

FIG. 49 is a diagram illustrating a seventh configuration example in which the separation unit 21 is configured using AWGs.

FIG. 50 is a diagram illustrating an eighth configuration example in which the separation unit 21 is configured using an AWG.

FIG. 51 is a diagram illustrating a ninth configuration example in which the separation unit 21 is configured using an AWG.

FIG. 52 is a diagram illustrating a tenth configuration example in which the separation unit 21 is configured using an AWG.

FIG. 53 is a diagram illustrating a twelfth configuration example in which the separation unit 21 is configured using AWGs.

FIG. 54 is a diagram illustrating a thirteenth configuration example in which the separation unit 21 is configured using AWGs.

FIG. 55 is a diagram illustrating a fourteenth configuration example in which the separation unit 21 is configured using AWGs.

FIG. 56 is a diagram illustrating a modification of the first embodiment of the separation system 11a.

FIG. 57 is a diagram illustrating a modification of the first embodiment of the separation system 11a.

FIG. 58 is a diagram illustrating a modification of the first embodiment of the separation system 11a.

FIG. 59 is a diagram illustrating a first configuration example in which the separation unit 21 in the modification is configured using an AWG.

FIG. 60 is a diagram illustrating a second configuration example in which the separation unit 21 in the modification is configured using an AWG.

FIG. 61 is a diagram illustrating a modification of the AWG.

FIG. 62 is a diagram illustrating a configuration example of the separation unit 21 configured using a modification of the AWG.

FIG. 63 is a diagram illustrating a configuration example of the separation unit 21 configured using a modification of the AWG.

FIG. 64 is a diagram illustrating a specific example of the separation unit 21 configured using a reflection type diffraction grating.

FIG. 65 is a diagram illustrating a specific example of the separation unit 21 configured using a reflection type diffraction grating.

FIG. 66 is a diagram illustrating a first configuration example in which the separation unit 21 is configured using a waveguide-type ring resonator.

FIG. 67 is a diagram illustrating a second configuration example in which the separation unit 21 is configured using a waveguide-type ring resonator type ring resonator.

FIG. 68 is a diagram illustrating a first configuration example in which the separation unit 21 is configured using a lattice-type optical filter.

FIG. 69 is a view illustrating a second configuration example in which the separation unit 21 is configured using the lattice-type optical filter.

FIG. 70 is a diagram illustrating a specific example of a configuration in a case where the separation unit 21 is configured using separation units having high polarization dependency.

FIG. 71 is a diagram illustrating a system configuration example of a second embodiment (optical cross-connect system 10b) of an optical cross-connect system 10 of the present invention.

FIG. 72 is a diagram illustrating a first specific example of a configuration of a separation system 11b.

FIG. 73 is a diagram illustrating a third specific example of the configuration of the separation system 11b.

FIG. 74 is a diagram illustrating a system configuration example of a third embodiment (optical cross-connect system 10c) of an optical cross-connect system 10 of the present invention.

FIG. 75 is a diagram illustrating a system configuration example of a fourth embodiment (optical cross-connect system 10d) of an optical cross-connect system 10 of the present invention.

FIG. 76 is a diagram illustrating a first specific example of a configuration of a separation system 11d.

FIG. 77 is a diagram illustrating a third specific example of the configuration of the separation system 11d.

FIG. 78 is a diagram illustrating a modification of the second embodiment of the separation system 11b.

FIG. 79 is a diagram illustrating a modification of the fourth embodiment of the separation system 11d.

FIG. 80 is a diagram illustrating another specific example of a configuration of the separation system 11a.

### DESCRIPTION OF EMBODIMENTS

Embodiments of the present invention will be described in detail with reference to the drawings.

An optical cross-connect system 10 according to the present invention is a device that outputs a desired signal from an input optical signal and routes the signal to a destination.

The optical cross-connect system 10 is used for a transparent network. As a specific example of the transparent network, for example, there is a network by a PG. Hereinafter, the optical cross-connect system 10 used for the PG will be described as an embodiment of the optical cross-connect system 10. However, the optical cross-connect system 10 may be applied to any network as long as the network is a transparent network as described above, and is not necessarily limited to an application to the network by the PG as described below. Further, in the optical cross-connect system 10 described below, each separation system 11 is applied in a mechanism for instructing a wavelength to user equipment, but the separation system 11 of the present invention is not necessarily limited to such a mechanism.

One or more user devices are connected to one side of the PG. A predetermined wavelength is set by the PG in each user device under the control of the PG. Each user device under control of the PG transmits an optical signal of a set wavelength according to a predetermined criterion, such as signal intensity. On the other side of the PG, a user device (hereinafter referred to as “opposing device”) to be a communication destination is located. The optical signal transmitted from each user device is output to an appropriate route by an optical cross-connect device of the PG, and is routed to the destination opposing device.

In the following description, a position relatively close to an opposing device will be referred to as a “first side”, and a position relatively close to a user device that is a transmission source of an optical signal to be processed will be referred to as a “second side”.

### First Embodiment

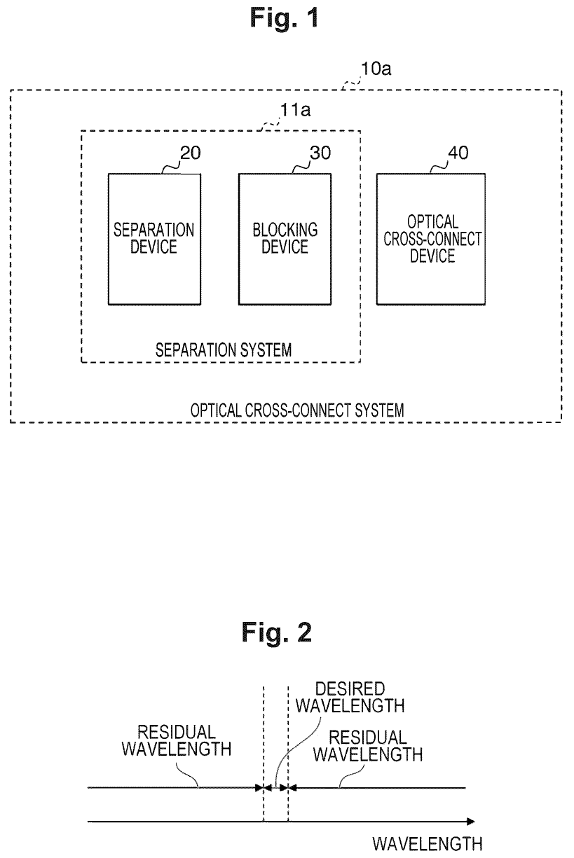

FIG. 1 is a diagram illustrating a system configuration example of a first embodiment (an optical cross-connect system 10a) of an optical cross-connect system 10 of the present invention. The optical cross-connect system 10a includes a separation system 11a and an optical cross-connect device 40. The separation system 11a includes a separation device 20 and a blocking device 30.

The separation device 20 processes an optical signal (hereinafter referred to as a “separation input signal”) input to the own device. In the following description, a desired wavelength indicates a proper wavelength range, and a residual wavelength indicates a wavelength range other than the desired wavelength.

Note that the proper wavelength range varies depending on the wavelength that can be used by the user device. For example, at the time of initial connection (in a state where the wavelength is not set in the user device), the wavelength range that may be used for the initial connection is the proper wavelength range, and after the wavelength is set in the user device after the initial connection, the set wavelength range becomes the proper wavelength range.

FIG. 2 is a schematic diagram of a desired wavelength and a residual wavelength in a case where the desired wavelength in the separation system 11a is one wavelength. Note that the desired wavelength may be a plurality of wavelengths as in Examples described later.

A desired signal is an optical signal either having an intensity less than a threshold at which the intensity meets the appropriate intensity or having an intensity of a residual wavelength component less than a threshold of proper to the wavelength, or both.

Note that a proper optical signal is also referred to as “proper light” in the following description.

A residual signal is an optical signal of at least one of having an intensity equal to or more than a threshold of proper to the intensity or having an intensity of a residual wavelength component equal to or more than a threshold of proper to the wavelength. Note that the improper optical signal is also referred to as “improper light” in the following description.

As an example of the threshold of proper to the intensity, for example, a value at which the transmission line (optical fiber), the optical cross-connect device constituting the optical cross-connect system, the device in the subsequent stage such as the corresponding device of the user device, or the like is not damaged, for example, 10 dBm (10 mW) or the like may be used. As an example of the threshold of proper to the wavelength, a value at which the influence on communication or communication quality of another user device in which the residual wavelength is the desired wavelength is tolerable, for example, a value at which the intensity of the residual wavelength of the signal input or output to the separation device is sufficiently smaller than an OFF level in a case where another user performs the ON/OFF modulation, or a value at which the intensity of the residual wavelength after blocking by blocking capability of the residual wavelength in a demultiplexer multiplexed with a signal of another user is sufficiently small, for example, −20 dBm (0.01 mW) or the like may be used. The ratio of the intensity of the residual wavelength to the intensity of the desired wavelength may be a sufficiently small value, for example, a value of −20 dB ( 1/100) or less.

The separation device 20 wavelength-separates an optical signal having a desired wavelength (hereinafter referred to as a “desired separation signal”) and an optical signal having a residual wavelength (hereinafter referred to as a “residual separation signal”) from the separation input signal. For example, the separation device 20 may be configured to include a separation unit 21 and a detection unit 22 as described later.

In separation processing in the separation unit 21 of the separation device 20 of the separation system 11a, the desired signal and the residual signal are wavelength-separated from the separation input signal. The optical signal separated as the desired signal in the separation processing is hereinafter referred to as a “desired separation signal”. The optical signal separated as the residual signal is hereinafter referred to as a “residual separation signal”. Depending on characteristics (suppression ratio and blocking capability) of the filter used in the separation processing, in a case where there is a component of the residual wavelength, the component of the residual wavelength may be slightly mixed into the desired separation signal, and in a case where there is a component of the desired wavelength, the component of the desired wavelength may be slightly mixed into the residual separation signal. However, if the ratio of the desired signal to the separation input signal is significantly large, the desired signal occupies most of the desired separation signal and the residual separation signal, and if the ratio of the residual signal to the separation input signal is significantly large, the residual signal occupies most of the desired separation signal and the residual separation signal. This can also occur depending on a suppression ratio of the filter.

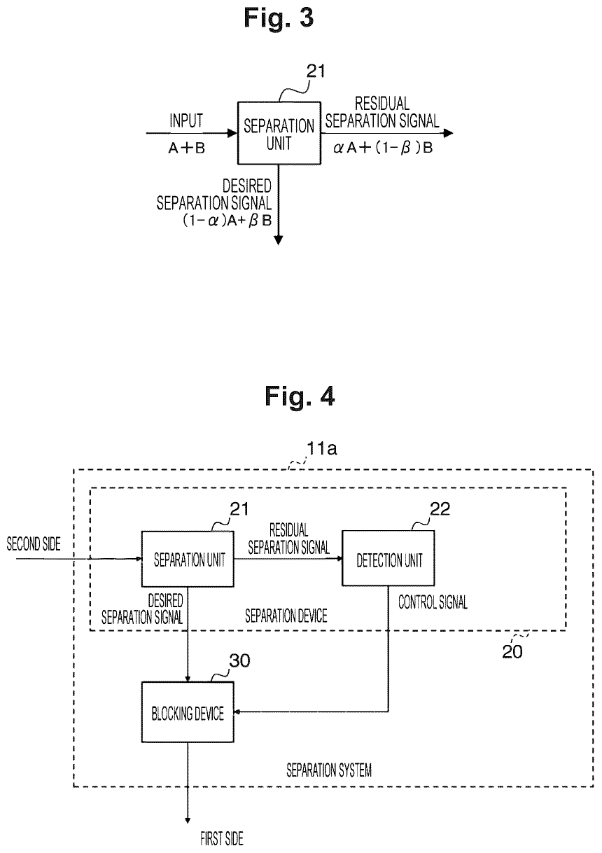

FIG. 3 is a diagram schematically illustrating wavelength separation of the separation unit 21 of the separation device 20 of the separation system 11a. The light intensity of the component of the desired wavelength in the optical signal (separation input signal) before being separated by the separation unit 21 is defined as A, the ratio at which the component of the desired wavelength is separated as the residual separation signal is defined as a, the ratio at which the component of the desired wavelength is separated as the desired separation signal is defined as (1−α), the light intensity of the component of the residual wavelength in the optical signal (separation input signal) before being separated by the separation unit 21 is defined as B, the ratio at which the component of the residual wavelength is separated as the desired separation wavelength is defined as B, and the ratio at which the residual signal is separated as the residual separation signal is defined as (1−β).

In the case of FIG. 3, the light intensity of the residual separation signal after separation by the separation unit 21 is αA+(1−β)B. The light intensity of the desired separation signal after separation by the separation unit 21 is (1−α)A+βB. A value obtained by multiplying the light intensity of the desired separation signal by α/(1−α) is subtracted from the light intensity of the residual separation signal. As a result, intensity B of the residual signal is expressed as follows.

$$( α A + ( 1 - β ) B ) - α / ( 1 - α ) ( ( 1 - α ) A + β B ) = ( 1 - β ) B - β / ( 1 - α )$$

$$B = ( 1 - β ( 1 - 1 / ( 1 - α ) ) B \approx B$$

Note that (1−β(1−1/(1−α)) is approximated to 1 with α<<1 and β<<1.

Note that, in a case where the intensity of the optical signal before being separated in the separation unit 21 is obtained by an optical monitor 92, the intensity B of the residual signal may be expressed as follows.

$$B \approx ( 1 - α ) B = ( α A + B ) - α ( A + B )$$

Note that the intensity B of the residual signal before being separated in the separation unit 21 may be expressed as follows.

### Intensity B of Improper Light Before Separation

=(output value of detection unit)−(proper light output ratio α of improper light-side output port of separation unit)/(proper light output ratio (1−α) of proper light-side output port of separation unit)×(monitored value of proper light-side output port of separation unit)
=(output value of detection unit)−(proper light output ratio α of improper light-side output port of separation unit)/(proper light output ratio (1−α) of proper light-side output port of separation unit)×{(proper light output ratio (1−α) of proper light-side output port of separation unit)×(intensity A of proper light before separation)+(improper light output ratio B of proper light-side output port of separation unit)×(intensity B of improper light before separation)}
≈(output value of detection unit)−(proper light output ratio α of improper light-side output port of separation unit)/(proper light output ratio (1−α) of proper light-side output port of separation unit)×{(proper light output ratio (1−α) of proper light-side output port of separation unit)×(intensity A of proper light before separation)}
=(output value of detection unit)−(proper light output ratio α of improper light-side output port in separation unit)×(intensity A of proper light before separation)

Note that it is assumed that the power of optical signals (residual signals) other than light having a desired wavelength is sufficiently small, and the suppression ratio of the residual optical signals is ignored. That is, it is assumed that light having a wavelength other than the proper wavelength before separation is sufficiently weak as compared to light having the proper wavelength, and imperfection of suppression of light having a wavelength other than the proper wavelength in the separation unit 21 is ignored.

When the intensity of the residual separation signal is equal to or more than a predetermined intensity, the separation system 11a including the blocking device 30 blocks the separation input signal or the desired separation signal separated from the separation input signal. Note that the predetermined intensity value (threshold) related to the wavelength may be set so that leakage of the residual signal into the desired separation signal is equal to or less than a predetermined intensity in consideration of the characteristics of the filter.

In the following description, the “predetermined intensity” refers to, in a case where it relates to the intensity of light of a signal, allowable high intensity, for example, a value at which there is a high risk of damaging equipment in the subsequent stage, or intensity that is prescribed in Article 19 of the Regulations of Telecommunications Equipment for Business (Prevention of Damage) and is considered to have a risk of damaging telecommunication equipment connected by a user or another telecommunication carrier. In addition, the predetermined intensity value (threshold) related to the wavelength may be, for example, an intensity equal to or lower than a noise level or equal to or lower than an OFF level in a case of IM-DD.

Even when the separation input signal includes only the optical signal having the desired wavelength (when not including the signal having the residual wavelength), when the intensity of the separation input signal exceeds an appropriate value (when it is equal to or more than the predetermined intensity), the separation system 11a including the blocking device 30 blocks the separation input signal or the optical signal (desired separation signal) separated from the separation input signal.

The separation device 20 detects the light intensity of the separated residual separation signal. Upon detecting the residual separation signal with a predetermined light intensity or more, the separation device 20 outputs a control signal indicating that the optical signal input to the blocking device 30 is blocked to the blocking device 30. When not blocking (that is, when the control signal indicating block is not input), the blocking device 30 allows the input optical signal to pass. The optical signal having passed through the blocking device 30 is input to a device connected to a subsequent stage of the blocking device 30. When receiving a control signal indicating block from the separation device 20, the blocking device 30 blocks the optical signal input to the own device. In this case, the optical signal input to the blocking device 30 is not input to the device connected to the subsequent stage. As a result, the desired signal included in the blocked optical signal (the optical signal including the improper optical signal) does not reach the destination.

Note that the blocking device 30 may be configured, when the control signal indicating block is input and block is performed, to continue block until a control signal indicating release of block is input even if the control signal indicating block is no longer input, or may be configured to continue block as long as the control signal indicating block is input and release the block when the control signal is no longer input.

Furthermore, the separation device 20 may be configured to communicate with the control unit using any signal. For example, the separation device 20 may communicate with the control unit by using an optical signal that is superimposed on an optical signal (main signal) used by a user signal and has a wavelength used for initial connection at the time of initial connection (a state in which a wavelength is not set in the user device), may communicate with the control unit by using an optical signal having a wavelength (desired wavelength) after the wavelength is set in the user device, or may communicate with the control unit by using an optical signal having a wavelength different from the above-described wavelength at each timing. Furthermore, the separation device 20 may be configured to communicate with the control unit via a different carrier or a different line (a path different from the main signal) from the optical signal used by the user device. In such a case, the separation device 20 may communicate with the control unit using an optical signal, an electrical signal, or the like having a wavelength different from the wavelength used for the initial connection or the set wavelength as described above.

Note that the same applies to the communication between the separation device 20 and the control unit in the communication between the blocking device 30 and the control unit to be described later, and the same applies to the communication between the separation device 20 and the blocking device 30. However, part of the communication between the separation device 20 and the control unit, the communication between the blocking device 30 and the control unit, and the communication between the separation device 20 and the blocking device 30 may be implemented by the same communication means, may be implemented by respective different communication means, or may be implemented by the same communication means.

The optical cross-connect device 40 routes the optical signal input to the own device and outputs the optical signal from a port corresponding to a destination (to the destination device or a route connected to the path to the destination device).

FIG. 4 is a diagram illustrating a first specific example of a configuration of the separation system 11a. The separation device 20 in the first specific example includes the separation unit 21 and the detection unit 22. The separation unit 21 may be configured using, for example, a band drop filter (BDF), a band pass filter, a WDM filter, or a multiplexer/demultiplexer that separates by wavelength components. The separation unit 21 executes separation processing for separating the wavelength of the optical signal input to the optical cross-connect system 10a into the desired signal and the residual signal.

By execution of the separation processing, the desired separation signal and the residual separation signal are wavelength-separated. The separated desired separation signal is input to the blocking device 30.

The detection unit 22 detects the light intensity of the separated residual separation signal. Upon detecting the residual separation signal with a predetermined light intensity or more, the detection unit 22 outputs a control signal indicating that the optical signal (desired separation signal) input to the blocking device 30 is blocked to the blocking device 30. In this case, the detection unit 22 may record information (log) indicating that the residual separation signal has been detected with a predetermined light intensity or more. The detection unit 22 may be configured to be non-reflective. That is, the detection unit 22 may be configured not to reflect the input light from the separation unit 21. Such a log may be recorded along with a detection time of an improper wavelength. By recording the log in this manner, for example, when an inquiry occurs, it is possible to appropriately respond to the inquiry. Such a log may also be recorded with the detected intensity or with the detected time and intensity. Hereinafter, the method of using the recorded log is the same.

When not blocking, the blocking device 30 allows the input optical signal to pass. The desired separation signal that has passed through the blocking device 30 is output to a route corresponding to the destination. Upon receiving the control signal indicating block from the detection unit 22 of the separation device 20, the blocking device 30 blocks the input optical signal. In this case, the desired separation signal is not output to the first side.

The detection unit 22 may be configured using, for example, a photodiode (PD) or an avalanche photodiode (APD). The detection unit 22 detects the signal intensity of an input signal (residual separation signal).

The blocking device 30 may be configured using, for example, the following. With such a configuration, the blocking device 30 suppresses the signal of the target determined to be improper.

### Fiber Cross Connect (FXC)

Optical switch (optical SW) with a predetermined suppression ratio
Optical attenuator with a predetermined suppression ratio
Semiconductor optical amplifier (for example, a semiconductor optical amplifier (SOA) capable of suppressing at a predetermined suppression ratio)
Modulator capable of being suppressed at a predetermined suppression ratio

Specific examples of the above-described modulator include the following configurations.
Device for changing light absorption rate by electro refractive (ER) effect to change refractive index by controlling carrier (conduction electron and hole) concentration or applying electric field
Device using electro-absorption (electrometric absorption) EA effect

Note that, among modulators using the ER effect (for example, Mach-Zender (Mach-Zehnder) type), modulators having a wide cutoff wavelength are particularly suitable. In the modulator using the ER effect, a modulator having small wavelength dependency of the refractive index change is particularly suitable from the viewpoint of widening the cutoff wavelength.

In the separation system 11a illustrated in FIG. 4, the presence or absence of the residual separation signal is detected instead of the ratio of the intensities of the desired separation signal and the residual separation signal. In other words, the presence or absence of the residual signal is detected on the basis of whether or not the intensity of the residual separation signal exceeds the threshold. Accordingly, even if there is a configuration for detecting the ratio of intensities of the desired separation signal and the residual separation signal, sensitivity can be further improved as compared with such a configuration. In addition, it is also possible to mount the detection unit 22 using a detector with low sensitivity.

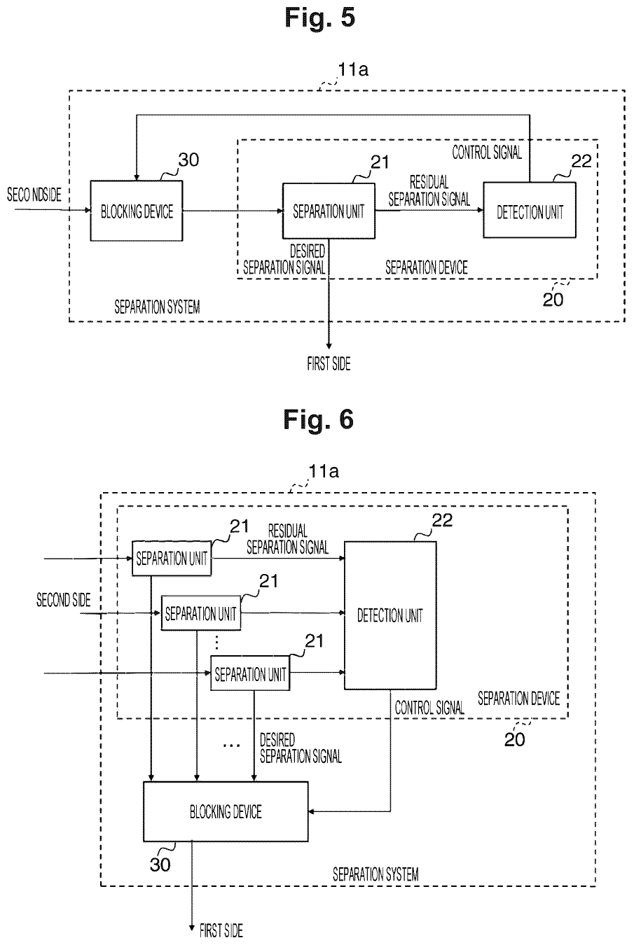

In the separation system 11a illustrated in FIG. 4, it is possible to output an optical signal (desired separation signal) including a relatively large amount of optical signal having a desired wavelength as compared with the residual separation signal. In addition, in the separation system 11a illustrated in FIG. 4, when the residual separation signal obtained from the input optical signal (separation input signal) is detected with an intensity exceeding the threshold, the desired separation signal (signal input to the blocking device 30) separated from the input optical signal by the separation unit 21 can be blocked. In addition, unlike a configuration illustrated in FIG. 5 to be described later, in the separation system 11a illustrated in FIG. 4, the residual separation signal of the optical signal input to the separation system 11a is continuously input to the detection unit 22 even while the block is performed by the blocking device 30, and the detection processing by the detection unit 22 is also continuously performed. Accordingly, in a case where the residual separation signal becomes less than the predetermined light intensity after the block is performed, the detection unit 22 can detect that. In this case, the blocking device 30 may be configured to release the block. As described above, the release of the blocking device 30 may be performed, for example, in response to input of the control signal indicating release of block from the detection unit 22, or may be performed in response to no input of the control signal indicating block.

FIG. 5 is a diagram illustrating a second specific example of the configuration of the separation system 11a. The separation device 20 in the second specific example includes the separation unit 21 and the detection unit 22. The separation unit 21 may be configured using, for example, a BDF. In the second specific example, an optical signal input to the separation system 11a is first input to the blocking device 30. The separation unit 21 receives an optical signal that has passed through the blocking device 30 among optical signals input to the optical cross-connect system 10a. The separation unit 21 separates the desired separation signal and the residual separation signal by executing the separation processing for wavelength-separating the desired signal and the residual signal from the input optical signal (separation input signal). The separated desired separation signal is output to the first side.

The detection unit 22 detects the light intensity of the separated residual separation signal. Upon detecting the residual separation signal with a predetermined light intensity or more, the detection unit 22 outputs the control signal indicating that the input optical signal is blocked to the blocking device 30. In this case, the detection unit 22 may record information (log) indicating that the residual separation signal has been detected with a predetermined light intensity or more.

When not block, the blocking device 30 allows the input optical signal to pass. The desired separation signal that has passed through the blocking device 30 is input to the separation unit 21 of the separation device 20. Upon receiving the control signal indicating block from the detection unit 22 of the separation device 20, the blocking device 30 blocks the input optical signal. In this case, since the optical signal is not input to the separation unit 21 in the first place, the desired separation signal is not output to the first side.

Next, a third specific example of the configuration of the separation system 11a will be described. The third specific example is a configuration in which an isolator 23 is provided on the output side of the residual separation signal of the separation unit 21 in the configuration of the first specific example. Hereinafter, the third specific example will be described in detail. The separation device 20 in the third specific example includes the separation unit 21, the detection unit 22, and the isolator 23. In a case where the optical signal is reflected from the detection unit 22 and returns to the separation unit 21 or in a case where the optical signal input from the port of the separation unit 21 on the detection unit 22 side leaks into the separated desired separation signal, this configuration has an effect of preventing such an event. The separation unit 21 may be configured using, for example, a BDF. The separation unit 21 separates the desired separation signal and the residual separation signal by executing the separation processing for wavelength-separating the desired signal and the residual signal from the optical signal input to the optical cross-connect system 10a. The separated desired separation signal is input to the blocking device 30. The residual separation signal is input to the isolator 23.

The isolator 23 passes the optical signal flowing from the separation unit 21 to the detection unit 22 and blocks the optical signal flowing from the detection unit 22 to the separation unit 21. The detection unit 22 receives an input of the residual separation signal via the isolator 23. The detection unit 22 detects the light intensity of the input residual separation signal. Upon detecting the residual separation signal with a predetermined light intensity or more, the detection unit 22 outputs the control signal indicating that the input optical signal (desired separation signal) is blocked to the blocking device 30. In this case, the detection unit 22 may record information (log) indicating that the residual separation signal has been detected with a predetermined light intensity or more.

When not block, the blocking device 30 allows the input optical signal to pass. The desired separation signal that has passed through the blocking device 30 is output to the first side. Upon receiving the control signal indicating block from the detection unit 22 of the separation device 20, the blocking device 30 blocks the input optical signal. In this case, the desired separation signal is not output to the first side.

Next, a fourth specific example of the configuration of the separation system 11a will be described. The fourth specific example is the configuration in which the isolator 23 is provided on the output side of the residual separation signal of the separation unit 21 in the configuration of the second specific example. Hereinafter, the fourth specific example will be described in detail. The separation device 20 in the fourth specific example includes the separation unit 21, the detection unit 22, and the isolator 23. The separation unit 21 may be configured using, for example, a BDF. In the fourth specific example, an optical signal input to the separation system 11a is first input to the blocking device 30. The separation unit 21 receives an optical signal that has passed through the blocking device 30 among optical signals input to the optical cross-connect system 10a. The separation unit 21 separates the desired separation signal and the residual separation signal by executing the separation processing for wavelength-separating the desired signal and the residual signal from the input optical signal. The separated desired separation signal is output to the first side. The residual separation signal is input to the isolator 23.

The isolator 23 passes the optical signal flowing from the separation unit 21 to the detection unit 22 and blocks the optical signal flowing from the detection unit 22 to the separation unit 21. The detection unit 22 receives an input of the residual separation signal via the isolator 23. The detection unit 22 detects the light intensity of the input residual separation signal. Upon detecting the residual separation signal with a predetermined light intensity or more, the detection unit 22 outputs the control signal indicating that the input optical signal is blocked to the blocking device 30. In this case, the detection unit 22 may record information (log) indicating that the residual separation signal has been detected with a predetermined light intensity or more.

When not block, the blocking device 30 allows the input optical signal to pass. The optical signal that has passed through the blocking device 30 is input to the separation unit 21 of the separation device 20. Upon receiving the control signal indicating block from the detection unit 22 of the separation device 20, the blocking device 30 blocks the input optical signal. In this case, since the optical signal is not input to the separation unit 21 in the first place, the desired separation signal is not output to the first side.

FIG. 6 is a diagram illustrating a fifth specific example of the configuration of the separation system 11a. The separation device 20 in the fifth specific example includes a plurality of separation units 21 and the detection unit 22. The separation unit 21 may be configured using, for example, a BDF. One of a plurality of optical signals input to the optical cross-connect system 10a is input to each separation unit 21. Each separation unit 21 separates the desired separation signal and the residual separation signal by executing the separation processing for wavelength-separating the desired signal and the residual signal from the input optical signal. The separated desired separation signal is input to the blocking device 30.

The detection unit 22 detects the light intensity of the separated residual separation signal. Upon detecting the residual separation signal from any one of the separation units 21 with a predetermined light intensity or more, the detection unit 22 outputs the control signal indicating that the input optical signal (desired separation signal) is blocked to the blocking device 30. In this case, the detection unit 22 may record information (log) indicating that the residual separation signal has been detected with a predetermined light intensity or more. The detection unit 22 may be configured to be non-reflective.

When not block, the blocking device 30 allows each input optical signal (desired separation signal) to pass through. Each desired separation signal having passed through the blocking device 30 is output to the first side. Upon receiving the control signal indicating block from the detection unit 22 of the separation device 20, the blocking device 30 blocks all the input optical signals. In this case, none of the desired separation signals of the plurality of optical signals input to the separation system 11a is output to the first side.

The blocking device 30 illustrated in FIG. 6 may be configured by either a configuration in which inputs and outputs are one-to-one (hereinafter referred to as a “first configuration” in the description of the present drawing) or a configuration in which a plurality of inputs is multiplexed and output as a single output (hereinafter referred to as a “second configuration” in the description of the present drawing). Hereinafter, each configuration will be described.

In the first configuration, the blocking device 30 may be configured to select block or non-block for each input (that is, for each separation unit 21) (hereinafter referred to as “individual block” in the description of the present drawing). In the first configuration, the blocking device 30 may be configured to block all the inputs (all the separation units 21) when the detection unit 22 detects the residual separation signal of any one of the separation units 21 with a predetermined light intensity or more (hereinafter referred to as “total block” in the description of the present drawings). The first configuration may be implemented, for example, by providing the blocking device 30 for each separation unit 21.

In the second configuration, when block the optical signal input to the own device, the blocking device 30 may be configured to individually block the optical signal before being multiplexed, or may be configured to block the optical signal after being multiplexed. In a case of a configuration in which the optical signals are individually blocked before being multiplexed, the optical signals may be configured by individual block or may be configured by total block. Note that, in the case of the configuration in which the optical signal after being multiplexed is blocked, the configuration is a total block configuration. The second configuration may be implemented, for example, by providing the blocking device 30 for each separation unit 21 and providing a multiplexer/demultiplexer or a coupler/splitter on the output side of each blocking device 30.

In this case, the multiplexer/demultiplexer or the coupler/splitter multiplexes and outputs the outputs of respective blocking devices 30.

Furthermore, as another configuration example, the plurality of separation units 21 illustrated in FIG. 6 may be configured as separation units for single-input multiple-output, multiple-input single-output, and multiple-input multiple-output. Such a separation unit 21 may be configured using, for example, a diffraction grating or an AWG. In this case, the separation unit 21 may output the desired separation signal to the blocking device 30 as one output.

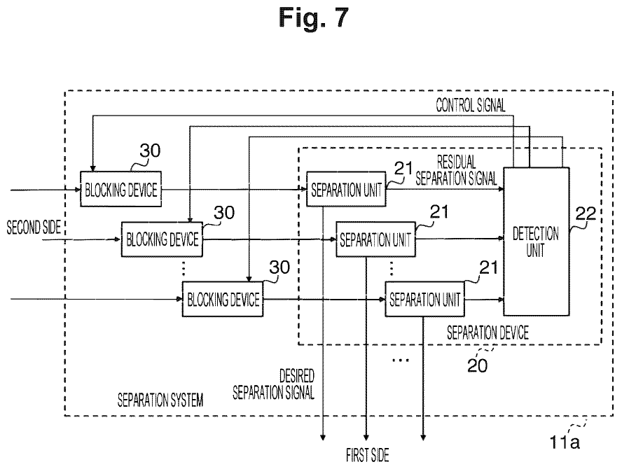

FIG. 7 is a diagram illustrating a sixth specific example of the configuration of the separation system 11a. The separation system 11a in the sixth specific example includes the separation device 20 and a plurality of blocking devices 30. The separation device 20 in the sixth specific example includes a plurality of separation units 21 and the detection unit 22. In the separation system 11a in the sixth specific example, the number of the separation units 21 may be equal to the number of the blocking devices 30.

In the sixth specific example, an optical signal input to the separation system 11a is first input to the blocking device 30. One of a plurality of optical signals input to the optical cross-connect system 10a is input to each blocking device 30. At least one separation unit 21 is connected to the subsequent stage (first side) of each blocking device 30.

The separation unit 21 may be configured using, for example, a BDF. Among the plurality of optical signals input to the optical cross-connect system 10a, the optical signal that has passed through the blocking device 30 connected to the preceding stage (second side) of the own device is input to each separation unit 21. Each separation unit 21 separates the desired separation signal and the residual separation signal by executing the separation processing for wavelength-separating the desired signal and the residual signal from the input optical signal. The separated desired separation signal is output to the first side route.

The detection unit 22 detects the light intensity of the separated residual separation signal. Upon detecting the residual separation signal with a predetermined light intensity or more, the detection unit 22 outputs the control signal indicating that the input optical signal (desired separation signal) is blocked to the blocking device 30. In this case, the detection unit 22 may record information (log) indicating that the residual separation signal has been detected with a predetermined light intensity or more. The detection unit 22 may be configured to be non-reflective.

When not block, the blocking device 30 allows each input optical signal to pass. Each optical signal having passed through the blocking device 30 is output to the separation unit 21. Upon receiving the control signal indicating block from the detection unit 22 of the separation device 20, the blocking device 30 blocks the input optical signal. In this case, among the desired separation signals of the plurality of optical signals input to the separation system 11a, the desired separation signal of the optical signal blocked by the blocking device 30 does not reach the destination. However, the desired separation signal of a non-blocked optical signal is transmitted to the destination. Note that, in the configuration of the sixth specific example, all the blocking devices 30 may be configured to block the optical signal when the detection unit 22 detects the residual separation signal from any one of the separation units 21 with a predetermined light intensity or more.

As described above, in the configuration of the sixth specific example, the passing or block of the plurality of optical signals input to the separation system 11a can be controlled in units of individual blocking devices 30. For example, the detection unit 22 may detect the residual separation signal for the optical signal passing through each blocking device 30 by making the blocking devices 30 to pass through one by one in a predetermined order (block the entirety and releasing the block one by one). With such a configuration, the detection unit 22 can identify from which separation unit 21 the residual separation signal has been detected with a predetermined intensity or more. In this case, only in a case where the residual separation signal is detected, the detection unit 22 may determine that the blocking device 30, which has been passed at that time, is to be blocked, or may notify the user device that is the transmission source of the optical signal. In addition, the detection unit 22 may pass through all the blocking devices 30 to collectively detect the residual separation signals of all the optical signals.

Note that, in FIG. 7, a multiplexer/demultiplexer or a coupler/splitter may be provided on the first side of each separation unit 21. In this case, the multiplexer/demultiplexer or the coupler/splitter multiplexes and outputs the outputs of the respective separation units 21. Furthermore, as another configuration example, the plurality of separation units 21 illustrated in FIG. 7 may be configured as one multiple-input multiple-output separation unit. Such a separation unit 21 may be configured using, for example, a diffraction grating or an AWG. In this case, the separation unit 21 may output the desired separation signal to the first side as one output.

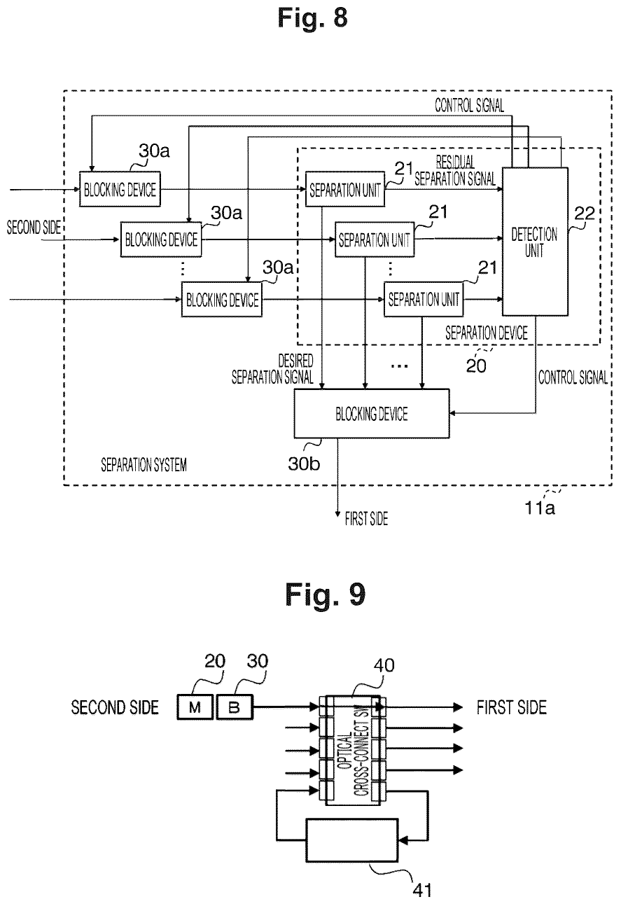

FIG. 8 is a diagram illustrating a seventh specific example of the configuration of the separation system 11a. The separation system 11a in the seventh specific example includes the separation device 20 and a plurality of blocking devices 30. In the seventh specific example, a plurality of blocking devices 30a is provided in the preceding stage (second side) of the separation device 20, and a blocking device 30b is provided in the subsequent stage (first side) of the separation device 20. The separation device 20 in the seventh specific example includes a plurality of separation units 21 and the detection unit 22. In the separation system 11a in the seventh specific example, the number of the separation units 21 may coincide with the number of the blocking devices 30a provided in the preceding stage (second side) of the separation device 20. The blocking device 30b in the subsequent stage may be configured using a plurality of blocking devices and a multiplexer/demultiplexer or a coupler/splitter that multiplexes outputs of the respective blocking devices. In this case, the plurality of blocking devices may be connected to the respective corresponding separation units 21. The output of each separation unit 21 is input to each blocking device. The output of each blocking device is input to a multiplexer/demultiplexer or a coupler/splitter. The multiplexer/demultiplexer or the coupler/splitter multiplexes and outputs the input signal. Furthermore, as another configuration example, the plurality of separation units 21 illustrated in FIG. 8 may be configured as one multiple-input multiple-output separation unit. Such a separation unit 21 may be configured using, for example, a diffraction grating or an AWG. In this case, the separation unit 21 may output the desired separation signal to the blocking device 30b as one output.

In the seventh specific example, an optical signal input to the separation system 11a is first input to the blocking device 30a. One of a plurality of optical signals input to the optical cross-connect system 10a is input to each blocking device 30a. At least one separation unit 21 is connected to the subsequent stage (first side) of each blocking device 30a.

The separation unit 21 may be configured using, for example, a BDF. Among the plurality of optical signals input to the optical cross-connect system 10a, the optical signal that has passed through the blocking device 30a connected to the preceding stage (second side) of the own device is input to each separation unit 21. Each separation unit 21 separates the desired separation signal and the residual separation signal by executing the separation processing for wavelength-separating the desired signal and the residual signal from the input optical signal. The separated desired separation signal is output to the blocking device 30b provided in the subsequent stage (first side) of the separation device 20.

The detection unit 22 detects the light intensity of the separated residual separation signal. Upon detecting the residual separation signal with a predetermined light intensity or more, the detection unit 22 outputs the control signal indicating that the input optical signal (desired separation signal) is blocked to the blocking device 30a or the blocking device 30b. In this case, the detection unit 22 may record information (log) indicating that the residual separation signal has been detected with a predetermined light intensity or more. The detection unit 22 may be configured to be non-reflective.

When not block, the blocking devices 30a and the blocking device 30b pass the input optical signals. Each optical signal having passed through the blocking devices 30a is output to the separation unit 21. Upon receiving the control signal indicating block from the detection unit 22 of the separation device 20, the blocking device 30a blocks the input optical signal. In this case, among the desired separation signals of the plurality of optical signals input to the separation system 11a, the desired separation signal of the optical signal blocked by the blocking device 30a is not output to the first side. However, the desired separation signal of a non-blocked optical signal is routed to the destination. Upon receiving the control signal indicating block from the detection unit 22 of the separation device 20, the blocking device 30b blocks the input optical signal. In this case, all the desired separation signals of the plurality of optical signals input to the separation system 11a are not output to the first side.

As described above, in the configuration of the seventh specific example, the passing or block of the plurality of optical signals input to the separation system 11a can be controlled in units of the individual blocking devices 30a. For example, the detection unit 22 may detect the residual separation signal for the optical signal passing through each blocking device 30a by making the blocking devices 30a to pass through one by one in a predetermined order (by block the entirety and releasing the block one by one). In this case, only when the residual separation signal is detected, the detection unit 22 may determine that the blocking device 30a, which has been passed at that time, is to be blocked, or may notify the user device that is the transmission source of the optical signal.

In addition, the detection unit 22 may pass through all the blocking devices 30a to collectively detect the residual separation signals of all the optical signals. In this case, the detection unit 22 may block the optical signals collectively by block the blocking device 30b when the residual separation signal is detected. Further, even while the detection unit 22 causes the blocking device 30b to block, the detection unit 22 may make all the blocking devices 30a to pass through. With this configuration, it is possible to continuously detect the state of each optical signal (for example, the intensity of the residual separation signal) while preventing the desired separation signal of the violating optical signal from flowing to the first side.

Also in the separation system 11a of each specific example illustrated in FIGS. 5 to 8, specific configuration examples, operations, and effects of the detection unit 22 and the blocking device 30 (blocking devices 30a and blocking device 30b) are common to those of the separation system 11a illustrated in FIG. 4. Furthermore, for example, a TFF (thin film filter, dielectric multilayer film filter), a fiber bragg grating (FBG), a reflection/transmission-type diffraction grating (including an AWG), a ring resonator, a (light) lattice filter, or a (light) transversal filter can be applied to each separation system 11a. That is, any device that extracts one or a plurality of wavelength components from a single input light beam into one output and separates the output from other wavelength components can be applied. In addition, as the separation unit of the multiple-input multiple-output described above, it is possible to apply a device that extracts a wavelength component corresponding to a port (case of PLC such as AWG, ring type resonator, lattice filter, and transversal filter, or coupling by PLC or the like) to be input from a plurality of input light beams or a position and an angle (in a case of a spatially coupled reflection/transmission-type diffraction grating or a TFF that sets a selection wavelength by an angle) to one output and separates the wavelength component from other wavelength components.

FIGS. 9 to 18 are diagrams illustrating specific examples of the positional relationship among the devices in the first embodiment (optical cross-connect system 10a) of the optical cross-connect system 10. In FIGS. 9 to 18, “M” indicated by a reference numeral 20 indicates the separation device 20, “B” indicated by a reference numeral 30 indicates the blocking device 30, “optical cross-connect SW” indicated by a reference numeral 40 indicates the optical cross-connect device 40, and a rectangle indicated by a reference numeral 41 indicates an additional package. Note that, in these specific examples, for convenience of explanation, an example is illustrated in which the devices are disposed in a central office from the vicinity of the user device of the transmission source, but the user devices may be disposed anywhere between the user device as the transmission source and the user device as the transmission destination (reception side). For example, some or all of the devices may be disposed in the vicinity of the user device as the transmission destination from the central office.

The additional package is a device for implementing a function additionally added to the PG. For example, an optical signal output from a specific port of the optical cross-connect device 40 is input to the additional package 41. The additional package 41 executes predetermined processing on the input optical signal. The predetermined processing may be performed on an electrical signal after converting the optical signal into the electrical signal, or may be performed on the optical signal as light. When the electrical signal is processed, the electrical signal is converted into an optical signal and then output from the additional package 41. The additional package 41 inputs the optical signal subjected to the predetermined processing to a predetermined port of the optical cross-connect device 40. The optical cross-connect device 40 outputs the input optical signal from another port. With such a configuration, it is possible to execute predetermined processing on the optical signal passing through the optical cross-connect device 40. The predetermined processing executed by the optical cross-connect device 40 may be, for example, processing such as multiplexing, demultiplexing, wavelength multiplexing, wavelength demultiplexing, and splitting as an optical signal as a node of an all-optical network. In addition, the predetermined processing executed by the optical cross-connect device 40 is not necessarily limited to the above-described processing. In any specific example of FIGS. 9 to 18, the optical cross-connect device 40 is installed in the central office. However, the installation place of the optical cross-connect device 40 is not limited to the central office, and may be installed, for example, in a building (user building) or the like in which the user device is installed. The reference numerals are illustrated in FIG. 9, and the reference numerals are omitted in FIGS. 10 to 18.

In FIG. 9, the separation device 20 and the blocking device 30 are installed on the second side and at a place different from the optical cross-connect device 40 (a place other than the central office). For example, the separation device 20 and the blocking device 30 may be installed at the same place as the user device (for example, in the user's home). For example, any one or both of the separation device 20 and the blocking device 30 may be installed on an upper part of a utility pole, a closure (terminal box), a security box outside the user's home, or the like if it is aerial. For example, if it is underground, the separation device 20 and the blocking device 30 may be installed in a tunnel, a manhole, a hand hole, a main distribution frame (MDF) chamber in which an MDF of a user building is housed, or the like.

In FIG. 9, the optical signal transmitted from the user device is first input to the separation device 20. The separation device 20 outputs the desired separation signal to the blocking device 30. The optical cross-connect device 40 receives the desired separation signal that has passed through the blocking device 30, and outputs the desired signal from the port on the first side.

Note that the order in which the optical signal is input by the separation device 20 and the blocking device 30 may be configured in reverse. That is, in FIG. 9, as illustrated in FIG. 4, the optical signal is first input to the separation device 20, and then the desired separation signal is input to the blocking device 30, but a configuration may be employed in which, as illustrated in FIG. 5, the optical signal is first input to the blocking device 30, and when it is not blocked, the optical signal is input to the separation device 20. A configuration as illustrated in FIG. 6 or 7 may be employed, or a configuration in which the optical signal is input to the blocking device, the separation device, and the blocking device in this order as illustrated in FIG. 8 may be employed.

In FIG. 10, the separation device 20 is installed on the second side and at a place different from the optical cross-connect device 40 (a place other than the central office). For example, the separation device 20 may be installed at the same place as the user device (for example, in the user's home). In FIG. 10, the optical cross-connect device 40 functions as the blocking device 30. As described above, in FIG. 10, functioning as the blocking device 30 by the optical cross-connect device 40 is expressed by describing a diagram representing the blocking device 30 above and in contact with the diagram representing the optical cross-connect device 40.

In FIG. 10, the optical signal transmitted from the user device is first input to the separation device 20. The separation device 20 outputs the desired separation signal to the optical cross-connect device 40. In this case, the separation device 20 outputs a control signal to the optical cross-connect device 40 which is the blocking device 30. In response to the control signal, the optical cross-connect device 40 blocks the desired separation signal. When not block, the optical cross-connect device 40 outputs the desired separation signal from the port on the first side. At this time, the optical cross-connect device 40 connects the input port and the output port according to the set information, and outputs the desired separation signal from the output port connected to the input port to which the desired separation signal has been input. Note that the control signal output from the separation device 20 to the blocking device 30 (optical cross-connect device 40) may be exchanged via a network that exchanges the control signal such as a data communication network (DCN), or may be exchanged by multiplexing by AMCC or the like, time division multiplexing, wavelength division multiplexing, or the like with the main signal.

Note that, in the configurations illustrated in FIGS. 12, 15, 16, 17, and 18 to be described later, “M” (separation device 20) and “B” (blocking device 30) are separated from each other similarly to the configuration illustrated in FIG. 10. In these cases, the communication between the separation device 20 and the blocking device 30 is implemented similarly to the communication illustrated in FIG. 10.

Further, in the configuration in which the separation device 20 and the blocking device 30 are replaced in the configuration of FIG. 10, the main signal is in a disconnected state in a state where the blocking device 30 blocks. Accordingly, when the blocking device 30 responds to the separation device 20, the control signal cannot be applied to the light of the main signal by AMCC or the like. Accordingly, light from a light source different from the main signal is used, or another transmission method is used. The same applies to a configuration illustrated in FIG. 15 described later.

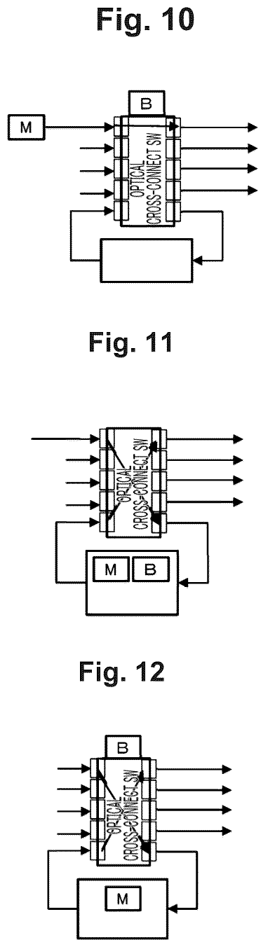

In FIG. 11, the separation device 20 and the blocking device 30 are mounted in the additional package 41. In FIG. 11, the optical signal transmitted from the user device is first input to the optical cross-connect device 40. In particular, in the example of FIG. 11, it is input to the upper left port. The optical cross-connect device 40 inputs the input optical signal to the additional package 41. The optical signal input to the additional package 41 is input to the blocking device 30 mounted in the additional package 41. The optical signal having passed through the blocking device 30 is input to the separation device 20. The separation device 20 outputs the desired separation signal to the optical cross-connect device 40.

Note that the order in which the optical signals are input by the blocking device 30 and the separation device 20 may be configured in reverse. That is, in FIG. 11, the optical signal input to the additional package 41 is first input to the blocking device 30, and then input to the separation device 20 when it is not blocked, but a configuration may be employed in which the optical signal is first input to the separation device 20, and then the desired separation signal is input to the blocking device 30.

Note that functions (hereinafter referred to as an “additional function”) other than the separation device 20 and the blocking device 30 may be mounted on the additional package 41. In this case, in the example of FIG. 11, the order of processing executed on the optical signal input to the additional package 41 may be first the function of the blocking device 30, next the separation device 20, and then the additional function, or may be first the function of the blocking device 30, next the additional function, and then the function of the separation device 20, or may be first the additional function, next the function of the blocking device 30, and then the function of the separation device 20. In addition, in a case where the order in which the optical signals are input by the separation device 20 and the blocking device 30 is configured to be opposite to that in FIG. 11 as described above, the order may be first the function of the separation device 20, next the blocking device 30, and then the additional function, or may be first the function of the separation device 20, next the additional function, and then the function of the blocking device 30, or may be first the additional function, next the function of the separation device 20, and then the function of the blocking device 30. Note that, by configuring such that the optical signal is input to the blocking device 30 before the additional function, it is possible to prevent the additional function of the additional package 41 from being executed with respect to the improper optical signal. Furthermore, by being configured such that the optical signal is input to the separation device 20 before the additional function, it is possible to output a control signal indicating block of the improper optical signal to the blocking device 30 at an earlier timing.

The desired separation signal output from the additional package 41 having the functions of the separation device 20 and the blocking device 30 is input to the optical cross-connect device 40. Then, the optical cross-connect device 40 outputs the desired separation signal from the port on the first side.

In FIG. 12, the separation device 20 is mounted in the additional package 41. Further, in FIG. 12, the optical cross-connect device 40 functions as the blocking device 30. As described above, in FIG. 12, functioning as the blocking device 30 by the optical cross-connect device 40 is expressed by describing a diagram representing the blocking device 30 above and in contact with the diagram representing the optical cross-connect device 40.

In FIG. 12, the optical signal transmitted from the user device is first input to the optical cross-connect device 40. In particular, in the example of FIG. 12, it is input to the upper left port. The optical cross-connect device 40 inputs the input optical signal to the additional package 41. The optical signal input to the additional package 41 is input to the separation device 20 mounted in the additional package 41. The separation device 20 outputs the desired separation signal to the optical cross-connect device 40. In this case, the separation device 20 outputs a control signal to the optical cross-connect device 40 which is the blocking device 30. In response to the control signal, the optical cross-connect device 40 blocks the desired separation signal. When not block, the optical cross-connect device 40 outputs the desired separation signal from the port on the first side.

The block by the optical cross-connect device 40 may be of an optical signal before input of the additional package, the desired separation signal after output of the additional package, or both. When the optical signal before the input of the additional package is blocked, the input to the additional package can be blocked, and unnecessary processing in the additional package can be suppressed.

Note that functions (additional functions) other than the separation device 20 may be mounted in the additional package 41. In this case, in the example of FIG. 12, the order of processing executed on the optical signal input to the additional package 41 may be first the separation device 20 and then the additional function, or may be first the additional function and then the function of the separation device 20. Note that, by being configured such that the optical signal is input to the separation device 20 before the additional function, it is possible to suppress the input of the residual separation signal to the additional function, and it is possible to output a control signal indicating block of the improper optical signal to the blocking device 30 at an earlier timing.

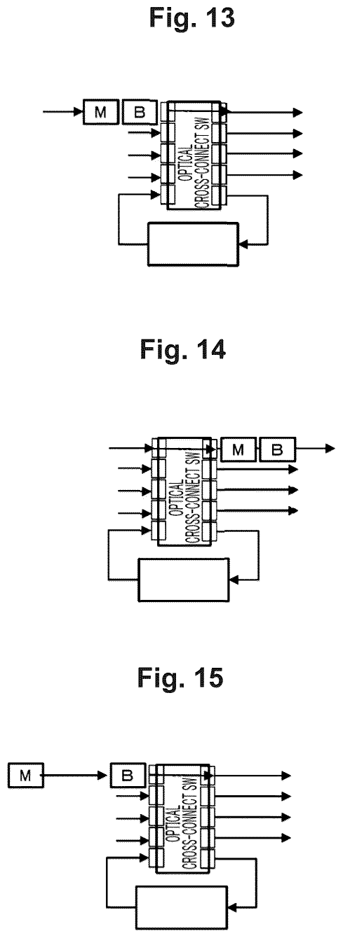

In FIG. 13, the separation device 20 and the blocking device 30 are installed on the second side and at the same place (for example, the central office) as the optical cross-connect device 40. In FIG. 13, the optical signal transmitted from the user device is first input to the separation device 20. The separation device 20 outputs the desired separation signal to the blocking device 30. The optical cross-connect device 40 receives the desired separation signal that has passed through the blocking device 30, and outputs the desired separation signal from the port on the first side.

Note that the order in which the optical signal is input by the separation device 20 and the blocking device 30 may be configured in reverse. That is, in FIG. 13, the optical signal is first input to the separation device 20, and then the desired separation signal is input to the blocking device 30. However, a configuration may be employed in which the optical signal is first input to the blocking device 30, and then the optical signal is input to the separation device 20 when the optical signal is not blocked.

In FIG. 14, the separation device 20 and the blocking device 30 are installed on the first side and at the same place (for example, the central office) as the optical cross-connect device 40. In FIG. 14, the optical signal transmitted from the user device is first input to the optical cross-connect device 40. The optical signal output from the port corresponding to the destination in the optical cross-connect device 40 is then input to the separation device 20. The separation device 20 outputs the desired separation signal to the blocking device 30. The desired separation signal that has passed through the blocking device 30 is routed to the first side.

Note that the order in which the optical signal is input by the separation device 20 and the blocking device 30 may be configured in reverse. That is, in FIG. 14, the optical signal is first input to the separation device 20, and then the desired separation signal input to the blocking device 30. However, a configuration may be employed in which the optical signal is first input to the blocking device 30, and then the optical signal is input to the separation device 20 when it is not blocked.

In FIG. 15, the separation device 20 is installed on the second side and at a place different from the optical cross-connect device 40 (a place other than the central office). For example, the separation device 20 may be installed at the same place as the user device (for example, in the user's home). The blocking device 30 is installed on the first side and at the same place (for example, the central office) as the optical cross-connect device 40. In FIG. 15, the optical signal transmitted from the user device is first input to the separation device 20. The separation device 20 outputs the desired separation signal to the first side. The blocking device 30 receives the desired separation signal and blocks the signal according to the control signal. The optical cross-connect device 40 receives the desired separation signal that has passed through the blocking device 30, and outputs the desired separation signal from the port on the first side.

Note that the order in which the optical signal is input by the separation device 20 and the blocking device 30 may be configured in reverse. That is, in FIG. 15, the optical signal is first input to the separation device 20, and then the desired separation signal is input to the blocking device 30. However, a configuration may be employed in which the optical signal is first input to the blocking device 30, and then the optical signal is input to the separation device 20 when it is not blocked. In this case, the mounting positions of the separation device 20 and the blocking device 30 are also reversed.

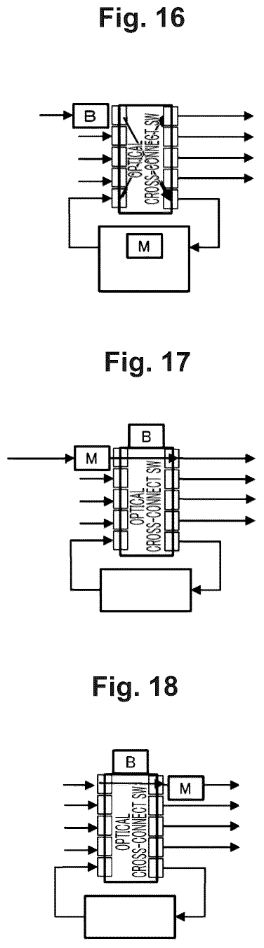

In FIG. 16, the separation device 20 is mounted in the additional package 41. The blocking device 30 is installed on the second side and at the same place (for example, the central office) as the optical cross-connect device 40. In FIG. 16, the optical signal transmitted from the user device is first input to the blocking device 30. The optical signal that has passed through the blocking device 30 is input to the optical cross-connect device 40. In particular, in the example of FIG. 16, it is input to the upper left port. The optical cross-connect device 40 inputs the input optical signal to the additional package 41. The separation device 20 outputs the desired separation signal to the optical cross-connect device 40. The optical cross-connect device 40 receives the desired separation signal output from the separation device 20 of the additional package 41, and outputs the desired separation signal from the port on the first side.

Note that the order in which the optical signals are input by the blocking device 30 and the separation device 20 may be configured in reverse. That is, in FIG. 16, the optical signal is first input to the blocking device 30, and when it is not blocked, the optical signal is then input to the separation device 20. However, a configuration may be employed in which the optical signal is first input to the separation device 20, and then the desired separation signal is input to the blocking device 30. In this case, the mounting positions of the separation device 20 and the blocking device 30 are also reversed.

In FIG. 17, the separation device 20 is installed on the second side and at the same place (for example, the central office) as the optical cross-connect device 40. In FIG. 17, the optical cross-connect device 40 functions as the blocking device 30. As described above, in FIG. 17, functioning as the blocking device 30 by the optical cross-connect device 40 is expressed by describing a diagram representing the blocking device 30 above and in contact with the diagram representing the optical cross-connect device 40. In FIG. 17, the optical signal transmitted from the user device is first input to the separation device 20. The separation device 20 outputs the desired separation signal to the optical cross-connect device 40. In this case, the separation device 20 transmits a control signal to the optical cross-connect device 40. In response to the control signal, the optical cross-connect device 40 blocks the desired separation signal. When not block, the optical cross-connect device 40 outputs the desired separation signal from the port on the first side.

In FIG. 18, the separation device 20 is installed on the first side at the same place (for example, the central office) as the optical cross-connect device 40. Further, in FIG. 18, the optical cross-connect device 40 functions as the blocking device 30. As described above, in FIG. 18, functioning as the blocking device 30 by the optical cross-connect device 40 is expressed by describing a diagram representing the blocking device 30 above and in contact with the diagram representing the optical cross-connect device 40. In FIG. 18, the optical signal transmitted from the user device is first input to the optical cross-connect device 40. In response to the control signal output from the separation device 20, the optical cross-connect device 40 blocks the optical signal. When not block, the optical cross-connect device 40 outputs the optical signal to the separation device 20. The separation device 20 outputs the desired separation signal to the first side.

In the configuration example described above, when the separation device 20 is mounted in the additional package 41 as illustrated in FIGS. 11, 12, and 16, it may be configured to determine the residual separation signal of each optical signal by switching the target (wavelength of the optical signal) to be separated for each time. Such a configuration may be implemented, for example, by determining the residual separation signal of the optical signal of the input different for each time by setting the input/output of the additional package 41 to a plurality of inputs and a plurality of outputs (for example, n input and n output: n is an integer of 2 or more) instead of one input and one output.

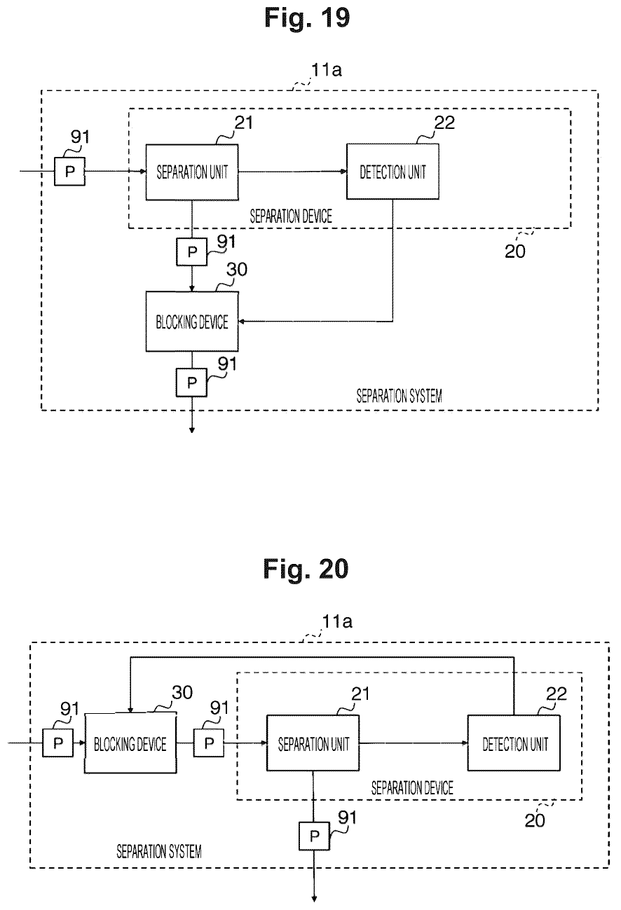

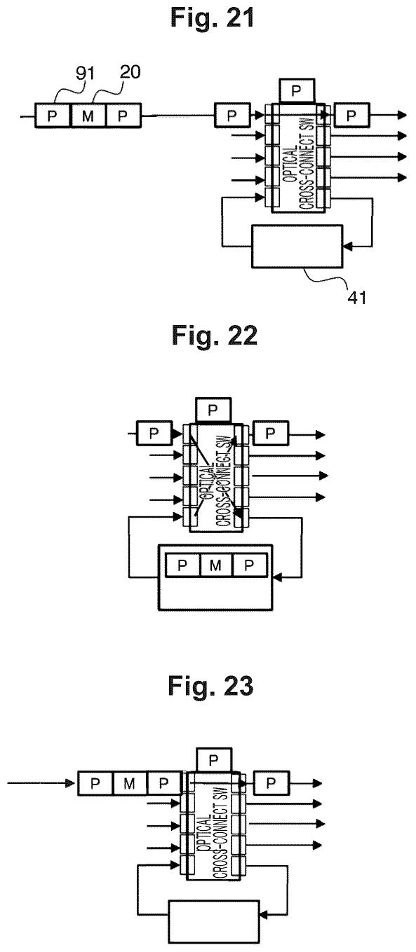

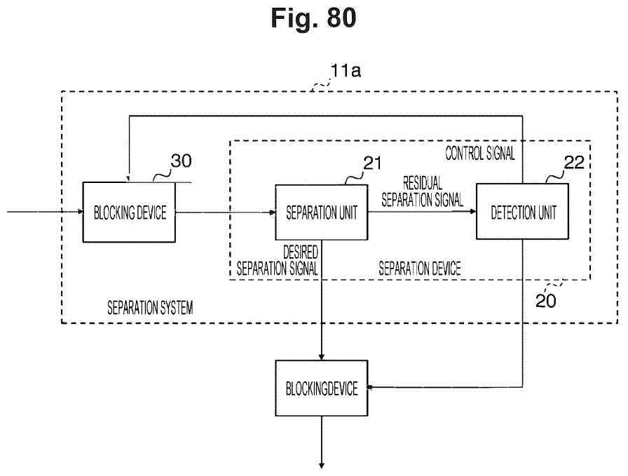

FIGS. 19 to 24 are diagrams illustrating configuration examples using an optical fuse. In FIGS. 19 to 24, “P” indicated by reference numeral 91 indicates an optical fuse 91. In FIGS. 19 to 24, “P” indicated by reference numeral 91 merely indicates a position where the optical fuse 91 may be provided. That is, the optical fuse 91 is not necessarily disposed at all the positions of “P” indicated by reference numeral 91. In FIGS. 19 to 24, the position where the optical fuse 91 may be provided is a position where an optical signal including a desired signal can be routed. Note that, examples of using the optical fuse are illustrated in FIGS. 19 and 20 with FIGS. 4 and 5, and illustrated in FIGS. 21 to 24 in a form corresponding to FIGS. 10, 12, 17, and 18 in which the separation unit is integrated with the optical cross-connect unit, but the optical fuse may be provided in each of corresponding positions in FIGS. 6 and 8, and FIGS. 56 to 58 and FIGS. 62 to 63, 72, 73, and FIGS. 76 to 80, and corresponding portions in FIGS. 9, 11, and 13 to 16.

The optical fuse 91 passes an optical signal in an initial state, but blocks communication of subsequent optical signals in response to an input of an optical signal having a predetermined intensity or more. The predetermined intensity serving as a reference of block is what is called a high intensity, and is, for example, an intensity that may damage devices such as the separation device 20, the blocking device 30, and the optical cross-connect device 40 when an optical signal of the intensity is input.

The optical fuse 91 may be configured to pass again after being blocked by some processing, such as an electromagnetic fuse in terms of electricity. The optical fuse 91 may be configured to automatically pass the optical signal when there is no more improper high intensity light. The optical fuse 91 may be implemented by combining with the blocking device 30 or another blocking device (not illustrated) using a detector (not illustrated) that detects the input intensity. In this case, the detector described above and another blocking device (not illustrated) may be installed at the position illustrated as the optical fuse 91. In the case of FIG. 19, the above-described detector is installed at a front stage of the separation unit 21, a preceding stage of the blocking device 30, or a subsequent stage of the blocking device 30.

The detector detects the improper intensity, and gives an instruction through a path (not illustrated) to block it by the blocking device 30. Any signal may be used as the instruction. For example, communication may be performed by superimposing on an optical signal used by the user signal, or communication may be performed by an optical signal having a wavelength different from the wavelength used by the user signal. Communication may be performed on a different carrier or a different line (a path different from the main signal) from the optical signal used by the user device.

Upon detecting the light intensity of the optical signal or the desired separation signal with a predetermined light intensity or more, the detector outputs the control signal indicating that the optical signal (desired separation signal) input to the blocking device 30 is blocked to the blocking device 30. In this case, in the detector, information (log) indicating that the input optical signal (desired separation signal) is detected with a predetermined light intensity or higher may be recorded, or the detection may be recorded together with the detected intensity, or may be recorded together with the detected time and intensity.

By recording the log in this manner, for example, when an inquiry occurs, it is possible to appropriately respond to the inquiry. Such a log may also be recorded with the detected intensity or with the detected time and intensity.

In the block, the input optical signal (desired separation signal) may be totally blocked, or may be attenuated so as to have an appropriate intensity, and may be policed with respect to the intensity.

In the optical cross-connect system 10, by providing the optical fuse 91 at any of the positions described above, communication control such as policing with respect to both the wavelength and the intensity is possible. The policing regarding the intensity is to attenuate until the intensity becomes appropriate. The policing regarding the wavelength is to pass only a desired separation wavelength by the separation unit, or pass the desired separation wavelength as long as the intensity of the residual separation wavelength does not become a predetermined intensity, and block the desired separation wavelength when the intensity becomes a predetermined intensity. The policing regarding both the wavelength and the intensity is to attenuate the optical signal (desired separation signal) to an appropriate intensity and pass only the desired separation wavelength by the separation unit, or pass the desired separation wavelength as long as the intensity of the residual separation wavelength does not become a predetermined intensity, and block the desired separation wavelength when the intensity becomes a predetermined intensity. In addition, in the optical cross-connect system 10, it is possible to prevent occurrence of an optical surge. Note that the optical fuse 91 to be used is desirably configured using a device that operates sufficiently fast to prevent the optical surge. Each of FIGS. 19 to 24 will be described below.

In the configuration illustrated in FIG. 19, the optical fuse 91 may be provided at any position on the second side of the separation unit 21, on a path through which the desired separation signal is output from the separation unit 21 and between the separation unit 21 and the blocking device 30, or on the first side of the blocking device 30. In addition, unlike a configuration illustrated in FIG. 20 to be described later, in the separation system 11a illustrated in FIG. 19, in a case where the optical fuse 91 is provided after the separation unit 21, the residual separation signal of the optical signal input to the separation system 11a is continuously input to the detection unit 22 even while the block is performed by the blocking device 30 or the optical fuse 91, and the detection processing by the detection unit 22 is also continuously performed. Accordingly, in a case where the residual separation signal becomes less than the predetermined light intensity after the block is performed, the detection unit 22 can detect that. In this case, the blocking device 30 and the optical fuse 91 may be configured to release the block.

In the configuration illustrated in FIG. 20, the optical fuse 91 may be provided at any position on the second side of the blocking device 30, between the blocking device 30 and the separation unit 21, and on a path through which the desired separation signal is output from the separation unit 21 and on the first side of the separation unit 21.

In the configuration illustrated in FIG. 21, the separation device 20 is installed on the second side and at a location different from the optical cross-connect device 40 (a location other than the central office). For example, the separation device 20 may be installed at the same place as the user device (for example, in the user's home). Note that, although the blocking device 30 is not illustrated in FIG. 21, the blocking device 30 may be located at any position as long as it can function appropriately. For example, the blocking device 30 may be located at any position illustrated in FIGS. 9, 10, and 15.

In FIG. 21, the optical fuse 91 may be provided at any position on the second side of the separation device 20, on a path through which the desired separation signal is output from the separation device 20 and the same place as the separation device 20 (for example, in the user's house), on a path through which the desired separation signal is output from the separation device 20 and the same place as the optical cross-connect device 40 (for example, in the central office), in the optical cross-connect device 40, and on the first side of the optical cross-connect device 40. Note that, although it is assumed that the input optical signal passes through the additional package 41, the optical fuse 91 may be installed inside the additional package 41 regardless of the position of the separation device 20, or the optical fuse 91 may be installed between the optical cross-connect device 40 and the additional package 41.

In the configuration illustrated in FIG. 22, the separation device 20 is mounted in the additional package 41. Note that, although the blocking device 30 is not illustrated in FIG. 22, the blocking device 30 may be located at any position as long as it can function appropriately. For example, the blocking device 30 may be located at any position illustrated in FIGS. 11, 12, and 16.

In FIG. 22, the optical fuse 91 may be provided at any position on the second side of the optical cross-connect device 40, on a path in the additional package 41 and on the user's home side of the separation device 20, on a path in the additional package 41 and on the first side of the separation device 20, in the optical cross-connect device 40, or on the first side of the optical cross-connect device 40. In addition, the optical fuse 91 may be installed between the optical cross-connect device 40 and the additional package 41.

In the configuration illustrated in FIG. 23, the separation device 20 is installed on the second side and at the same place (for example, in the central office) as the optical cross-connect device 40. Note that, although the blocking device 30 is not illustrated in FIG. 23, the blocking device 30 may be located at any position as long as it can function appropriately. For example, the blocking device 30 may be located at any position illustrated in FIGS. 13 and 17.

In FIG. 23, the optical fuse 91 may be provided at any position on the second side of the separation device 20 and at the same place as the separation device 20 (for example, in the central office), on a path through which the desired separation signal is output from the separation device 20 and between the separation device 20 and the optical cross-connect device 40, in the optical cross-connect device 40, or on the first side of the optical cross-connect device 40. Note that, although it is assumed that the input optical signal passes through the additional package 41, the optical fuse 91 may be installed inside the additional package 41 regardless of the position of the separation device 20, or the optical fuse 91 may be installed between the optical cross-connect device 40 and the additional package 41.

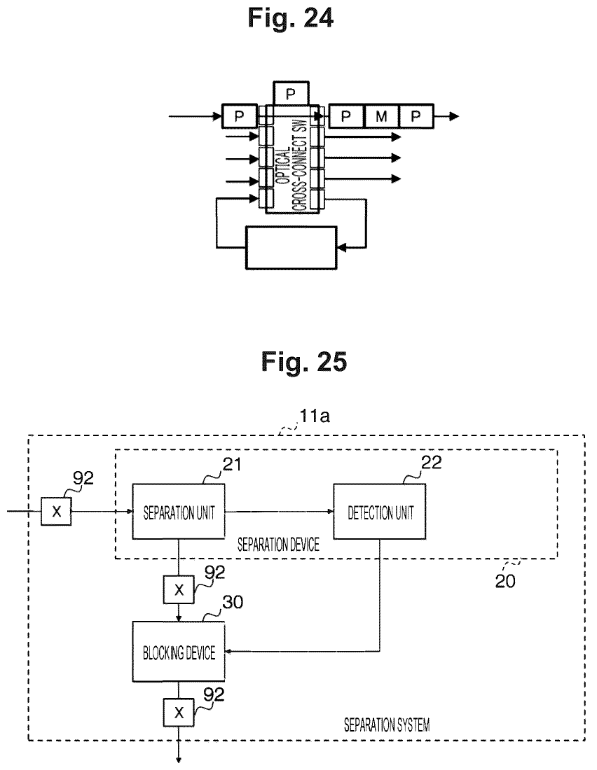

In the configuration illustrated in FIG. 24, the separation device 20 is installed on the first side and at the same place (for example, in the central office) as the optical cross-connect device 40. Note that, although the blocking device 30 is not illustrated in FIG. 24, the blocking device 30 may be located at any position as long as it can function appropriately. For example, the blocking device 30 may be located at any position illustrated in FIGS. 14 and 18.

In FIG. 24, the optical fuse 91 may be provided at any position on the second side of the optical cross-connect device 40 and at the same place as the optical cross-connect device 40 (for example, in the central office), in the optical cross-connect device 40, on a path through which an optical signal is output and between the optical cross-connect device 40 and the separation device 20, or on a path through which the desired separation signal is output from the separation device 20 and on the first side of the separation device 20. Note that, although it is assumed that the input optical signal passes through the additional package 41, the optical fuse 91 may be installed inside the additional package 41 regardless of the position of the separation device 20, or the optical fuse 91 may be installed between the optical cross-connect device 40 and the additional package 41.

In addition to the configuration illustrated in FIGS. 19 to 24 or separately, the optical fuse 91 may be provided between the separation unit 21 and the detection unit 22. With such a configuration, it is possible to prevent damage to the detection unit 22.

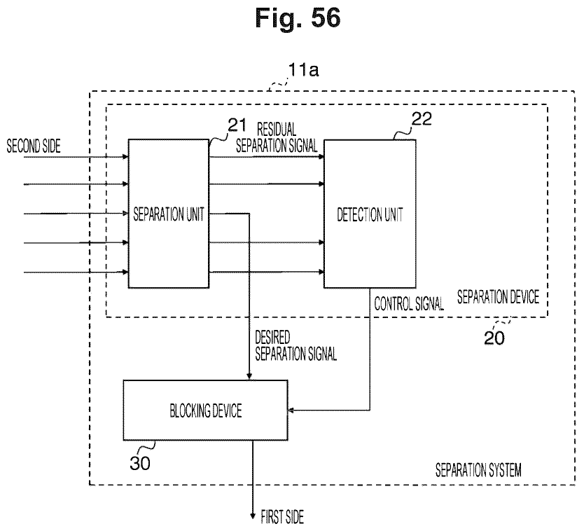

Note that the configuration using the optical fuse is illustrated only in accordance with FIGS. 4 and 5, but may be similarly used in FIGS. 6 to 8 and configurations described later, for example, FIGS. 56 to 58, FIGS. 72 and 73, and FIGS. 76 to 79 and 80.

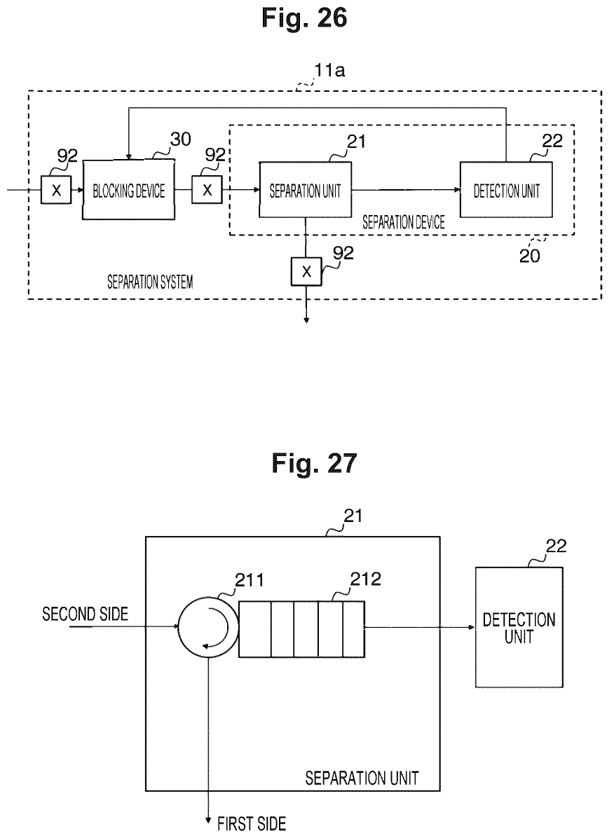

FIGS. 25 to 26 are diagrams illustrating a configuration example using an optical monitor. In FIGS. 25 to 26, “X” indicated by reference numeral 92 indicates an optical monitor 92. In FIGS. 25 to 26, “X” indicated by reference numeral 92 merely indicates a position where the optical monitor 92 may be provided. That is, the optical monitor 92 is not necessarily disposed at all the positions of “X” indicated by reference numeral 92. In FIGS. 25 to 26, the position where the optical monitor 92 may be provided is a position where an optical signal including a desired signal can be routed.

The optical monitor 92 measures the intensity of a passing optical signal. When detecting an optical signal having a predetermined intensity determined in advance or more, the optical monitor 92 notifies the blocking device 30 of a detection result. In this case, the blocking device 30 may operate to block the optical signal. In addition, the blocking device that blocks the optical signal according to the detection result of the optical monitor 92 may be provided as a component different from the blocking device 30 of the separation system 11a described in FIGS. 1 to 5 and the like, or may be implemented in the optical cross-connect device 40.

Any signal may be used as an instruction of the optical monitor 92. For example, communication may be performed by superimposing on an optical signal used by the user signal, or communication may be performed by an optical signal having a wavelength different from the wavelength used by the user signal. Communication may be performed on a different carrier or a different line (a path different from the main signal) from the optical signal used by the user device.

In the optical monitor 92, information (log) indicating that the input optical signal (desired separation signal) is detected with a predetermined light intensity or higher may be recorded, or the detection may be recorded together with the detected intensity, or may be recorded together with the detected time and intensity.

In the block, the input optical signal (desired separation signal) may be totally blocked, or may be attenuated so as to have an appropriate intensity, and may be policed with respect to the intensity.

The optical monitor 92 provided on the second side of the separation unit 21 measures the intensity of the optical signal including the desired signal and the residual signal. In this case, it may be disposed on the second side of the blocking device optical monitor 92 that blocks the optical signal according to the detection result of the optical monitor 92. With this configuration, damage to the optical monitor 92 can be prevented.

The optical monitor 92 provided on the first side of the separation unit 21 measures the intensity of the desired separation signal. In a case where the optical monitor 92 is provided at any of the positions described above, a device that attenuates or amplifies the optical signal (desired separation signal) to a predetermined signal intensity according to a measurement result of the optical monitor 92 may be further provided. With this configuration, it is possible to equalize the output signal (desired separation signal) with the intensity of other signals.

However, by providing the above device at a position on the first side of the separation unit 21, it is possible to appropriately attenuate or amplify the proper light. In addition, even if the device is provided on the second side of the separation unit 21, in a case where the input optical signal does not include light having an improper wavelength, if processing is performed in consideration of attenuation of a proper wavelength in the separation unit 21, appropriate attenuation and amplification are obtained. In a case where the input optical signal includes light having an improper wavelength, the intensity becomes lower by the amount thereof than the intensity desired to be equalized, but there is no problem when the light is blocked. The optical monitor 92 may notify an optical cross-connect disposed on the first side of the measurement result. In this case, the optical cross-connect, WSS, or ROADM may smooth the intensity between wavelengths of the WDM.

In addition, the optical monitor 92 may notify another device (for example, optical cross-connect, WSS, ROADM, and the like) on the path of the optical signal of the measurement result. With such a configuration, there is an effect that it is not necessary to measure the optical signal by a notification destination device. For example, in the notification destination device, the measurement result can be utilized in a case where the intensities of signals obtained by multiplexing a measured signal and other signals are equalized. In addition, instead of notifying the above-described device of the measurement result, the optical monitor 92 may acquire the value of the measurement result by receiving the measurement result measured by the above-described device. In this case, the optical monitor 92 may have a function of receiving a value (measurement result) measured by the above-described device instead of the function of measuring. Each of FIGS. 25 to 26 will be described below.

In the configuration illustrated in FIG. 25, the optical monitor 92 may be provided at any position on the second side of the separation unit 21, on a path through which the desired separation signal is output from the separation unit 21 and between the separation unit 21 and the blocking device 30, or on the first side of the blocking device 30.

In the configuration illustrated in FIG. 26, the optical monitor 92 may be provided at any position on the second side of the blocking device 30, between the blocking device 30 and the separation unit 21, and on a path through which the desired separation signal is output from the separation unit 21 and on the first side of the separation unit 21.

The position where the optical monitor 92 is provided is not limited to FIGS. 25 and 26 described above. For example, the optical monitor 92 may be provided at a position where the optical fuse 91 is provided in the configuration illustrated in FIGS. 21 to 24. As in the configuration including the optical fuse, the optical monitor may be provided at corresponding positions in FIGS. 6 and 8, and FIGS. 56 to 58, 62 to 63, 72, 73, and 76 to 80 to be described later, and at corresponding positions in FIGS. 9, 11, 13, 14, 15, and 16.

In the configuration including the optical monitor 92, the detection unit 22 may correct the light intensity of the separation input signal or the desired separation signal on the basis of the measurement result of the optical monitor 92. If the characteristic of wavelength separation of the separation unit 21 is not ideal, separation of the desired signal and the residual signal becomes incomplete. That is, the desired wavelength component leaks into the residual separation signal, and the residual wavelength component leaks into the desired separation signal. Accordingly, even if there is no component of the residual wavelength that is improper with respect to the wavelength, the detection intensity of the residual separation signal becomes non-zero due to leakage of the desired wavelength component in a case where the intensity of the desired signal is high, and there is a possibility that it is erroneously detected as improper with respect to the wavelength. By correcting the detection intensity of the residual separation signal according to the leakage of the desired wavelength component into the residual separation signal, it is possible to reduce erroneous detection that there is an improper wavelength component.

In a case where the intensity of the optical signal (desired separation signal) separated by the separation unit 21 is obtained by the optical monitor 92, the detection unit 22 may perform the following processing. First, when measuring the intensity of the optical signal, the optical monitor 92 causes the optical signal to branch at a predetermined splitting ratio for measurement. The optical monitor 92 measures the intensity of the branched optical signal for measurement and notifies the detection unit 22 of the measured value. The detection unit 22 returns the measurement value to the intensity of the optical signal before being measured by the optical monitor 92 on the basis of the loss and the splitting ratio when the optical signal is branched.

The detection unit 22 calculates the light intensity of a proper wavelength component leaking into the residual separation signal separated by the separation unit 21 on the basis of the suppression ratio in the separation processing in the separation unit 21 and the light intensity of the optical signal input to the own device (the detection unit 22). Then, the detection unit 22 can calculate the light intensity of the residual signal with higher accuracy by subtracting the calculated light intensity from the intensity of the residual separation signal separated by the separation unit 21. The detection unit 22 determines the intensity of the residual signal on the basis of the light intensity thus obtained. Note that the configuration using the optical monitor is illustrated only in accordance with FIGS. 4 and 5, but may be similarly used in FIGS. 6 to 8 and configurations described later, for example, FIGS. 56 to 58, FIGS. 72 and 73, and FIGS. 76 to 79. Here, also in the configurations of FIGS. 56 to 58, FIGS. 62 and 63, and FIGS. 71 to 79 described later, the arrangement of the corresponding functions may be the arrangement illustrated in FIGS. 9 to 18, similarly, the optical fuse and the optical monitor illustrated in FIGS. 19 to 26 may be arranged, or other appropriate combination may be used.

Next, a specific example of a configuration of the separation unit 21 will be described. For example, a specific example described below may be applied to each separation unit 21 illustrated in FIGS. 4 to 8. In that case, in the following description, the blocking device 30 is not illustrated in order to describe a specific example of the configuration of the separation unit 21, but signals (the separation input signal, the desired separation signal, and the like) related to the separation unit 21 may be blocked by the blocking device 30 illustrated in FIGS. 4 to 8. In a case where a specific example of the separation unit 21 described below is applied to the separation unit 21 illustrated in FIGS. 6 to 8, each separation unit 21 separates at a wavelength corresponding to each of different desired wavelengths and residual wavelengths corresponding to a plurality of different inputs. In the following description, an element such as one or a plurality of filters will be described as an element constituting the separation unit 21. In that case, the separation processing is performed by each element (for example, the FBG 212), and a signal input to the element is separated into the desired separation signal and the residual separation signal. In a case where the separation unit 21 includes a plurality of elements, the desired separation signal or the residual separation signal separated by the element in the preceding stage is input to the element in the subsequent stage. Furthermore, in a case where the separation unit 21 includes a plurality of elements, a corresponding desired wavelength (proper wavelength) may be different depending on the element. In that case, the separation processing is performed according to the corresponding desired wavelength in each element.

Furthermore, each specific example in the following description may be applied to each separation unit 21 illustrated in FIGS. 19, 20, 25, and 26, and FIGS. 72, 73, 76, and 77 to be described later. In FIGS. 19 and 20, even in a configuration in which the optical monitor 92 (X) is disposed instead of the optical fuse 91 (P), each specific example in the following description may be applied to each separation unit 21. In addition, both the optical fuse 91 (P) and the optical monitor 92 (X) may be provided. Also in this case, each specific example in the following description may be applied to each separation unit 21.

In that case, in the following description, a specific example of the configuration of the separation unit 21 will be described only and thus the description thereof will be omitted, but on the basis of the residual separation signal output from the separation unit 21 in each of the following specific examples, a notification signal may be output from the detection unit 22, or a detection result may be output. Similarly, the residual separation signal output from the separation unit 21 in each of the following specific examples may also be discarded by a discarding unit 24. Furthermore, a multiple-input multiple-output separation unit as described in FIGS. 6, 7, and 8 may be applied.

FIG. 6 is a multiple-input single-output separation system (separation device (separation units+detection unit)+blocking device), which includes a multiple-input multiple-output separation device 20 (separation units+detection units) and includes a plurality of single-input separation units 21. In FIG. 6, the outputs of the plurality of separation units 21 are input to the multiple-input single-output blocking device 30. The multiple-input single-output blocking device 30 may be configured by multiplexing the output of the single-input single-output blocking device corresponding to the number of ports by a coupler/splitter, or may be configured by multiplexing the ports by a coupler/splitter and inputting the output to the single-input single-output blocking device. The blocking device 30 of FIG. 6 includes a set of single-input single-output blocking devices, and can be a multiple-input multiple-output separation system as in FIG. 7.

FIG. 7 is a multiple-input multiple-output separation system 11a (separation device (separation units+detection unit)+blocking devices), which includes a multiple-input multiple-output separation device 20 (separation units+detection unit), which includes a plurality of single-input separation units 21. In FIG. 7, the outputs of the plurality of separation units 21 can be multiplexed by a coupler/splitter to form a multiple-input single-output separation system as in FIG. 6.

For example, in the configuration illustrated in FIG. 73 and the configuration illustrated in FIG. 77 to be described later, a multiple-input multiple-output separation unit may be applied instead of including the plurality of separation units 21. In this case, the multiple-input multiple-output separation unit may be configured to receive inputs from a plurality of ports and output the desired separation signal from one port (multiple-port input single-port output).

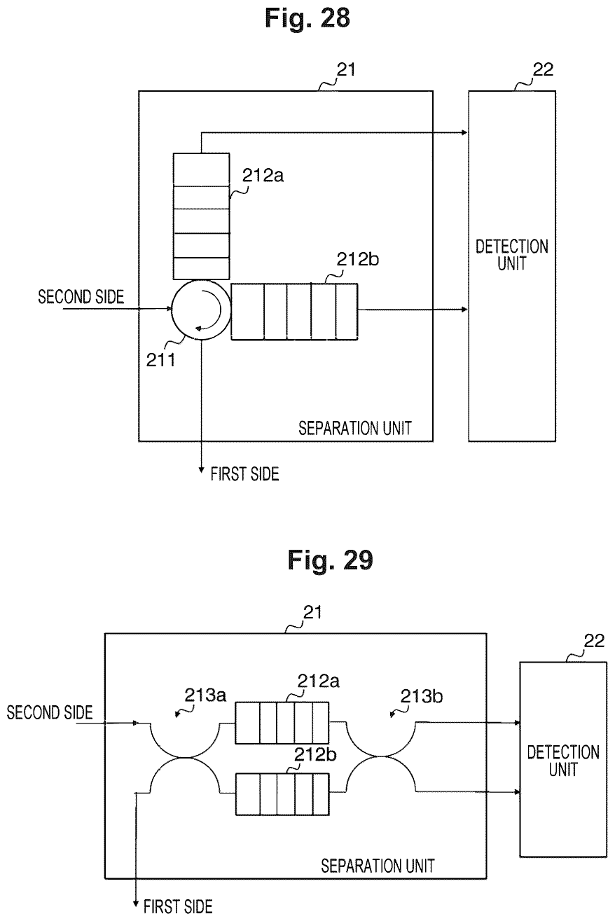

Note that, in the following description, different reference numerals are given to distinguish components in the same drawings, but the components do not perform exactly the same operation even if the reference numerals are the same in different drawings. For example, although the FBG 212a in FIG. 28 and the FBG 212a in FIG. 29 are common in that they are FBGs, the FBGs are used differently, and thus different operations are performed.

### Specific Example 1: FBG

FIG. 27 is a diagram illustrating a first configuration example in which the separation unit 21 is configured using a fiber bragg grating (FBG). The FBG is configured by creating a diffraction grating in an optical fiber. When light is incident on the FBG, only light of a specific wavelength component corresponding to the interval between diffraction gratings is reflected, and light of other wavelength components passes. By utilizing such characteristics, the separation unit 21 using the FBG can be configured.

The separation unit 21 includes a circulator 211 and an FBG 212. The circulator 211 inputs an optical signal input from the second side to the FBG 212. The circulator 211 outputs an optical signal input from the FBG 212 to the first side. The circulator 211 may be configured using, for example, a coupler/splitter. In a case where the circulator 211 is configured using a 2×2 coupler/splitter, two ports on one side function as an input port and an output port, one of two ports on the opposite side is connected to the FBG 212, and the other port is configured with a non-reflection termination. The circulator 211 may be configured using a 2×1 coupler/splitter such that there is no open end. In this case, two ports on one side function as an input port and an output port, and one port on the opposite side is connected to the FBG 212. The FBG 212 reflects an optical signal having a desired wavelength and transmits an optical signal having a residual wavelength. By such reflection and transmission, the desired separation signal and the residual separation signal are separated from the separation input signal.

FIG. 28 is a diagram illustrating a second configuration example in which the separation unit 21 is configured using FBGs. In the example illustrated in FIG. 28, the separation unit 21 includes the circulator 211 and a plurality of FBGs 212 (for example, two FBGs (FBG 212a and FBG 212b)). The circulator 211 inputs an optical signal input from the second side to the FBG 212a. The circulator 211 inputs an optical signal input from the FBG 212a to the FBG 212b. The circulator 211 outputs an optical signal input from the FBG 212b to the first side. Note that, although FIG. 28 illustrates a cascade configuration of two stages, a cascade configuration of three or more stages may be employed.

The FBG 212a and the FBG 212b reflect an optical signal having a desired wavelength and transmit an optical signal having a residual wavelength. With such a configuration, it is possible to further remove, in the FBG 212b, an optical signal having a residual wavelength that cannot be removed by the FBG 212a. Only the output of one of the FBG 212a and the FBG 212b may be input to the detection unit 22, or both may be input thereto. The isolator 23 may be provided between the separation unit 21 and the detection unit 22.

For example, in order to more accurately detect that the residual signal is mixed in the optical signal input to the optical cross-connect system 10a, it is desirable to use the output of the FBG 212a. In order to estimate the light intensity of the residual signal (the residual signal mixed in the desired separation signal) that cannot be removed in the separation unit 21, it is desirable to use the output of the FBG 212b. For example, if the reflectance of the residual signal is β and the loss of the circulator 211 is 0, if the light intensity of B×(1−β) is detected at the output of the FBG 212a, the residual signal of B×β\hat{ }2 is mixed in the desired separation signal output to the first side. It can be seen that when mixture of the same degree occurs, the B×β×(1−β) light intensity is detected in the FBG 212b, and thus the β-fold intensity decreases. Note that such an event is the same in the following embodiments. Note that the circulator 211 may be configured using a coupler/splitter as in the first configuration example.

FIG. 29 is a diagram illustrating a third configuration example in which the separation unit 21 is configured using FBGs. In FIG. 29, a Mach-Zehnder interferometer (hereinafter, Mach-Zehnder type) using FBGs is applied. The separation unit 21 includes a plurality of directional couplers (coupler/splitter) 213 (213a and 213b) and a plurality of FBGs 212 (FBG 212a and FBG 212b).

In the case of the Mach-Zehnder type, a set of FBGs 212 is provided on each arm of the Mach-Zehnder interferometer. When the distances from the directional couplers on the input side constituting the Mach-Zehnder interferometer to the two gratings are the same, the reflected light merges and interferes, and are then output from a lower left port. Therefore, it is necessary not only to match the characteristics of the two gratings, but also to match the distances from the directional couplers to the gratings with an accuracy of at least a wavelength or less, for example, an accuracy of 1/10 or less of the wavelength. Accordingly, a method of adjusting the optical length by what is called trimming such as changing the refractive index by applying ultraviolet light to the portion between the gratings and the directional couplers after the gratings are formed is also necessary.

The directional coupler 213a receives an optical signal from an upper left port, and outputs the desired separation signal reflected by the FBG 212a and the FBG 212b from a lower left port. The residual separation signals transmitted through the FBG 212a and the FBG 212b are input from upper left and lower left ports of the directional coupler 213b, respectively. The directional coupler 213b outputs the residual separation signal from upper right and lower right ports. Note that the directional coupler 213b may output the residual separation signal from only one of the two ports (the upper right and lower right ports in FIG. 29) to the detection unit 22. In this case, the other port may be configured as, for example, a non-reflection termination or may be connected to an isolator.

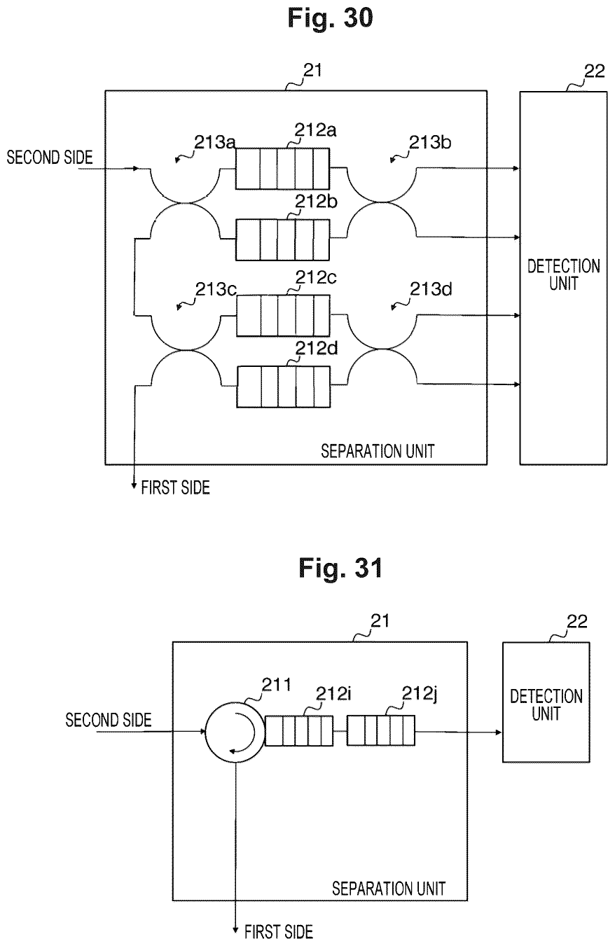

FIG. 30 is a diagram illustrating a fourth configuration example in which the separation unit 21 is configured using FBGs. In the example illustrated in FIG. 30, the separation unit 21 includes a plurality of directional couplers 213 (213a to 213d) and a plurality of FBGs 212 (212a to 212d). The directional coupler 213a receives an optical signal from an upper left port, and outputs the desired separation signal reflected by the FBG 212a and the FBG 212b from a lower left port. The directional coupler 213c inputs the desired separation signal output from the lower left port of the directional coupler 213a from an upper left port. The directional coupler 213c outputs the desired separation signal reflected by the FBG 212c and the FBG 212d from a lower left port. The directional coupler 213b and the directional coupler 213d each output the residual separation signal from upper right and lower right ports. Note that the directional coupler 213b may output the residual separation signal from only one of the two ports (the upper right and lower right ports in FIG. 30) to the detection unit 22. In this case, the other port may be configured as, for example, a non-reflection termination or may be connected to an isolator. Such a configuration is similar for directional coupler 213d. Note that, although FIG. 30 illustrates a cascade configuration of two stages, a cascade configuration of three or more stages may be employed.

With such a configuration, it is possible to further remove, in the FBG 212c and the FBG 212d, an optical signal having a residual wavelength that cannot be removed by the FBG 212a and the FBG 212b. Only the output of one of the directional coupler 213b and the directional coupler 213d may be input to the detection unit 22, or both may be input thereto. The isolator 23 may be provided between the separation unit 21 and the detection unit 22.

In the case of assuming a grating in which only one wavelength can be separated for each grating in FIGS. 27 to 30, it is necessary to connect gratings having different reflection wavelengths in multiple stages in order to demultiplex optical signals (for example, optical signals such as DWDM and CWDM) in which light of a plurality of different wavelengths is multiplexed. Similarly to the dielectric multilayer film filter, when the number of wavelengths is large, downsizing, cost reduction, and improvement of mass productivity are problems. Instead of designing such that gratings having different reflection wavelengths are connected in multiple stages as a combination of individual components, a quartz-based glass waveguide or a semiconductor optical waveguide may be designed to be integrated as a monolithic PLC or a hybrid PLC.

In the configurations illustrated in FIGS. 31 to 34 described below, desired signals of a plurality of wavelengths are used. In order to simplify the description, in the following description, it is assumed that a first desired signal having a first desired wavelength λi and a second desired signal having a second desired wavelength λj are separated from the residual signal.

Note that, in the configuration illustrated in FIGS. 27 to 30 described above, when only one wavelength is separated for each grating, a desired signal of one wavelength is used. However, in the configuration illustrated in FIGS. 27 to 30, when a plurality of wavelengths is reflected by apodization or the like, gratings corresponding to a plurality of wavelengths can be superimposed to correspond to desired signals of a plurality of wavelengths without forming a cascade. FIGS. 31 to 34 are used when a grating that separates only one wavelength is used for each grating to support desired signals of a plurality of wavelengths.

FIG. 31 is a diagram illustrating a fifth configuration example in which the separation unit 21 is configured using FBGs. The separation unit 21 includes the circulator 211, an FBG 212i, and an FBG 212j. The circulator 211 inputs an optical signal input from the second side to the FBG 212i and the FBG 212j. The circulator 211 outputs each of optical signals input from the FBG 212i and the FBG 212j to the first side. The FBG 212i reflects an optical signal having the first desired wavelength (first desired signal) and transmits an optical signal having another wavelength (second desired wavelength and residual wavelength). The FBG 212j reflects an optical signal having the second desired wavelength (second desired signal), and transmits an optical signal having another wavelength (the residual wavelength and the first desired wavelength that has not been reflected by the FBG 212i on the preceding stage and has been transmitted). By such reflection and transmission, the desired separation signal and the residual separation signal are separated from the separation input signal. Note that, in the configuration of FIG. 31, the circulator 211 may be configured using a coupler/splitter, similarly to the configuration described with reference to FIG. 27.

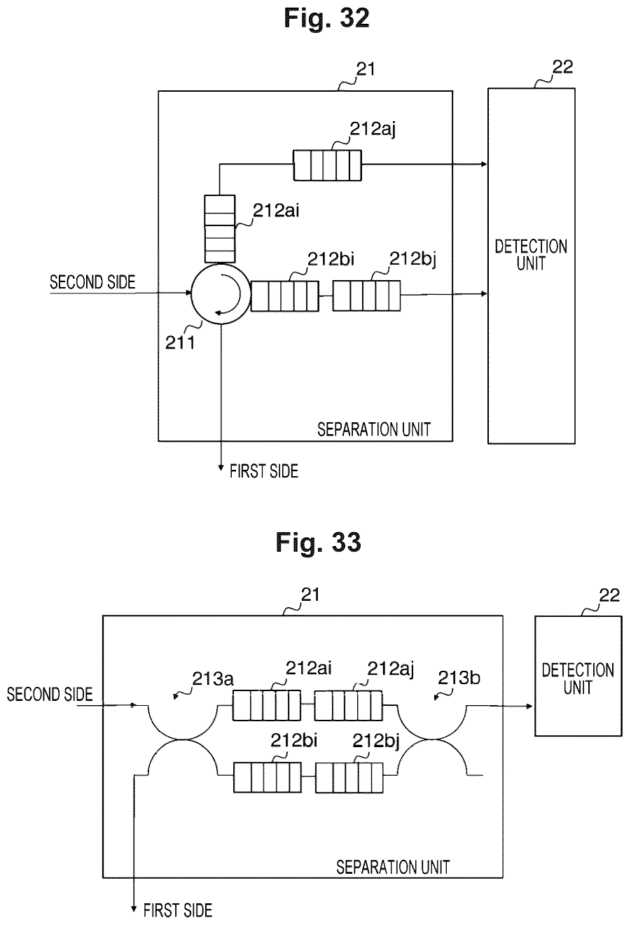

FIG. 32 is a diagram illustrating a sixth configuration example in which the separation unit 21 is configured using FBGs. In the example illustrated in FIG. 32, the separation unit 21 includes the circulator 211 and a plurality of FBGs 212 (FBG 212ai, FBG 212aj, FBG 212bi, and FBG 212bj). The circulator 211 inputs an optical signal input from the second side to the FBG 212ai. The circulator 211 inputs an optical signal input from the FBG 212ai to the FBG 212bi. The circulator 211 outputs an optical signal input from the FBG 212bi to the first side. Note that, although FIG. 32 illustrates a cascade configuration of two stages, a cascade configuration of three or more stages may be employed. Note that, from the viewpoint of equalizing propagation delays, a plurality of stages are desirable.

The FBG 212ai and the FBG 212bi reflect the optical signal having the first desired wavelength (first desired signal) among the optical signals input from the circulator 211 side, and transmit optical signals having other wavelengths (second desired wavelength and residual wavelength). The FBG 212aj and the FBG 212bj reflect an optical signal having the second desired wavelength (second desired signal) among the optical signals input from the FBG 212ai and the FBG 212bi, respectively, and transmit an optical signal having other wavelengths (residual wavelength and first desired wavelength transmitted without being reflected by the FBG 212ai or the FBG 212bi in the preceding stage). The FBG 212ai and the FBG 212bi transmit light input from the FBG 212aj and the FBG 212bj to the circulator 211, respectively.

With such a configuration, it is possible to further remove, in the FBG 212bi and the FBG 212bj, an optical signal having a residual wavelength that cannot be removed by the FBG 212ai and the FBG 212aj. Only the output of one of the FBG 212aj and the FBG 212bj may be input to the detection unit 22, or both may be input thereto. In a case where only the output of one of the FBG 212aj and the FBG 212bj is input to the detection unit 22, the output of the other may be configured as a non-reflection termination or may be connected to an isolator. The isolator 23 may be provided between the separation unit 21 and the detection unit 22.

In addition, propagation delays of a plurality of optical signals of proper wavelengths reflected by the FBGs 212 may be equalized to the same value. For example, it is assumed that the propagation delay (product of the refractive index and the round-trip distance) from the circulator 211 to reflection of the grating is 100 in the FBG 212ai and the FBG 212bi, and 200 in the FBG 212aj and the FBG 212bj. The propagation delay is 200 in total for the reflection wavelength of the FBG 212ai, and the propagation delay is 400 in total for the reflection wavelength of the FBG 212aj. Therefore, in the assumption described above, the propagation delay varies depending on the wavelength.

Therefore, for example, by making the reflection wavelengths of the FBG 212ai and the FBG 212bj the same, making the reflection wavelengths of the FBG 212bi and the FBG 212aj the same, and making the sum of the propagation delays when reflected by the FBG 212ai and the FBG 212bj equal to the sum of the propagation delays when reflected by the FBG 212bi and the FBG 212aj, the propagation delays of both wavelengths can be equalized. In order to equalize the sum of the propagation delays, for example, the propagation delays of the FBG 212ai and the FBG 212bi, and the propagation delays of the FBG 212aj and the FBG 212bj may be configured to be the same. Note that, although two different wavelengths are used in the above description, even in a case where optical signals having three or more different wavelengths are used, the sum of propagation delays of a plurality of proper wavelengths reflected by the FBGs 212 may be equalized similarly. Note that the circulator 211 may be configured using a coupler/splitter as in the fifth configuration example. In this case, the output ports in the preceding stage and the input ports in the subsequent stage of the 2×2 coupler/splitter are connected in a cascade.

FIG. 33 is a diagram illustrating a seventh configuration example in which the separation unit 21 is configured using FBGs. In FIG. 33, a Mach-Zehnder FBG is applied as an FBG. The separation unit 21 includes a plurality of directional couplers 213 (213a and 213b) and a plurality of FBGs 212 (FBG 212ai, FBG 212aj, FBG 212bi, and FBG 212bj).

The directional coupler 213a receives an optical signal from an upper left port, and outputs the desired separation signal of the first desired signal and the desired separation signal of the second desired signal reflected by the FBG 212ai, the FBG 212aj, the FBG 212bi, and the FBG 212bj from a lower left port. The residual separation signals transmitted through the FBG 212ai, the FBG 212aj, the FBG 212bi, and the FBG 212bj are input from upper left and lower left ports of the directional coupler 213b, respectively. The directional coupler 213b outputs the residual separation signal from an upper right port to the detection unit 22. In this case, the remaining port (lower right port) of the directional coupler 213b may be configured as a non-reflection termination or may be connected to an isolator. Further, the directional coupler 213b may output the residual separation signal from the two ports (the upper right port and the lower right port) to the detection unit 22.

In addition, propagation delays of a plurality of optical signals of proper wavelengths reflected by the FBG 212 are equalized to the same value. For example, the FBG 212ai and the FBG 212bi have the same reflection wavelength, and the FBG 212bj and the FBG 212aj have the same reflection wavelength. Note that, although two different wavelengths are used in the above description, even in a case where optical signals having three or more different wavelengths are used, propagation delays of a plurality of proper wavelengths reflected by the FBG 212 are similarly equalized by both arms.

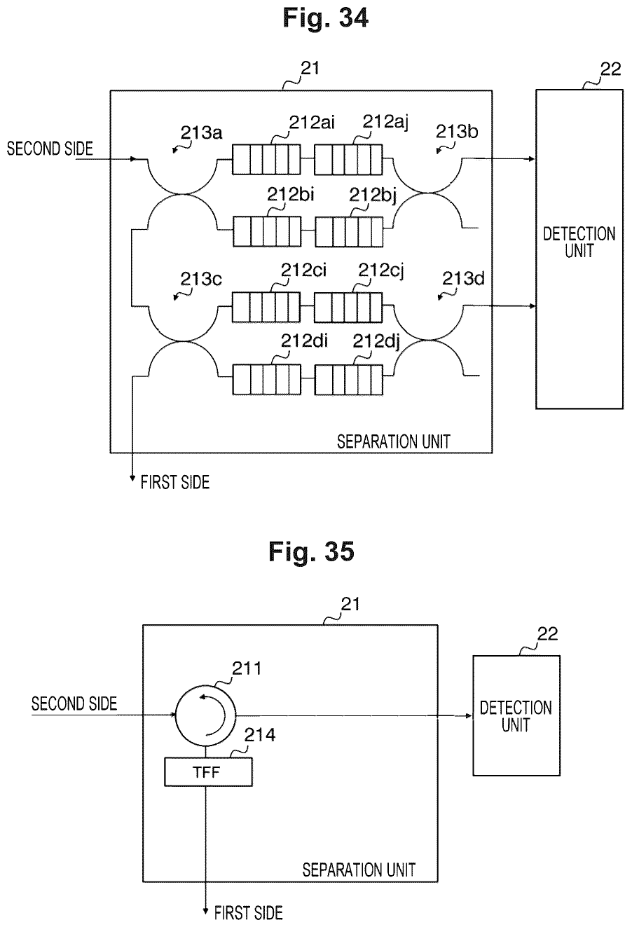

FIG. 34 is a diagram illustrating an eighth configuration example in which the separation unit 21 is configured using FBGs. In the example illustrated in FIG. 34, a Mach-Zehnder FBG is applied as an FBG. The separation unit 21 includes a plurality of directional couplers 213 (213a to 213d) and a plurality of FBGs 212 (212ai to 212di and 212aj to 212dj). The directional coupler 213a receives an optical signal from an upper left port, and outputs the desired separation signal of the first desired signal and the desired separation signal of the second desired signal reflected by the FBG 212ai, the FBG 212aj, the FBG 212bi, and the FBG 212bj from a lower left port. Note that, although FIG. 34 illustrates a cascade configuration of two stages, a cascade configuration of three or more stages may be employed. Note that, from the viewpoint of equalizing propagation delays, multiple stages are desirable.

The directional coupler 213c receives the desired separation signal of the first desired signal and the desired separation signal of the second desired signal output from the lower left port of the directional coupler 213a from the upper left port. The directional coupler 213c outputs the desired separation signal of the first desired signal and the desired separation signal of the second desired signal reflected by the FBG 212ci, the FBG 212cj, the FBG 212di, and the FBG 212dj, respectively, from the lower left port. The directional coupler 213b and the directional coupler 213d each output the residual separation signal from an upper right port to the detection unit 22. In this case, the remaining port (lower right port) of the directional coupler 213d may be configured as a non-reflection termination or may be connected to an isolator. Further, the directional coupler 213d may output the residual separation signal from the two ports (the upper right port and the lower right port) to the detection unit 22.

In addition, with respect to the FBG 212ci, the FBG 212cj, the FBG 212di, and the FBG 212dj, propagation delays of a plurality of optical signals having proper wavelengths reflected by the FBG 212 may be equalized to the same value. For example, making the reflection wavelengths of the FBG 212ai, the FBG 212bi, the FBG 212cj, and the FBG 212dj the same, making the reflection wavelengths of the FBG 212aj, the FBG 212bj, the FBG 212di, and the FBG 212ci are the same, and making the sum of the propagation delay when reflected by the FBG 212ai and the FBG 212bi and the propagation delay reflected by the FBG 212cj and the FBG 212dj equal to the sum of the propagation delay reflected by the FBG 212aj and the FBG 212bj and the propagation delay reflected by the FBG 212di and FBG 212ci, the propagation delays of both wavelengths can be equalized. Note that, although two different wavelengths are used in the above description, even in a case where optical signals having three or more different wavelengths are used, the sum of propagation delays of a plurality of proper wavelengths reflected by the FBGs 212 may be equalized similarly.

With such a configuration, it is possible to further remove, in the FBG 212ci and the FBG 212di, the optical signals having the second desired wavelength and the residual wavelength that cannot be removed by the FBG 212ai and the FBG 212bi. Similarly, it is possible to further remove, in the FBG 212cj and the FBG 212dj, an optical signal having a residual wavelength that cannot be removed in the FBG 212aj and the FBG 212bj. Only the output of one of the directional coupler 213b and the directional coupler 213d may be input to the detection unit 22, or both may be input thereto. In a case where only the output of one of the directional coupler 213b and the directional coupler 213d is input to the detection unit 22, the output of the other may be configured as a non-reflection termination or may be connected to an isolator. The isolator 23 may be provided between the separation unit 21 and the detection unit 22.

In addition, propagation delays of a plurality of optical signals of proper wavelengths reflected by the FBGs 212 may be equalized to the same value. The (FBG 212ai and FBG 212bi), (FBG 212aj and FBG 212bj), (FBG 212ci and FBG 212di), and (FBG 212cj and FBG 212dj) disposed at equal distances from the coupler/splitter of each arm have the same reflection wavelengths. Similarly to the description in FIG. 32, in order to equalize the propagation delays for the respective wavelengths, the reflection wavelengths of the (FBG 212ai and FBG 212bi) and the (FBG 212cj and FBG 212dj) and the (FBG 212aj and FBG 212bj) and the (FBG 212ci and FBG 212di) are set to the same wavelengths, and the sum of the propagation delays of the FBG 212ai and the FBG 212cj is equal to the sum of the propagation delays of the FBG 212aj and the FBG 212ci. For example, propagation distances of the FBG 212ai, the FBG 212bi, the FBG 212ci, and the FBG 212di may be made equal, and propagation distances of the FBG 212aj, the FBG 212bj, the FBG 212cj, and the FBG 212dj may be made equal.

In addition, it is also preferable to configure as follows. At least the FBG 212ai and the FBG 212bi, the FBG 212aj and the FBG 212bj, the FBG 212ci and the FBG 212di, and the FBG 212cj and the FBG 212dj have the same propagation distances from the coupler/splitter on the input side and the same wavelengths reflected by each other. Furthermore, in order to equalize the propagation delay time for each wavelength, it is desirable that the FBG 212ai, the FBG 212bi, the FBG 212cj, the FBG 212dj, the FBG 212aj, the FBG 212bj, the FBG 212ci, and the FBG 212di have the same wavelengths, and the propagation delays of the wavelengths reflected by the FBG 212ai and the FBG 212cj and the propagation delays of the wavelengths reflected by the FBG 212aj and the FBG 212ci are equal.

### Specific Example 2: TFF

First, a multilayer film filter will be described. The multilayer film is usually a dielectric multilayer film, and will be described here as TFF as a representative. A thin film filter (TFF) will be described.

In the following description, a dielectric filter is used as the TFF. The dielectric filter is a wavelength filter utilizing an interference phenomenon in a multilayer film structure of a dielectric thin film. The dielectric filter is formed using a vacuum film forming technique such as an electron beam evaporation method or a reactive sputtering method. Specific examples of the main dielectric material used for the dielectric filter include Al2O3, HfO2, MgF2, Nb2O5, Si, SiO2, Ta2O5, TiO2, Y2O3, ZrO2, or the like. The refractive index of the dielectric depends on the material and ranges from 1.38 (MgF2) to 3.5 (Si). The dielectric is used in a wavelength range where absorption can be ignored. The multilayer film is formed by several (usually two) dielectric materials having different refractive indexes. The film thickness of each layer is approximately equal to or less than the wavelength of light (0.05 to several μm). The number of layers of the multilayer film is 100 or more at most. The light is incident perpendicularly or obliquely to the film surface, a part thereof is reflected, and the rest is transmitted. An advantage of the TFF is that the transmittance and the reflectance can be designed to be a high value (95% or more) or a specific value (1 to 99%).

For example, in the BPF, light having a wavelength other than the transmission band is reflected (or absorbed). A structure in which two parallel mirrors face each other is called a resonator (cavity). The dielectric BPF has a structure in which a dielectric spacer layer (λ/2) is sandwiched between two highly reflective multilayer film mirrors (λ/4 layers), and has what is called a Fabry-Perot resonator structure. The light incident on the BPF is divided into multiple light fluxes while repeating multiple reflection in the cavity, and is transmitted at a specific wavelength at which phases of the multiple light fluxes are intensified. By stacking the multilayer film structure in multiple stages with the λ/4 bonding layer interposed therebetween, the spectrum shape can be made close to a box shape (multi-cavity BPF). The transmission wavelength of the BPF depends on an optical film thickness of the spacer layer. For example, by using a material (for example, Si) having a large refractive index temperature coefficient for the spacer layer, the transmission wavelength can be controlled by temperature.

In addition, the dielectric thin film has a structure in which dielectric thin films having a high refractive index of λ/4 and a low refractive index are alternately deposited, and a thickness of a pair of high/low refractive index layers (one period) is λ/2, so that reflected light from each layer interface is added in phase, resulting in a mirror. When the λ/4 multilayer film mirrors are opposed to each other with the spacer layer having the thickness λ/2 interposed therebetween, a Fabry-Perot structure is formed, and only the resonance wavelength is transmitted.

The transmission wavelength of the TFF can be changed to any value by changing the optical film thickness of the dielectric spacer layer (λ/2). For example, as described above, when a material (for example, Si) having a large refractive index temperature coefficient is used for the spacer layer, the transmission wavelength can be controlled by temperature. In addition, a film having a different spacer layer thickness may be formed in a direction perpendicular to the optical path, and the film may be slid in a horizontal direction in which the thickness changes to change the average film thickness. In addition, the optical film on the optical path may be effectively changed by inclining the incident angle with respect to the optical path. Note that, in the following description, a mode is employed in which an optical signal is vertically reflected in the TFF, and reflected light is input to the detection unit 22 by a circulator. The TFF can set a wavelength to be reflected or transmitted according to an angle of incidence or emission. For example, in a case where input light beams different from each other at different angles have wavelengths proper for the respective angles, it is also possible to use the input light beams as the multiple-input single-output separation unit 21 similarly to the diffraction grating.

FIG. 35 is a diagram illustrating a first configuration example in which the separation unit 21 is configured using a TFF. The separation unit 21 includes the circulator 211 and a TFF 214. The circulator 211 inputs an optical signal input from the second side to the TFF 214. The circulator 211 inputs an optical signal input from the TFF 214 to the detection unit 22. The configuration of the circulator 211 is as described above.

Note that, for example, in the circulator 211 in FIG. 27 and the circulator 211 in FIG. 35, the traveling direction of light is reverse rotation as viewed from the paper surface. The traveling direction of light of the circulator 211 is reversely rotated as described above in a case where the element in the separation unit 21 is configured to reflect the light having the proper wavelength as in the FBG 212, for example, and in a case where the element is configured to transmit the light having the proper wavelength as in the TFF 214, for example.

The TFF 214 transmits an optical signal having a desired wavelength and reflects an optical signal having a residual wavelength. The optical signal (residual separation signal) reflected by the TFF 214 is input to the detection unit 22 via the circulator 211. By such reflection and transmission, the desired separation signal and the residual separation signal are separated from the separation input signal. Note that also in FIG. 35 having a configuration that transmits a desired wavelength, the circulator 211 may be configured using a coupler/splitter as in FIG. 27 having a configuration that reflects a desired wavelength. The same applies to other configurations.

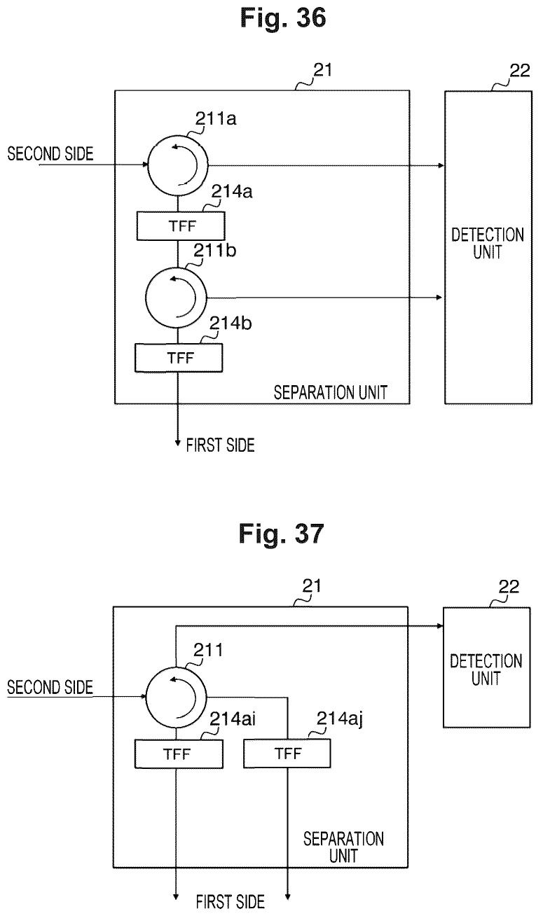

FIG. 36 is a diagram illustrating a second configuration example in which the separation unit 21 is configured using a TFF. In the example illustrated in FIG. 36, the separation unit 21 includes a plurality of circulators 211 (for example, a circulator 211a and a circulator 211b) and a plurality of TFFs 214 (for example, TFF 214a and TFF 214b). The circulator 211a inputs an optical signal input from the second side to the TFF 214a. The circulator 211a inputs an optical signal input from the TFF 214a to the detection unit 22. Note that, although FIG. 36 illustrates a cascade configuration of two stages, a cascade configuration of three or more stages may be employed.

The TFF 214a passes the desired separation signal among optical signals input from the circulator 211a and inputs the signal to the circulator 211b, and reflects the residual separation signal and inputs the signal to the circulator 211a. The circulator 211b inputs an optical signal (residual separation signal) input from the TFF 214a to the TFF 214b. As described above, since the TFF 214a transmits the light having the proper wavelength, mainly the proper wavelength component is directed from the TFF 214a to the TFF 214b. The circulator 211b inputs an optical signal (residual separation signal) reflected and input from the TFF 214b to the detection unit 22. The TFF 214b causes the desired separation signal among optical signals input from the circulator 211b to pass through the transmission path, reflects the residual separation signal, and inputs the residual separation signal to the circulator 211b.

With such a configuration, it is possible to further remove, in the TFF 214b, an optical signal having the residual wavelength that cannot be removed in the TFF 214a. Only the output of one of the circulator 211a and the circulator 211b may be input to the detection unit 22, or both may be input thereto. In a case where only the output of one of the circulator 211a and the circulator 211b is input to the detection unit 22, the output of the other may be configured as a non-reflection termination or may be connected to an isolator.

The isolator 23 may be provided between the separation unit 21 and the detection unit 22. Note that the circulator 211b may not necessarily be provided. In that case, since the residual separation signal separated in the TFF 214b is not input to the detection unit 22, the accuracy of the processing in the detection unit 22 may slightly decrease, but it is possible to remove the remaining component of the residual signal from the desired separation signal. Note that the improper wavelength component reflected by the TFF 214b returns to the TFF 214a, but when these improper wavelength components are reflected by the TFF 214a or the circulator 211a, the improper wavelength component is input again to the path of the proper wavelength component (path to the first side). In order to prevent such a situation, for example, an isolator may be provided at any position between the TFF 214a and the TFF 214b.

In the configurations illustrated in FIGS. 37 to 39 described below, desired signals of a plurality of wavelengths are used. In order to simplify the description, in the following description, it is assumed that a first desired signal having a first desired wavelength λi and a second desired signal having a second desired wavelength λj are separated from the residual signal.

FIG. 37 is a diagram illustrating a third configuration example in which the separation unit 21 is configured using a TFF. The separation unit 21 includes the circulator 211, a TFF 214ai, and a TFF 214aj. The circulator 211 inputs an optical signal input from the second side to the TFF 214ai. The circulator 211 inputs an optical signal input from the TFF 214ai to the TFF 214aj. The circulator 211 inputs an optical signal input from the TFF 214aj to the detection unit 22. The configuration of the circulator 211 is as described above. The TFF 214ai transmits an optical signal having a first desired wavelength and reflects optical signals having a second desired wavelength and the residual wavelength. The TFF 214aj transmits an optical signal having the second desired wavelength and reflects a reflected residual wavelength and a reflected optical signal having the first desired wavelength that is not transmitted. By such reflection and transmission, the desired separation signal and the residual separation signal are separated from the separation input signal. Note that, although FIG. 37 illustrates a configuration of desired wavelengths of two wavelengths, a configuration of three or more wavelengths may be used.

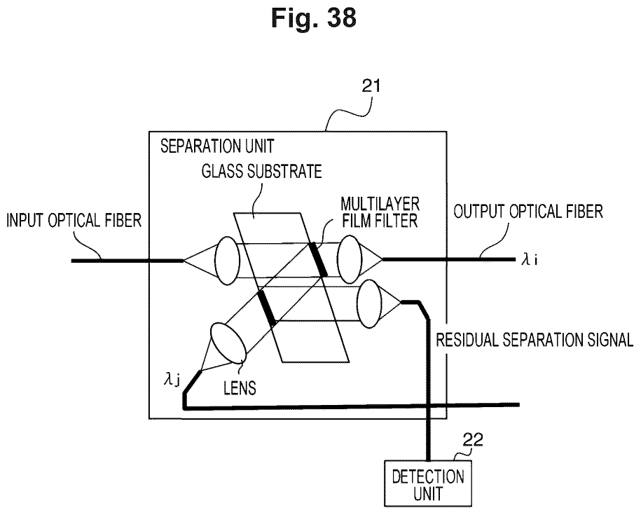

FIG. 38 is a diagram illustrating a configuration example of the TFF 214 with oblique incidence. As illustrated in FIG. 38, a wavelength component traveling straight and a reflected wavelength component are separated on the same optical axis. For example, the desired separation signal of the first desired signal is transmitted through the upper right lens as a wavelength component traveling straight, the second desired signal and the residual signal are reflected as a reflected wavelength component, and then the desired separation signal of the second desired signal is transmitted through the lower left lens. The reflected residual separation signal is output to the detection unit 22 via the lower right lens.

Accordingly, the separation unit 21 may be configured without using a circulator by condensing light on different fibers. In particular, FIG. 38 illustrates a configuration in which the desired separation signal of the first desired signal, the desired separation signal of the second desired signal, and the residual separation signal are collected from the input signal without using a circulator and output by different fibers. It may be configured such that light from the user device is incident on the TFF at a predetermined angle, emission of light having an angle at which a desired wavelength is reflected out of the reflected light is condensed on an output to the first side, and emission of light having an angle at which a residual wavelength is reflected is input to the detection unit 22. With this configuration, the separation unit 21 may be configured without using a circulator. For example, in a case where the configuration illustrated in FIG. 36 is configured using the TFF 214 with oblique incidence, a signal (desired separation signal) of a proper wavelength may be output from λj (lower left) of FIG. 38 by reflecting the proper wavelength by the first filter and transmitting the same by the next filter. In this case, λi (upper right) may be connected to the detection unit 22. In this case, (residual separation signal) is output from λi (upper right). With such a configuration, a configuration corresponding to FIG. 36 can be implemented without using a circulator. In this manner, the TFF 214 with oblique incidence can be used to set the output destination of the condensed light as the detection unit 22 or the first side. Note that whether to reflect or transmit a proper wavelength (desired separation signal) may be appropriately selected according to the setting.

Using the TFF 214 with oblique incidence illustrated in FIG. 38, FIGS. 35 to 37 and 39 that transmit a desired wavelength may be configured, or FIGS. 40 to 44 that reflect a desired wavelength to be described later may be configured.

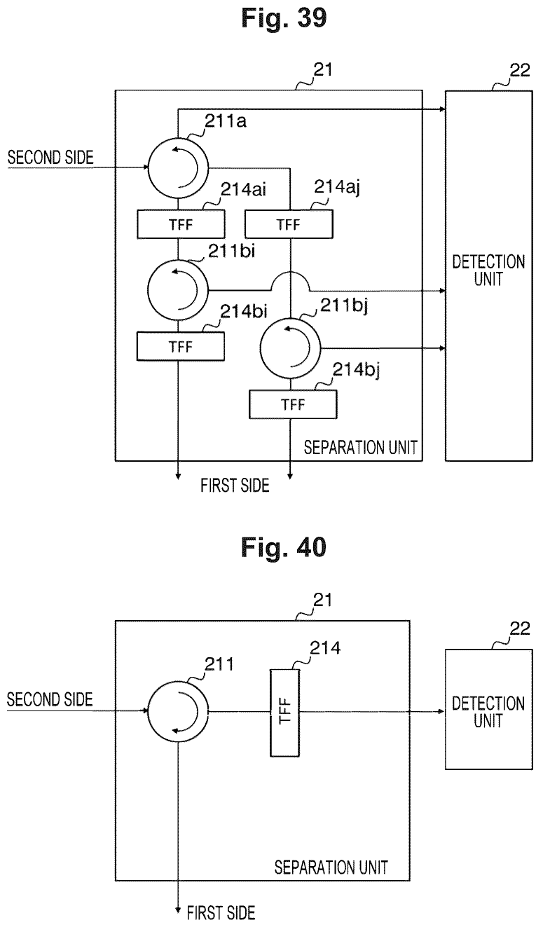

FIG. 39 is a diagram illustrating a fourth configuration example in which the separation unit 21 is configured using a TFF. In the example illustrated in FIG. 39, the separation unit 21 includes a plurality of circulators 211 (for example, the circulator 211a, a circulator 211bi, and a circulator 211bj) and a plurality of TFFs 214 (for example, the TFF 214ai, the TFF 214aj, a TFF 214bi, and a TFF 214bj). The circulator 211a inputs an optical signal input from the second side to the TFF 214ai. The circulator 211a inputs an optical signal input from the TFF 214ai to the TFF 214aj. The circulator 211a inputs an optical signal input from the TFF 214aj to the detection unit 22. Note that although FIG. 39 illustrates a cascade configuration of two wavelengths in two stages, a cascade configuration of three or more stages of two wavelengths may be employed, or a cascade configuration of three or more wavelengths may be employed.

The TFF 214ai passes the desired separation signal of the first desired signal among the optical signals input from the circulator 211a and inputs the signal to the circulator 211bi, reflects the desired separation signal and the residual separation signal of the second desired signal, and inputs the signal to the circulator 211a. The circulator 211bi inputs an optical signal input from the TFF 214ai to the TFF 214bi. The circulator 211bi inputs an optical signal input from the TFF 214bi to the detection unit 22. The TFF 214bi outputs the desired separation signal of the first desired signal among the optical signals input from the circulator 211bi to the transmission path, reflects the desired separation signal and the residual separation signal of the second desired signal, and outputs the reflected signals to the detection unit 22.

The TFF 214aj passes the desired separation signal of the second desired signal among the optical signals input from the circulator 211a and inputs the signal to the circulator 211bj, and reflects the residual separation signal and the remaining first desired signal and inputs the signals to the circulator 211a. The circulator 211bj inputs an optical signal input from the TFF 214aj to the TFF 214bj. The circulator 211bj inputs an optical signal input from the TFF 214bj to the detection unit 22. The TFF 214bj outputs the desired separation signal of the second desired signal among the optical signals input from the circulator 211bj to the transmission path, reflects the residual separation signal and the remaining first desired signal, and inputs the reflected signal to the circulator 211bj. The output of the circulator 211bj is input to the detection unit 22.

With such a configuration, it is possible to further remove, in the TFF 214bi, the optical signals having the second desired wavelength and the residual wavelength that cannot be removed in the TFF 214ai. In addition, it is possible to further remove, in the TFF 214bj, an optical signal having a residual wavelength that cannot be removed in the TFF 214aj. Only the output of one of the circulator 211a, the circulator 211bi, and the circulator 211bj may be input to the detection unit 22, any two of the outputs may be input thereto, or all the outputs may be input thereto. For example, the outputs (desired separation signals) of the TFF 214bi and the TFF 214bj are preferable for a process of estimating leakage of remaining light (residual signal) into the desired separation signal. That is, the residual separation signal may be detected by reflection of any of the circulator 211a in the preceding stage, and the circulator 211bi and the circulator 211bj in the subsequent stage. In the reflection in the preceding stage, the intensity of the residual separation signal is larger than that in the reflection in the subsequent stage, and thus the sensitivity is higher than that in the subsequent stage. In the reflection in the subsequent stage, since demultiplexing is not performed again in the subsequent stage as in the preceding stage, it is easy to estimate leakage of the residual signal to the first side.

The isolator 23 may be provided between the separation unit 21 and the detection unit 22. Furthermore, the isolator 23 is not limited to be provided between the separation unit 21 and the detection unit 22, and may be provided in a portion where an optical signal is not intended to be reflected. For example, the isolator 23 may be provided between the TFF 214ai and the circulator 211bi, or the isolator 23 may be provided between the TFF 214bj and the circulator 211bj. Providing the isolator 23 in this manner is similar in other embodiments and other specific examples.

Note that the circulator 211bi and the circulator 211bj may not necessarily be provided. In that case, since the residual separation signal separated in the TFF 214bi and the TFF 214bj is not input to the detection unit 22, the accuracy of the processing in the detection unit 22 may slightly decrease, but it is possible to remove the remaining component of the residual signal from the desired separation signal. Note that, in a case where the circulator 211bi and the circulator 211bj are not provided, it is desirable to provide an isolator. This isolator is desirably provided particularly between the TFF 214 and the TFF 214.

The configurations of FIGS. 40, 41, 42, and 43 for reflecting a proper wavelength using the multilayer film filter are similar to the configurations of FIGS. 27, 28, 31, and 32 for reflecting a proper wavelength using an FBG. Each will be described below.

FIG. 40 is a diagram illustrating a fifth configuration example in which the separation unit 21 is configured using a TFF. The separation unit 21 includes the circulator 211 and the TFF 214. The circulator 211 inputs an optical signal input from the second side to the TFF 214. The circulator 211 outputs the optical signal input from the TFF 214 to the first side. The circulator 211 may be configured using, for example, a coupler/splitter in similarly to as described with reference to FIG. 27. Note that, also in the configuration using the TFF 214 and the circulator 211 described below, the circulator 211 may be configured as described above. The TFF 214 reflects an optical signal having a desired wavelength and transmits an optical signal having a residual wavelength. By such reflection and transmission, the desired separation signal and the residual separation signal are separated from the separation input signal.

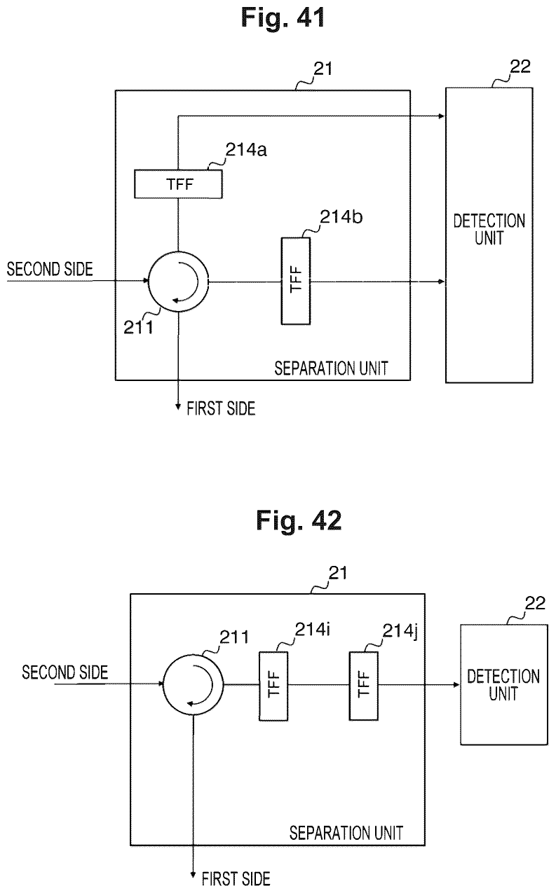

FIG. 41 is a diagram illustrating a sixth configuration example in which the separation unit 21 is configured using TFFs. In the example illustrated in FIG. 41, the separation unit 21 includes the circulator 211 and a plurality of TFFs 214 (for example, two TFFs (TFF 214a and TFF 214b)). The circulator 211 inputs an optical signal input from the second side to the TFF 214a. The circulator 211 inputs an optical signal input from the TFF 214a to the TFF 214b. The circulator 211 outputs the optical signal input from the TFF 214b to the first side. The TFF 214a and the TFF 214b reflect an optical signal having a desired wavelength and transmit an optical signal having a residual wavelength. By such reflection and transmission, the desired separation signal and the residual separation signal are separated from the separation input signal. Note that, although FIG. 41 illustrates a cascade configuration of two stages, a cascade configuration of three or more stages may be employed.

With such a configuration, it is possible to further remove, in the TFF 214b, an optical signal having the residual wavelength that cannot be removed in the TFF 214a. Only the output of one of the TFF 214a and the TFF 214b may be input to the detection unit 22, or both may be input thereto. In a case where only the output of one of the TFF 214a and the TFF 214b is input to the detection unit 22, the output of the other may be configured as a non-reflection termination or may be connected to an isolator. The isolator 23 may be provided between the separation unit 21 and the detection unit 22.

FIG. 42 is a diagram illustrating a seventh configuration example in which the separation unit 21 is configured using TFFs. The separation unit 21 includes the circulator 211, a TFF 214i, and a TFF 214j. The circulator 211 inputs an optical signal input from the second side to the TFF 214i and the TFF 214j. The circulator 211 outputs optical signals input from the TFF 214i and the TFF 214j to the first side. The TFF 214i reflects an optical signal having the first desired wavelength (first desired signal) and transmits an optical signal having another wavelength (second desired wavelength and residual wavelength). The TFF 214j reflects an optical signal having the second desired wavelength (second desired signal), and transmits an optical signal having another wavelength (the residual wavelength and the first desired wavelength that has not been reflected by the TFF 214i on the preceding stage and has been transmitted).

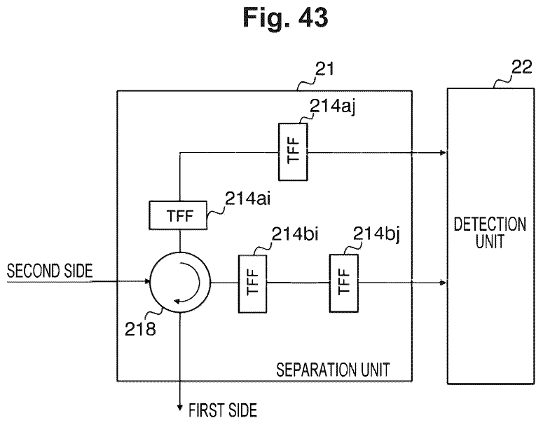

FIG. 43 is a diagram illustrating an eighth configuration example in which the separation unit 21 is configured using TFFs. In the example illustrated in FIG. 43, the separation unit 21 includes the circulator 211 and a plurality of TFFs 214 (TFF 214ai, TFF 214aj, TFF 214bi, and TFF 214bj). The circulator 211 inputs an optical signal input from the second side to the TFF 214ai. The circulator 211 inputs an optical signal input from the TFF 214ai to the TFF 214bi. The circulator 211 outputs the optical signal input from the TFF 214bi to the first side. Although FIG. 30 illustrates a cascade configuration of two stages, a cascade configuration of three or more stages may be employed. Note that, from the viewpoint of equalizing propagation delays, multiple stages are desirable.

The TFF 214ai and the TFF 214bi reflect the optical signal having the first desired wavelength (first desired signal) among the optical signals input from the circulator 211 side, and transmit optical signals having other wavelengths (second desired wavelength and residual wavelength). The TFF 214aj and the TFF 214bj reflect an optical signal having the second desired wavelength (second desired signal) among the optical signals input from the TFF 214ai and the TFF 214bi, respectively, and transmit an optical signal having other wavelengths (residual wavelength and first desired wavelength transmitted without being reflected by the TFF 214ai or the TFF 214bi at the preceding stage). The TFF 214ai and the TFF 214bi input light input from the TFF 214aj and the TFF 214bj, respectively, to the circulator 211. Transmission of the TFF 214aj and the TFF 214bj is output to the detection unit 22.

With such a configuration, it is possible to further remove, in the TFF 214bi and the TFF 214bj, an optical signal having a residual wavelength that cannot be removed in the TFF 214ai and the TFF 214aj. Only the output of one of the TFF 214aj and the TFF 214bj may be input to the detection unit 22, or both may be input thereto. In a case where only the output of one of the TFF 214aj and the TFF 214bj is input to the detection unit 22, the output of the other may be configured as a non-reflection termination or may be connected to an isolator. The isolator 23 may be provided between the separation unit 21 and the detection unit 22.

Further, as described in the description of FIGS. 32 and 34, also in the configuration of FIG. 43, propagation delays of optical signals of a plurality of proper wavelengths reflected by the TFF 214 may be equalized to the same value. For example, by making the reflection wavelengths of the TFF 214ai and the TFF 214bj the same, making the reflection wavelengths of the TFF 214aj and the TFF 214bi the same, and making the sum of the propagation delays of the TFF 214ai and the TFF 214bj and the sum of the propagation delays of the TFF 214aj and the TFF 214bi equal, the propagation delays of both wavelengths can be equalized. In order to equalize the sum of the propagation delays, for example, the propagation delays of the TFF 214ai and the TFF 214bi and the propagation delays of the TFF 214aj and the TFF 214bj may be configured to be the same.

### Specific Example 3: AWG

First, arrayed waveguide gratings (AWG) will be described.

The AWG is a transmission-type diffraction grating including a plurality of waveguides having different lengths. An input waveguide (group), an output waveguide group, and a fan-shaped slab waveguide are monolithically integrated on a substrate. In general, such an AWG is fabricated using a waveguide (for example, a quartz waveguide), such as on a silicon substrate. For example, the AWG may be constituted by an input waveguide (group), a slab waveguide, an arrayed waveguide, and an output waveguide group. Light from the input waveguide(s) diffracts at the input slab and propagates through the arrayed waveguide. The arrayed waveguide of the AWG is radially connected to the output-side slab. The light emitted from the AWG is condensed at a position corresponding to the input waveguide and the wavelength.

The length of the plurality of waveguides in the AWG is designed to increase, for example, by a certain amount ΔL. The phase difference between the waveguides depends on the wavelength. Since the condensing position differs depending on the wavelength, a spectroscopic operation can be obtained. For example, the waveguide interval of the AWG at a connection portion with the slab is d, the curvature radius (that is, a focal length) of the slab is f, the diffraction angle of a focused beam in the output slab is θ, the output waveguide interval is Δx, and the effective refractive index between the channel waveguide and the slab waveguide is nc and ns.

The diffraction angle θ and the wavelength satisfy the basic principle expression nc ΔL+ns d sin θ=mλ depending on the condition that the light beams from many waveguides reach the focal point in the same phase. m is the diffraction order (integer). In the expression, since θ is near 0, the diffraction order m is proportional to ΔL and is generally a large value of 10 or more. A general diffraction grating needs to be finely divided in order to increase line dispersion. Compared with such a general diffraction grating, in the AWG, it is possible to increase m by designing the length of the waveguide. Therefore, in the AWG, high resolution can be easily obtained.

The free spectral range (FSR) is expressed as follows.

FSR=c/(ngΔL)

Note that ng is a waveguide group refractive index and is expressed as follows.

Waveguide group refractive index ng: ng=nc−λ(dn/dλ)

Here, c is the speed of light in vacuum. There are many transmission wavelengths with FSR as a period. Accordingly, it is necessary to design FSR wider than the number of multiplexing×multiplexing interval, and ΔL has an upper limit. When a quartz waveguide having a relative refractive index difference of around 1% is used, a multiplexer/demultiplexer for DWDM having 80 waves at intervals of 50 GHz can be manufactured with a chip of several centimeters square.

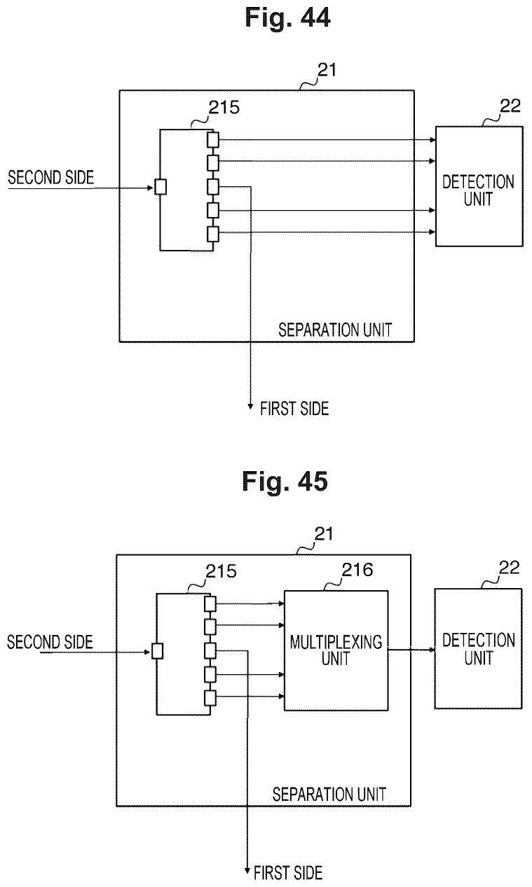

FIG. 44 is a diagram illustrating a first configuration example in which the separation unit 21 is configured using an AWG. The separation unit 21 includes an AWG 215. The AWG 215 outputs an optical signal input from the second side from a port corresponding to a wavelength. Among the plurality of output ports of the AWG 215, the output port from which the desired separation signal is output is connected to the first side. It is desirable that all the remaining output ports are connected to the detection unit 22. This is to prevent detection omission of the residual separation signal from occurring. The isolator 23 may be provided between the separation unit 21 and the detection unit 22. The isolator 23 may be provided, for example, between the AWG 215 and the multiplexer/demultiplexer. In this case, the cost increases because the number of isolators 23 increases, but a higher effect can be obtained.

Although a single-input AWG is used in the drawing, a double-input AWG may be used. In that case, in order to reduce the influence of reflection, ports that are not used are non-reflection terminated or an isolator is connected. The same applies to the following configurations.

FIG. 45 is a diagram illustrating a second configuration example in which the separation unit 21 is configured using an AWG. The separation unit 21 includes the AWG 215 and a multiplexing unit 216. The AWG 215 outputs an optical signal input from the second side from a port corresponding to a wavelength. Among the plurality of output ports of the AWG 215, the output port from which the desired separation signal is output is connected to the first side. The remaining output ports are connected to the multiplexing unit 216. The multiplexing unit 216 multiplexes a plurality of residual separation signals input from the AWG 215 and outputs the resultant signal to the detection unit 22. Any device may be applied to the multiplexing unit 216 as long as the device can multiplex optical signals of a plurality of wavelengths. For example, the multiplexing unit 216 may be configured using an AWG. In this case, a plurality of output ports that output the residual separation signal of the AWG 215 is connected to input ports of the multiplexing unit 216 (AWG) according to the wavelength of each residual signal. The multiplexing unit 216 may be configured using a coupler/splitter. The isolator 23 may be provided between the separation unit 21 and the detection unit 22. Note that, in order to prevent the output improper wavelength component from being blocked by the multiplexer/demultiplexer and not detected, the multiplexing unit 216 desirably has a wavelength transmission characteristic equivalent to that of the AWG 215 or has less block than that, for example, has a large crosstalk between adjacent channels, that is, between adjacent ports.

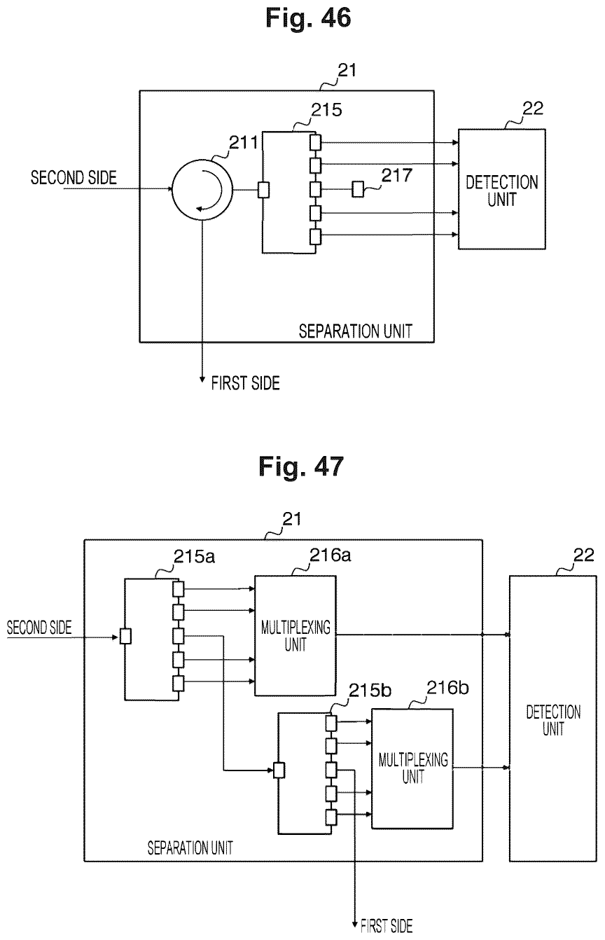

FIG. 46 is a diagram illustrating a third configuration example in which the separation unit 21 is configured using an AWG. The separation unit 21 includes the circulator 211, the AWG 215, and a reflection unit 217. The circulator 211 inputs an optical signal input from the second side to the AWG 215. The configuration of the circulator 211 is as described above. Among the plurality of output ports of the AWG 215, the output port from which the desired separation signal is output is connected to the reflection unit 217. The remaining output ports are connected to the detection unit 22. The reflection unit 217 reflects an optical signal (at least the desired separation signal) input from the AWG 215. The reflected desired separation signal is input to the circulator 211 via the AWG 215. The reflection unit 217 may be configured using, for example, a total reflector, or may be configured using a reflector such as an FBG that reflects a specific wavelength, here, at least a proper wavelength component. The reflection unit 217 may employ any configuration as long as it can reflect the desired separation signal. The circulator 211 outputs the optical signal input from the AWG 215 to the first side.

In the configuration in which a desired signal is reflected by the reflection unit 217 in this manner, the desired signal passes through the AWG 215 twice, and thus the ability to block a wavelength other than the desired wavelength is substantially twice the ability of the original AWG 215. The insertion loss of the desired signal is doubled, and the reflectance of the reflection end is also reduced. If the reflection is incomplete, the reflection is reduced by that amount. For example, 99% reflection results in 1% reduction, and 99.9% reflection results in 0.1% reduction. The reflection unit may be a reflection unit that performs total reflection, or may be a reflection unit that reflects a desired wavelength (for example, FBG, TFF, or the like that reflects a desired wavelength). By using a reflection unit that reflects a desired wavelength, the block capability can be improved. The same applies to the following embodiments.

Here, similarly to FIG. 44, the outputs of the AWGs 215 that are not output to the first side are each input to the detection unit 22, but similarly to FIG. 45, some or all of the outputs may be aggregated via the multiplexing unit 216 and then input to the detection unit 22. The same applies to the following embodiments.

FIG. 47 is a diagram illustrating a fifth configuration example in which the separation unit 21 is configured using AWGs. The separation unit 21 includes a plurality of AWGs 215 and a plurality of multiplexing units 216. An AWG 215a outputs an optical signal input from the second side to the separation unit 21 from a port corresponding to a wavelength. Among the plurality of output ports of the AWG 215a, an output port from which an optical signal having a desired wavelength is output is connected to an input port of the next stage AWG 215b (located on the first side relative to the own device). The remaining output ports of the AWG 215a are connected to a multiplexing unit 216a. The multiplexing unit 216a multiplexes a plurality of residual separation signals input from the AWG 215a and outputs the resultant signal to the detection unit 22. Note that, although FIG. 47 illustrates a cascade configuration of two stages, a cascade configuration of three or more stages may be employed.

The AWG 215b outputs an optical signal (desired separation signal) input from the AWG 215a located in the preceding stage (located on the second side relative to the own device) from a port corresponding to the wavelength. Among the plurality of output ports of the AWG 215b, an output port from which an optical signal having a desired wavelength is output is connected to the first side. The remaining output ports of the AWG 215b are connected to a multiplexing unit 216b. The multiplexing unit 216b multiplexes a plurality of residual separation signals input from the AWG 215b and outputs the resultant signal to the detection unit 22.

With such a configuration, the AWG 215b can further remove an optical signal having a residual wavelength that cannot be removed by the AWG 215a. Only the output of one of the multiplexing unit 216a and the multiplexing unit 216b may be input to the detection unit 22, or both may be input thereto. In a case where only the output of one of the multiplexing unit 216a and the multiplexing unit 216b is input to the detection unit 22, the output of the other may be configured as a non-reflection termination so as not to be reflected to the second side, or may be connected to an isolator. The isolator 23 may be provided between the separation unit 21 and the detection unit 22.

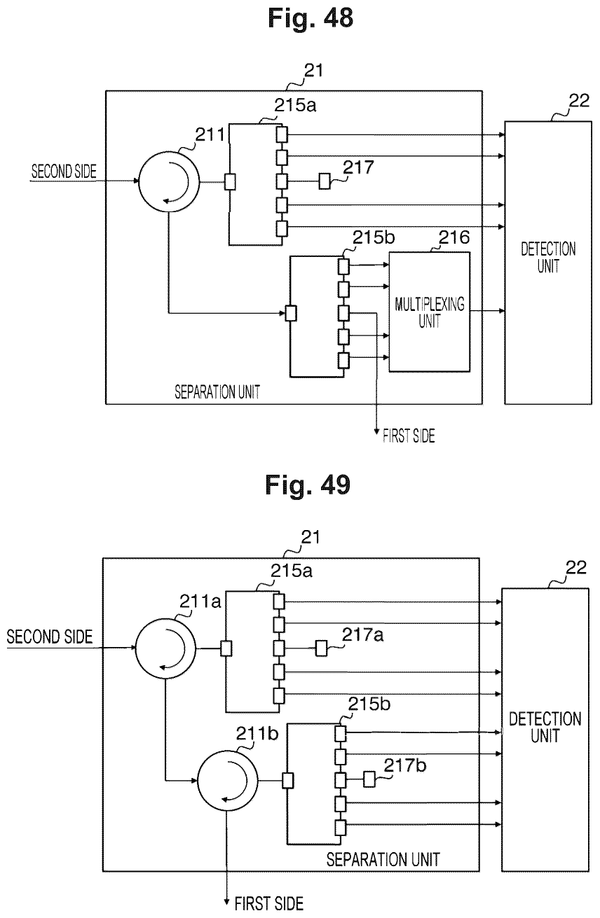

Here, the AWG 215a and the AWG 215b are aggregated via the multiplexing unit 216 and then input to the detection unit 22 as in FIG. 45, but the outputs of the AWG 215 (AWG 215a) that are not output to the first side may be individually input to the detection unit 22 without passing through the multiplexing unit 216 as in FIG. 44. Note that, although the configuration illustrated in FIG. 45 has been described as a base, one or both of the configurations may be replaced with the configuration illustrated in FIG. 46. FIGS. 48 and 49 illustrate an example in which the preceding stage is replaced with the configuration illustrated in FIG. 46 and an example in which both are replaced with the configuration illustrated in FIG. 46, respectively.

FIG. 48 is a diagram illustrating a sixth configuration example in which the separation unit 21 is configured using AWGs. Since the configuration of FIG. 48 uses different AWGs 215, there is an effect that AWGs 215 having different transmission characteristics can be combined. For example, in order to more easily detect mixture of the residual signal, an AWG having a gentle transmission characteristic with respect to a wavelength and having a transmission characteristic overlapping with each other between adjacent channels may be used in the preceding stage (AWG 215a), and an AWG in which adjacent channels are further blocked may be used in the subsequent stage (AWG 215b) so that mixture of the residual signal is small on the first side. Such a configuration is not limited to the configuration of FIG. 48, and the same applies to, for example, the configuration illustrated in FIG. 47 and the configuration illustrated in FIG. 49.

The separation unit 21 includes the circulator 211, the plurality of AWGs 215, the multiplexing unit 216, and the reflection unit 217. The circulator 211 inputs an optical signal input from the second side to the AWG 215a. The configuration of the circulator 211 is as described above. The AWG 215a outputs the optical signal input from the circulator 211 from a port corresponding to a wavelength. Among the plurality of output ports of the AWG 215a, an output port from which an optical signal having a desired wavelength is output is connected to the reflection unit 217. The remaining output ports of the AWG 215a are connected to the detection unit 22.

The reflection unit 217 reflects the optical signal (at least the desired separation signal) input from the AWG 215a. The reflected desired separation signal is input to the circulator 211 via the AWG 215a. The configuration of the reflection unit 217 is as described above. The circulator 211 outputs the optical signal (desired separation signal) input from the AWG 215a to the AWG 215b. The AWG 215b outputs the optical signal (desired separation signal) input from the circulator 211 from a port corresponding to a wavelength. Among the plurality of output ports of the AWG 215b, an output port from which an optical signal having a desired wavelength is output is connected to the first side. The remaining output ports of the AWG 215b are connected to the multiplexing unit 216. The multiplexing unit 216 multiplexes a plurality of residual separation signals input from the AWG 215b and outputs the resultant signal to the detection unit 22.

With such a configuration, the AWG 215b can further remove an optical signal having a residual wavelength that cannot be removed by the AWG 215a.

The output of the preceding stage (AWG 215a) is individually input to the detection unit 22 as in FIG. 44, and the output of the subsequent stage (AWG 215b) is aggregated via the multiplexing unit 216 and then input to the detection unit 22 as in FIG. 45. However, the output method may be switched between the preceding stage and the subsequent stage, or may be unified to one of the output methods.

Only the output of one of the AWG 215a and the multiplexing unit 216b may be input to the detection unit 22, or both may be input thereto. In a case where only the output of one of the AWG 215a and the multiplexing unit 216 is input to the detection unit 22, the output of the other may be configured as a non-reflection termination or may be connected to an isolator. The isolator 23 may be provided between the separation unit 21 and the detection unit 22.

FIG. 49 is a diagram illustrating a seventh configuration example in which the separation unit 21 is configured using AWGs. The separation unit 21 includes a plurality of circulators 211, a plurality of AWGs 215, and a plurality of reflection units 217. The circulator 211a inputs an optical signal input from the second side to the AWG 215a. Note that the configurations of the circulator 211a and the circulator 211b are as described above. The AWG 215a outputs the optical signal input from the circulator 211a from a port corresponding to a wavelength. Among the plurality of output ports of the AWG 215a, an output port from which an optical signal having a desired wavelength is output is connected to the reflection unit 217a. The remaining output ports of the AWG 215a are connected to the detection unit 22. Note that, although FIG. 49 illustrates a cascade configuration of two stages, a cascade configuration of three or more stages may be employed.

The reflection unit 217a reflects the optical signal (at least the desired separation signal) input from the AWG 215a. The reflected desired separation signal is input to the circulator 211a via the AWG 215a. Note that the configurations of the reflection unit 217a and the reflection unit 217b are as described above. The circulator 211a inputs the optical signal (desired separation signal) input from the AWG 215a to the circulator 211b. The circulator 211b inputs the optical signal input from the circulator 211a to the AWG 215b. The AWG 215b outputs the optical signal (desired separation signal) input from the circulator 211b from a port corresponding to a wavelength. Among the plurality of output ports of the AWG 215b, an output port from which an optical signal having a desired wavelength is output is connected to the reflection unit 217b. The remaining output ports of the AWG 215b are connected to the detection unit 22.

In both the preceding stage (AWG 215a) and the subsequent stage (AWG 215b), the output of the AWG 215 is individually input to the detection unit 22 as in FIG. 44, but any one or both AWGs 215 may be aggregated via the multiplexing unit 216 and then input to the detection unit 22 as in FIG. 45.

The reflection unit 217b reflects the optical signal (at least the desired separation signal) input from the AWG 215b. The reflected desired separation signal is input to the circulator 211b via the AWG 215b. The circulator 211b outputs the optical signal (desired separation signal) input from the AWG 215b to the first side. The remaining output ports of the AWG 215b are connected to the detection unit 22.

With such a configuration, the AWG 215b can further remove an optical signal having a residual wavelength that cannot be removed by the AWG 215a. Only the output of one of the AWG 215a and the AWG 215b may be input to the detection unit 22, or both may be input thereto. In a case where only the output of one of the AWG 215a and the AWG 215b is input to the detection unit 22, the output of the other may be configured as a non-reflection termination or may be connected to an isolator. The isolator 23 may be provided between the separation unit 21 and the detection unit 22.

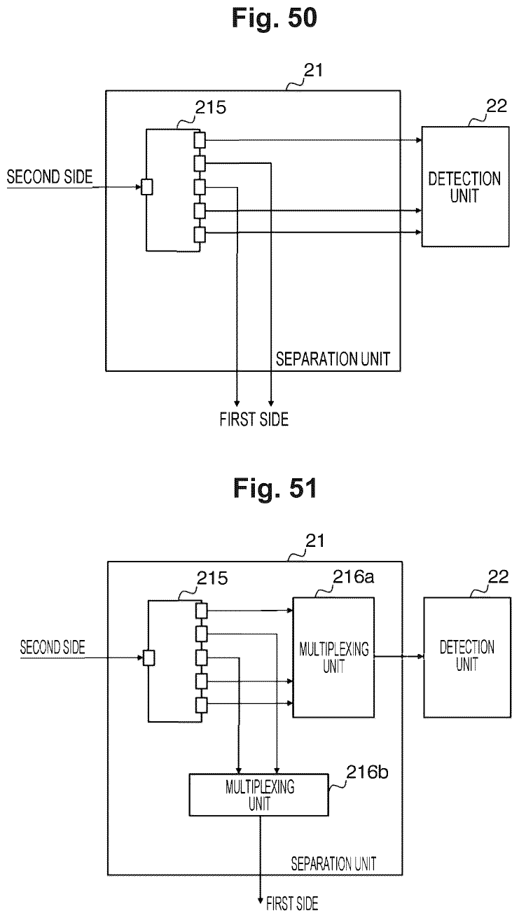

In the configurations illustrated in FIGS. 50 to 55 described below, desired signals of a plurality of wavelengths are used. In order to simplify the description, in the following description, it is assumed that a first desired signal having a first desired wavelength λi and a second desired signal having a second desired wavelength λj are separated from the residual signal other than the first desired signal and the second desired signal.

Note that, in a case where a plurality of inputs, which are an input in which only the first desired wavelength is a proper wavelength component and an input in which only the second desired wavelength is a proper wavelength component, are multiplexed and input, it is not possible to detect that an improper wavelength component of the second desired wavelength is mixed in the input in which only the first desired wavelength is a proper wavelength component and that an improper wavelength component of the first desired wavelength is mixed in the input in which only the second desired wavelength is a proper wavelength component. Also, leakage of the second desired wavelength into the path of the first desired wavelength and leakage of the first desired wavelength into the path of the second desired wavelength cannot be eliminated. That is, in a case where leakage of a residual wavelength between desired wavelengths is negligible, these embodiments are applicable.

FIG. 50 is a diagram illustrating an eighth configuration example in which the separation unit 21 is configured using an AWG. The separation unit 21 includes an AWG 215. The AWG 215 outputs an optical signal input from the second side from a port corresponding to a wavelength. Among the plurality of output ports of the AWG 215, an output port from which an optical signal having the first desired wavelength is output and an output port from which an optical signal having the second desired wavelength is output are connected to the first side. The remaining output ports are connected to the detection unit 22. The isolator 23 may be provided between the separation unit 21 and the detection unit 22.

FIG. 51 is a diagram illustrating a ninth configuration example in which the separation unit 21 is configured using an AWG. The separation unit 21 includes the AWG 215 and a plurality of multiplexing units 216. The AWG 215 outputs an optical signal input from the second side from a port corresponding to a wavelength. Among the plurality of output ports of the AWG 215, an output port from which an optical signal having the first desired wavelength is output and an output port from which an optical signal having the second desired wavelength is output are connected to the multiplexing unit 216b. The multiplexing unit 216b multiplexes a plurality of input desired separation signals (the desired separation signal of the first desired signal and the desired separation signal of the second desired signal) and outputs the resultant signal to the first side. A remaining output port (an output port from which the residual separation signal is output) of the AWG 215 is connected to the multiplexing unit 216a. The multiplexing unit 216a multiplexes a plurality of residual separation signals input from the AWG 215 and outputs the resultant signal to the detection unit 22. The configuration of the multiplexing unit 216 is as described above. The isolator 23 may be provided between the separation unit 21 and the detection unit 22.

The output of the AWG 215 may be individually input to the detection unit 22 as in FIG. 50. The wavelength characteristic of the multiplexing unit 216a is similar to that connected to the detection unit 22 of the previous embodiment. The wavelength characteristic of the multiplexing unit 216b can be utilized similarly to the AWG (AWG 215b) in the subsequent stage of FIG. 47, and thus the wavelength characteristic equivalent to the AWG 215 is favorable from the viewpoint of improving the block capability. However, the wavelength characteristic of the AWG 215 may be similar to that of the gentle preceding stage (AWG 215a) in FIG. 47, and the wavelength characteristic of the multiplexing unit 216b may be similar to that of the non-gentle subsequent stage (AWG 215b) in FIG. 47. In addition, in a case where the number of wavelengths of the desired wavelength is particularly small and loss due to multiplexing can be tolerated, the multiplexing unit 216b may perform multiplexing by a coupler/splitter.

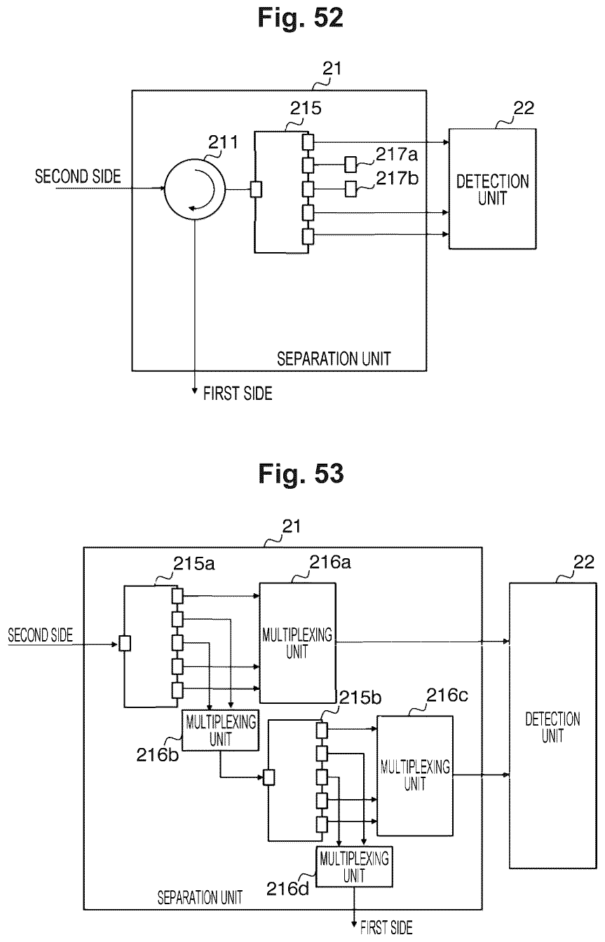

FIG. 52 is a diagram illustrating a tenth configuration example in which the separation unit 21 is configured using an AWG. The separation unit 21 includes the circulator 211, the AWG 215, and a plurality of reflection units 217. The reflection units 217 are provided according to the number of desired wavelengths to be used. The circulator 211 inputs an optical signal input from the second side to the AWG 215. The configuration of the circulator 211 is as described above. Among the plurality of output ports of the AWG 215, the output port from which the desired separation signal is output is connected to the reflection units 217. Specifically, an output port from which the desired separation signal of the first desired signal is output is connected to the reflection unit 217a, and an output port from which the desired separation signal of the second desired signal is output is connected to the reflection unit 217b. The remaining output ports are connected to the detection unit 22.

The reflection unit 217a reflects an optical signal (at least the desired separation signal of the first desired signal) input from the AWG 215. The reflection unit 217b reflects an optical signal (at least the desired separation signal of the second desired signal) input from the AWG 215. The reflected desired separation signal of the first desired signal and the reflected desired separation signal of the second desired signal are input to the circulator 211 via the AWG 215. The configurations of the reflection unit 217a and the reflection unit 217b are as described above. The circulator 211 outputs the optical signal (the desired separation signal of the first desired signal and the desired separation signal of the second desired signal) input from the AWG 215 to the first side. In the configuration in which the desired separation signal is reflected by the reflection unit 217 as described above, the ability to block a wavelength other than a desired wavelength is substantially doubled. The insertion loss of the desired signal is doubled, and the reflectance of the reflection end is also reduced. Note that the multiplexing unit 216a as illustrated in FIG. 51 may be provided between the AWG 215 and the detection unit 22. With such a configuration, the multiplexing unit 216a can multiplex a plurality of residual separation signals of the AWG 215 as one residual separation signal and output the resultant signal to the detection unit 23.

The configuration examples illustrated in FIGS. 50 to 52 may be connected in a cascade. With such a configuration, it is possible to improve the block capability. Specific examples of such a configuration are illustrated in FIGS. 53 to 55.

FIG. 53 is a diagram illustrating a twelfth configuration example in which the separation unit 21 is configured using AWGs. The separation unit 21 includes a plurality of AWGs 215 and a plurality of multiplexing units 216. An AWG 215a outputs an optical signal input from the second side to the separation unit 21 from a port corresponding to a wavelength. Among the plurality of output ports of the AWG 215a, an output port from which an optical signal having a desired wavelength is output is connected to the multiplexing unit 216b. Specifically, an output port from which the desired separation signal of the first desired signal is output and an output port from which the desired separation signal of the second desired signal is output are connected to the multiplexing unit 216b. The multiplexing unit 216b is connected to an input port of the AWG 215b. The multiplexing unit 216b multiplexes the desired separation signal of the input first desired signal and the desired separation signal of the second desired signal, and outputs the resultant signal to the AWG 215b. The remaining output ports of the AWG 215a are connected to a multiplexing unit 216a. The multiplexing unit 216a multiplexes a plurality of residual separation signals input from the AWG 215a and outputs the resultant signal to the detection unit 22. Note that, although FIG. 53 illustrates a cascade configuration of two stages, a cascade configuration of three or more stages may be employed.

The AWG 215b outputs an optical signal (a multiplexed signal of the desired separation signal of the first desired signal and the desired separation signal of the second desired signal) input from the multiplexing unit 216b from a port corresponding to a wavelength. Among the plurality of output ports of the AWG 215b, an output port from which an optical signal having a desired wavelength is output is connected to the multiplexing unit 216d. Specifically, an output port from which the desired separation signal of the first desired signal is output and an output port from which the desired separation signal of the second desired signal is output are connected to the multiplexing unit 216d. The multiplexing unit 216d is connected to the first side. The multiplexing unit 216d multiplexes the desired separation signal of the input first desired signal and the desired separation signal of the second desired signal, and outputs the resultant signal to the first side. The remaining output ports of the AWG 215b are connected to the multiplexing unit 216c. The multiplexing unit 216c multiplexes a plurality of residual separation signals input from the AWG 215b and outputs the resultant signal to the detection unit 22.

Note that one or both of the multiplexing unit 216a and the multiplexing unit 216c may not necessarily be provided. In that case, the outputs of the AWGs 215 in which the multiplexing unit 216 is not provided in the subsequent stage are individually input to the detection unit 22 without being aggregated. In addition, the multiplexing unit 216d may not necessarily be provided. In that case, the outputs to the first side of the separation unit 215b are individually output without being aggregated.

With such a configuration, with respect to the first desired signal and the second desired signal, an optical signal having a residual wavelength that cannot be removed by the AWG 215a can be further removed by the AWG 215b. Only the output of one of the multiplexing unit 216a and the multiplexing unit 216b may be input to the detection unit 22, or both may be input thereto. In a case where only the output of one of the multiplexing unit 216a and the multiplexing unit 216b is input to the detection unit 22, the output of the other may be configured as a non-reflection termination or may be connected to an isolator. The isolator 23 may be provided between the separation unit 21 and the detection unit 22.

Note that, in the configuration illustrated in FIG. 53, the multiplexing unit 216 may not be provided. In this case, a plurality of (two in FIG. 53) desired separation signals output from the AWG 215a are input to different AWGs 215 (AWGs 215 in the subsequent stage) instead of the AWG 215b. For example, a configuration illustrated in FIGS. 44 to 46 may be applied to the AWG 215 in the subsequent stage. When the configuration of FIG. 45 is employed, the multiplexing unit 216 is also used together with the AWG 215, and when the configuration of FIG. 46 is employed, the circulator 211 and the reflection unit 217 are also used together with the AWG 215. Each AWG 215 has a configuration corresponding to a desired wavelength in each desired separation signal output from the AWG 215a. Note that the output on the second wavelength side of the AWG 215 in the subsequent stage connected to the first wavelength side may be input to the detection unit 22, may be configured as a non-reflection termination, or may be discarded via an isolator. That is, the output on the second wavelength side of the AWG 215 in the subsequent stage connected to the first wavelength side may not be output to the first side. In addition, the output on the first wavelength side of the AWG 215 in the subsequent stage connected to the second wavelength side may be input to the detection unit 22, may be configured as a non-reflection termination, or may be discarded via an isolator. That is, the output on the first wavelength side of the AWG 215 in the subsequent stage connected to the second wavelength side may not be output to the first side.

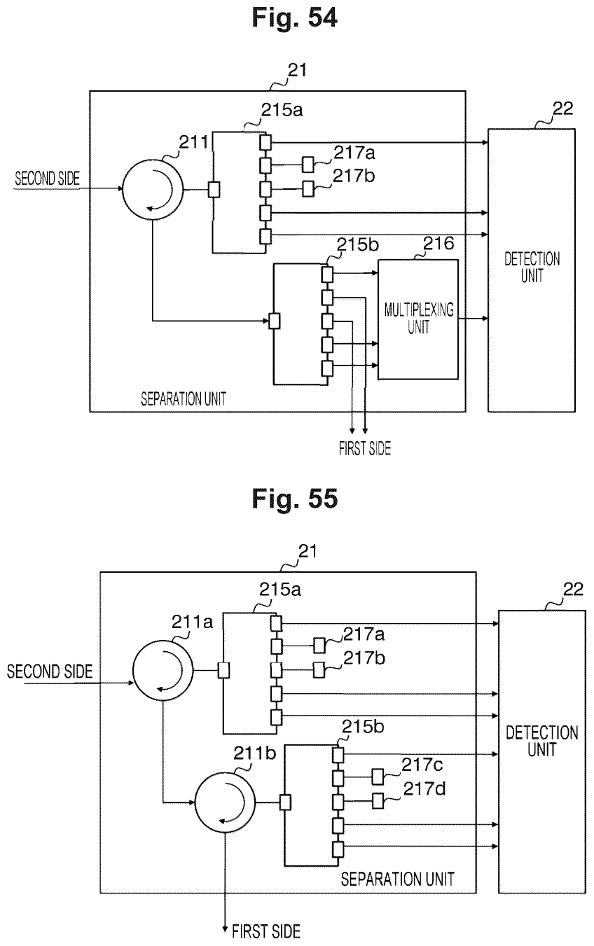

FIG. 54 is a diagram illustrating a thirteenth configuration example in which the separation unit 21 is configured using AWGs. The separation unit 21 includes the circulator 211, a plurality of AWGs 215, the multiplexing unit 216, and a plurality of reflection units 217. The circulator 211 inputs an optical signal input from the second side to the AWG 215a. The configuration of the circulator 211 is as described above. The AWG 215a outputs the optical signal input from the circulator 211 from a port corresponding to a wavelength. Among the plurality of output ports of the AWG 215a, an output port from which an optical signal having a desired wavelength is output is connected to the reflection units 217. Specifically, an output port from which the desired separation signal of the first desired signal is output is connected to the reflection unit 217a, and an output port from which the desired separation signal of the second desired signal is output is connected to the reflection unit 217b. The remaining output ports of the AWG 215a are connected to the detection unit 22.

The reflection unit 217a reflects the optical signal (at least the desired separation signal of the first desired signal) input from the AWG 215a. The desired separation signal of the reflected first desired signal is input to the circulator 211 via the AWG 215a. The reflection unit 217b reflects the optical signal (at least the desired separation signal of the second desired signal) input from the AWG 215a. The desired separation signal of the reflected second desired signal is input to the circulator 211 via the AWG 215a. The configurations of the reflection unit 217a and the reflection unit 217b are as described above.

The circulator 211 outputs the optical signal (the desired separation signal of the first desired signal and the desired separation signal of the second desired signal) input from the AWG 215a to the AWG 215b. The AWG 215b outputs the optical signal (the desired separation signal of the first desired signal and the desired separation signal of the second desired signal) input from the circulator 211 from a port corresponding to a wavelength. Among the plurality of output ports of the AWG 215b, the output port from which the optical signal having the first desired wavelength is output and the output port from which the optical signal having the second desired wavelength is output are connected to the first side. The remaining output ports of the AWG 215b are connected to the multiplexing unit 216. The multiplexing unit 216 multiplexes a plurality of residual separation signals input from the AWG 215b and outputs the resultant signal to the detection unit 22.

With such a configuration, with respect to the first desired signal and the second desired signal, an optical signal having a residual wavelength that cannot be removed by the AWG 215a can be further removed by the AWG 215b. Only the output of one of the AWG 215a and the multiplexing unit 216 may be input to the detection unit 22, or both may be input thereto. In a case where only the output of one of the AWG 215a and the multiplexing unit 216 is input to the detection unit 22, the output of the other may be configured as a non-reflection termination or may be connected to an isolator. The isolator 23 may be provided between the separation unit 21 and the detection unit 22. Note that the multiplexing unit 216 corresponding to the multiplexing unit 216b illustrated in FIG. 51 may be provided on the first side of the separation unit 215b. In addition, the multiplexing unit 216a illustrated in FIG. 51 may be connected to a plurality of output ports of the residual separation signal of the separation unit 215a. In addition, the multiplexing unit 216b illustrated in FIG. 51 may be connected to a plurality of output ports of the desired separation signal of the separation unit 215b.

FIG. 55 is a diagram illustrating a fourteenth configuration example in which the separation unit 21 is configured using AWGs. The separation unit 21 includes a plurality of circulators 211, a plurality of AWGs 215, and a plurality of reflection units 217. The circulator 211a inputs an optical signal input from the second side to the AWG 215a. Note that the configurations of the circulator 211a and the circulator 211b are as described above. The AWG 215a outputs the optical signal input from the circulator 211a from a port corresponding to a wavelength. Among the plurality of output ports of the AWG 215a, an output port from which an optical signal having a desired wavelength is output is connected to the reflection units 217. Specifically, an output port from which the desired separation signal of the first desired signal is output is connected to the reflection unit 217a, and an output port from which the desired separation signal of the second desired signal is output is connected to the reflection unit 217b. The remaining output ports of the AWG 215a are connected to the detection unit 22. Note that, although FIG. 55 illustrates a cascade configuration of two stages, a cascade configuration of three or more stages may be employed.

The reflection unit 217a reflects the optical signal (at least the desired separation signal of the first desired signal) input from the AWG 215a. The desired separation signal of the reflected first desired signal is input to the circulator 211a via the AWG 215a. The reflection unit 217b reflects the optical signal (at least the desired separation signal of the second desired signal) input from the AWG 215b. The desired separation signal of the reflected second desired signal is input to the circulator 211a via the AWG 215a. Note that the configurations of the reflection units 217a to 217d are as described above.

The circulator 211a inputs the optical signal (the desired separation signal of the first desired signal and the desired separation signal of the second desired signal) input from the AWG 215a to the circulator 211b. The circulator 211b inputs the optical signal input from the circulator 211a to the AWG 215b. The AWG 215b outputs an optical signal (the desired separation signal of the first desired signal and the desired separation signal of the second desired signal) input from the circulator 211b from a port corresponding to a wavelength. Among the plurality of output ports of the AWG 215b, an output port from which an optical signal having a desired wavelength is output is connected to the reflection units 217. Specifically, an output port from which the desired separation signal of the first desired signal is output is connected to the reflection unit 217c, and an output port from which the desired separation signal of the second desired signal is output is connected to the reflection unit 217d. The remaining output ports of the AWG 215b are connected to the detection unit 22.

The reflection unit 217c reflects the optical signal (at least the desired separation signal of the first desired signal) input from the AWG 215b. The desired separation signal of the reflected first desired signal is input to the circulator 211b via the AWG 215b. The reflection unit 217d reflects the optical signal (at least the desired separation signal of the second desired signal) input from the AWG 215b. The desired separation signal of the reflected second desired signal is input to the circulator 211b via the AWG 215b. The circulator 211b outputs the optical signal (the desired separation signal of the first desired signal and the desired separation signal of the second desired signal) input from the AWG 215b to the first side. The remaining output ports of the AWG 215b are connected to the detection unit 22.

With such a configuration, with respect to the first desired signal and the second desired signal, an optical signal having a residual wavelength that cannot be removed by the AWG 215a can be further removed by the AWG 215b. Only the output of one of the AWG 215a and the AWG 215b may be input to the detection unit 22, or both may be input thereto. In a case where only the output of one of the AWG 215a and the AWG 215b is input to the detection unit 22, the output of the other may be configured as a non-reflection termination or may be connected to an isolator. The isolator 23 may be provided between the separation unit 21 and the detection unit 22. Note that the multiplexing unit 216 corresponding to the multiplexing unit 216a illustrated in FIG. 51 may be provided between one or both of the AWG 215a and the AWG 215b and the detector.

### [Multiple-Port Modification]

Each of the separation units 21 described above includes one input port. However, the separation unit 21 may include a plurality of input ports. Hereinafter, a configuration example of the first embodiment including the separation unit 21 configured as described above will be described.

### [Modification of Multiple Ports of First Embodiment]

FIG. 56 is a diagram illustrating a modification of the first embodiment of the separation system 11a. The separation unit 21 may be configured using a separation unit having a different desired wavelength to be output as the desired separation signal for each input port, for example, a cyclic diffraction grating or a cyclic AWG. One of a plurality of optical signals input to the optical cross-connect system 10a is input to each input port of the separation unit 21. Here, each optical signal is input by selecting an input port at which a desired wavelength is separated into the desired separation signal and a residual wavelength is separated into the residual separation signal. The separation unit 21 separates the desired separation signal and the residual separation signal from the optical signals input from the plurality of ports by executing the separation processing for wavelength-separating the desired signal and the residual signal from the plurality of input optical signals. The separated desired separation signal is input to the blocking device 30.

The detection unit 22 detects the light intensity of the separated residual separation signal. Upon detecting any of the residual separation signals with a predetermined light intensity or higher, the detection unit 22 outputs the control signal indicating that the input optical signal (desired separation signal) is blocked to the blocking device 30. In this case, the detection unit 22 may record information (log) indicating that the residual separation signal has been detected with a predetermined light intensity or more. The detection unit 22 may be configured to be non-reflective.

When not block, the blocking device 30 makes each input optical signal (desired separation signal) to pass through. Each desired separation signal having passed through the blocking device 30 is output to the first side. Upon receiving the control signal indicating block from the detection unit 22 of the separation device 20, the blocking device 30 blocks all the input optical signals. In this case, none of the desired separation signals of the plurality of optical signals input to the separation system 11a is output to the first side.

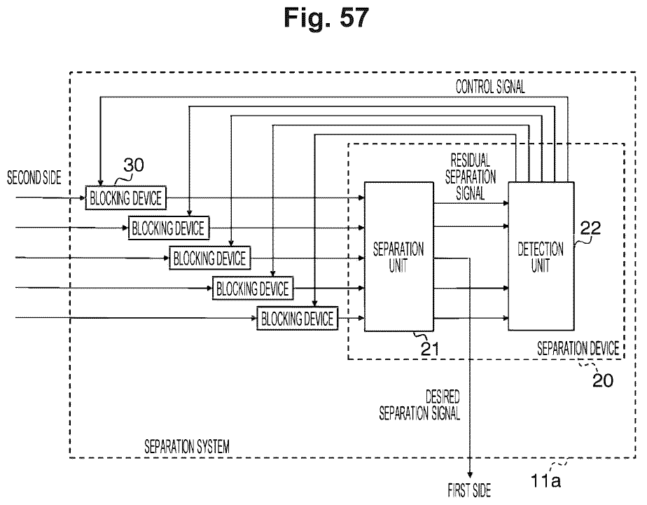

Here, in the present modification, in a case where it cannot be determined which input port whose input has been separated as the residual separation signal, the output may be stopped on a part of transmission sides, or an individual blocking device may be provided as illustrated in FIG. 57 to be described later, and a part may be blocked by the individual blocking device, only a part of the transmission sides may be allowed to output, or only a part may be made to pass through by the individual blocking device, so that the port to which the signal separated as the residual separation signal has been input is identified, and only the input is not output to the first side.

FIG. 57 is a diagram illustrating a modification of the first embodiment of the separation system 11a. In the example of FIG. 57, an optical signal input to the separation system 11a is first input to one of the plurality of blocking devices 30. One of a plurality of optical signals input to the separation system 11a is input to each blocking device 30. The separation unit 21 including a plurality of input ports is connected to a subsequent stage (first side) of each blocking device 30.

The separation unit 21 may be configured using, for example, an AWG. Among the plurality of optical signals input to the separation system 11a, an optical signal that has passed through the blocking device 30 connected to the preceding stage (second side) of the port is input to each input port of the separation unit 21. The separation unit 21 separates the desired separation signal and the residual separation signal by executing the separation processing for wavelength-separating the desired signal and the residual signal from the plurality of input optical signals. The separated desired separation signal is output to the first side.

The detection unit 22 detects the light intensity of the separated residual separation signal. Upon detecting the residual separation signal with a predetermined light intensity or more, the detection unit 22 outputs the control signal indicating that the input optical signal (desired separation signal) is blocked to the blocking device 30. In this case, the detection unit 22 may record information (log) indicating that the residual separation signal has been detected with a predetermined light intensity or more. The detection unit 22 may be configured to be non-reflective.

When not block, the blocking device 30 allows each input optical signal to pass. Each optical signal having passed through the blocking device 30 is output to the separation unit 21. Upon receiving the control signal indicating block from the detection unit 22 of the separation device 20, the blocking device 30 blocks the input optical signal. In this case, among the desired separation signals of the plurality of optical signals input to the separation system 11a, the desired separation signal of the optical signal blocked by the blocking device 30 is not output to the first side. However, the desired separation signal of a non-blocked optical signal is output to the first side. Note that, in this configuration, all blocking devices 30 may be configured to block the optical signal when the detection unit 22 detects any one of the residual separation signals with a predetermined light intensity or more.

As described above, in the present configuration, it is possible to control passing or block of a plurality of optical signals input to the separation system 11a in units of the individual blocking devices 30. For example, the detection unit 22 may detect the residual separation signal for the optical signal passing through each blocking device 30 by making the blocking devices 30 to pass through one by one in a predetermined order (block the entirety and releasing the block one by one). With such a configuration, the detection unit 22 can identify which blocking device 30 the residual separation signal from the optical signal having passed has been detected with a predetermined intensity or more. In this case, only in a case where the residual separation signal is detected, the detection unit 22 may determine that the blocking device 30, which has been passed at that time, is to be blocked, or may notify the user device that is the transmission source of the optical signal. In addition, the detection unit 22 may pass through all the blocking devices 30 to collectively detect the residual separation signals of all the optical signals.

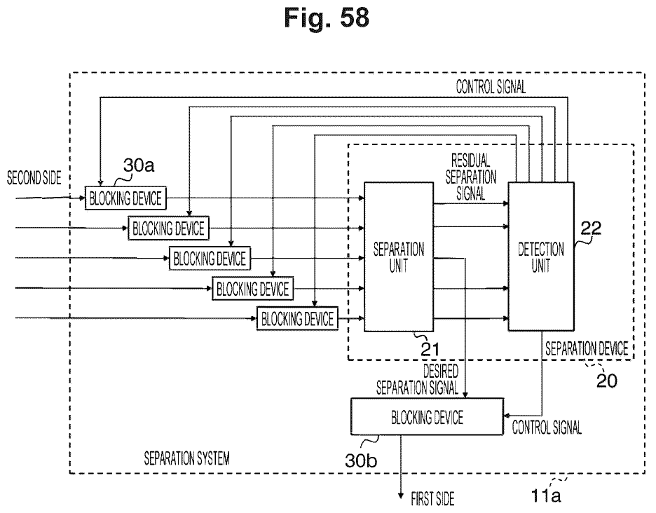

FIG. 58 is a diagram illustrating a modification of the first embodiment of the separation system 11a. In the present specific example, a plurality of blocking devices 30a is provided in the preceding stage (second side) of the separation device 20, and a plurality of blocking devices 30b is provided in the subsequent stage (first side) of the separation device 20.

An optical signal input to the separation system 11a is first input to one of the plurality of blocking devices 30a. One of a plurality of optical signals input to the separation system 11a is input to each blocking device 30a. The separation unit 21 including a plurality of input ports is connected to a subsequent stage (first side) of each blocking device 30a.

The separation unit 21 may be configured using, for example, an AWG. To each input port of the separation unit 21, among the plurality of optical signals input to the separation system 11a, an optical signal that has passed through the blocking device 30a connected to the preceding stage (second side) of the own port is input. The separation unit 21 separates the desired separation signal and the residual separation signal by executing the separation processing for wavelength-separating the desired signal and the residual signal from the plurality of input optical signals. The separated desired separation signal is output to the blocking device 30b provided in the subsequent stage (first side) of the separation device 20.

The detection unit 22 detects the light intensity of the separated residual separation signal. Upon detecting the residual separation signal with a predetermined light intensity or more, the detection unit 22 outputs the control signal indicating that the input optical signal (desired separation signal) is blocked to the blocking device 30a or the blocking device 30b. In this case, the detection unit 22 may record information (log) indicating that the residual separation signal has been detected with a predetermined light intensity or more. The detection unit 22 may be configured to be non-reflective.

When not block, the blocking devices 30a and the blocking device 30b pass the input optical signals. Each optical signal having passed through the blocking devices 30a is output to the separation unit 21. Upon receiving the control signal indicating block from the detection unit 22 of the separation device 20, the blocking device 30a blocks the input optical signal. In this case, among the desired separation signals of the plurality of optical signals input to the separation system 11a, the desired separation signal of the optical signal blocked by the blocking device 30a is not output to the first side. However, the desired separation signal of a non-blocked optical signal is output to the first side. Upon receiving the control signal indicating block from the detection unit 22 of the separation device 20, the blocking device 30b blocks the input optical signal. In this case, all the desired separation signals of the plurality of optical signals input to the separation system 11a are not output to the first side.

As described above, in the present configuration, it is possible to control passing or block of a plurality of optical signals input to the separation system 11a in units of the individual blocking devices 30a. For example, the detection unit 22 may detect the residual separation signal for the optical signal passing through each blocking device 30a by making the blocking devices 30a to pass through one by one in a predetermined order (by block the entirety and releasing the block one by one). In this case, only when the residual separation signal is detected, the detection unit 22 may determine that the blocking device 30a, which has been passed at that time, is to be blocked, or may notify the user device that is the transmission source of the optical signal.

In addition, the detection unit 22 may pass through all the blocking devices 30a to collectively detect the residual separation signals of all the optical signals. In this case, the detection unit 22 may block the optical signal (desired separation signal) collectively by block the blocking device 30b when the residual separation signal is detected. Further, even while the detection unit 22 causes the blocking device 30b to block, the detection unit 22 may make all the blocking devices 30a to pass through. With this configuration, it is possible to continuously detect the state (for example, the intensity of the residual separation signal) of each optical signal (separation input signal) while preventing the desired separation signal of the violating optical signal from flowing to the first side.

Next, a specific example of the configuration of the separation unit 21 including a plurality of input ports will be described. For example, a specific example described below may be applied to each separation unit 21 illustrated in FIGS. 56 to 58. In that case, in the following description, the blocking device 30 is not illustrated in order to describe a specific example of the configuration of the separation unit 21, but signals (the separation input signal, the desired separation signal, and the like) related to the separation unit 21 may be blocked by the blocking device 30 illustrated in FIGS. 56 to 58.

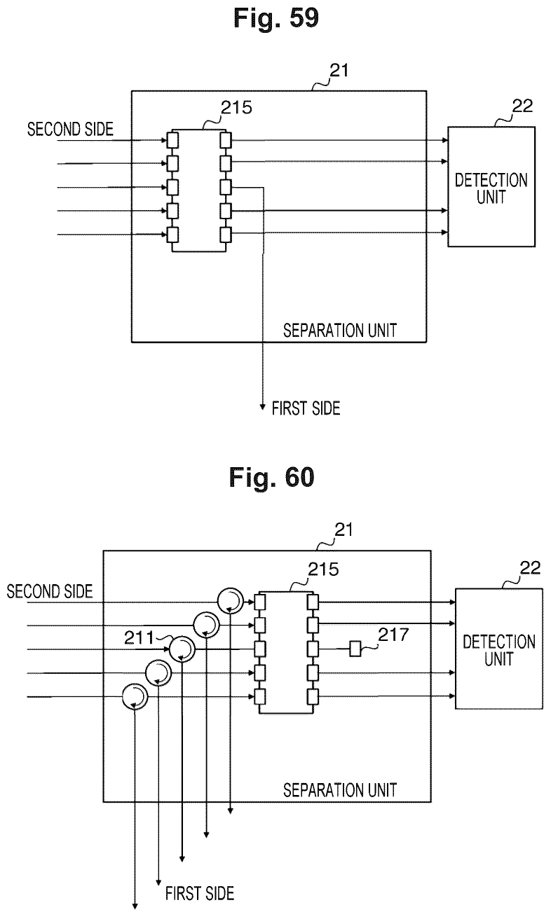

FIG. 59 is a diagram illustrating a first configuration example in which the separation unit 21 in the modification is configured using an AWG. The separation unit 21 includes the AWG 215 having a plurality of input ports. The AWG 215 outputs a plurality of optical signals input from the input port on the second side from output ports corresponding to respective wavelengths. Among the plurality of output ports of the AWG 215, an output port from which an optical signal (desired signal) having the desired separation signal wavelength is output is connected to the first side. The remaining output ports are connected to the detection unit 22.

For example, using an AWG in which λ1, λ2, λ3, λ4, and λ5 of an input port 1 are output ports 1, 2, 3, 4, and 5, λ1, λ2, λ3, λ4, and λ5 of an input port 2 are output ports 2, 3, 4, 5, and 1, λ1, λ2, λ3, λ4, and λ5 of an input port 3 are output ports 3, 4, 5, 1, and 2, λ1, λ2, λ3, λ4, and λ5 of an input port 4 are output ports 4, 5, 1, 2, and 3, and λ1, λ2, λ3, λ4, and λ5 of an input port 5 are output ports 5, 1, 2, 3, and 4, the desired separation signal is output to the port connected to the blocking device 30, and to the input port at which the residual separation signal is output to the detection unit 22, each user device (UT) is connected according to the set wavelength. That is, UTs having desired wavelengths λ1, λ2, λ3, λ4, and λ5 are connected to the input ports 3, 4, 5, 1, and 2, respectively. In this way, the light having the wavelength corresponding to the residual wavelength of each UT is output to the detector. The isolator 23 may be provided between the separation unit 21 and the detection unit 22.

FIG. 60 is a diagram illustrating a second configuration example in which the separation unit 21 in the modification is configured using an AWG. The separation unit 21 includes the circulators 211, the AWG 215 having a plurality of input ports, and the reflection unit 217. The circulator 211 inputs an optical signal input from the second side to one input port of the AWG 215. The configuration of the circulators 211 is as described above. Among the plurality of output ports of the AWG 215, the output port from which the desired separation signal is output is connected to the reflection units 217. The remaining output ports are connected to the detection unit 22. The reflection unit 217 reflects an optical signal (at least the desired separation signal) input from the AWG 215. The reflected desired separation signal is input to each of the circulators 211 via the AWG 215. The reflection unit 217 may be configured using, for example, a total reflector or may be configured using an FBG. The reflection unit 217 may employ any configuration as long as it can reflect the desired separation signal. The circulators 211 output the optical signals input from the AWG 215 to the first side. Since this configuration is multiple-input multiple-output, it is also possible to employ a cascade configuration and connect an output on the first side of the preceding stage to an input on the second side of the subsequent stage. In addition, since this configuration is multiple-input multiple-output, this configuration is suitable for a case where the desired separation signal is demultiplexed in FIGS. 56 and 57. The first side may be multiplexed by a multiplexer/demultiplexer or a coupler/splitter to form a multiple-input single output, and the multiple-input single-output may be directly applied to FIGS. 56 and 57.

When the separation unit 21 is configured using the AWG as described above, there are the following viewpoints. As the AWG, from the viewpoint of detecting that an optical signal (residual signal) other than the desired wavelength is mixed, the width of the residual wavelength demultiplexed as the residual signal needs to be sufficiently wide. When generation of light having a wavelength other than the input wavelength is not considered as in four-wave mixing or the Raman effect by a nonlinear optical effect, it is desirable that the AWG to be used covers all of the desired wavelength and the residual wavelength. When the generation is considered, it is desirable to cover all the affected wavelengths including the generated light.

When a cyclic AWG is applied, a cyclic period may be configured to be sufficiently wider than the residual wavelength of the detection target so that the residual wavelength is not output from the output port of the desired wavelength. A filter that blocks the residual signal may be provided so that the residual wavelength is not output from the port of the desired wavelength and does not reach the detection unit 22. For example, a wide-band AWG and a narrow-band AWG may be cascade-connected. For example, the transmitted wavelength may be the only available wavelength. For example, the BPF and the AWG that transmit only wavelengths corresponding to a part of circles may be cascade-connected.

However, if a wavelength circulating around the same port is set, a plurality of wavelengths can be handled as desired wavelengths as described later. However, when the wavelength demultiplexed at the same port includes the desired wavelength and the residual wavelength, the BPF and the AWG may be cascade-connected so as to transmit only the desired wavelength.

When the AWG is glass, the refractive index can be changed by changing the temperature to change the wavelength to be handled as a desired wavelength. When the AWG is a semiconductor, the refractive index can be changed by changing the temperature or applying a voltage to change the wavelength to be handled as a desired wavelength. In addition, it is possible to change the wavelength to be handled as the desired wavelength by reconnecting the port on the input side or the output side and the port.

An AWG having a large (for example, 3 dB) crosstalk XT between adjacent ports may be used to detect leakage of a wavelength of a cutoff band between ports of the AWG. In a case where a plurality of AWGs is cascade-connected, an AWG having a large crosstalk XT may be employed as the AWG in the preceding stage for monitoring, and an AWG having a small crosstalk XT may be employed as the AWG in the subsequent stage. With this configuration, it is desirable to mainly detect the output of the adjacent port in the AWG in the preceding stage.

Other diffraction gratings may be applied instead of the AWG described above. For example, a reflection type diffraction grating on a waveguide may be applied, a transmission type diffraction grating of a spatial system may be applied, or a reflection type diffraction grating of a spatial system may be applied. For example, a spatial modulation element whose transmission angle changes according to a wavelength, such as a spatial transmission-type diffraction grating or a liquid crystal on silicon (LCOS), may be used instead of the AWG. In this case, the output port is replaced with a range of angles of the output light. In addition, a spatial reflection-type diffraction grating that reflects the desired signal and the residual signal at different angles may be used instead of the AWG. Further, a spatial modulation element whose reflection angle changes according to the wavelength may be used instead of the AWG. The reflected light at the angle of the desired signal may be collected, and the output of the reflected light at the angle of the light of the residual signal may be collected and output to the detection unit 22. By such reflection and transmission, the desired separation signal and the residual separation signal are separated from the separation input signal. Hereinafter, a typical spatially coupled reflection type diffraction grating will be described.

The relationship between the wavelength λ diffracted by the diffraction grating having a grating interval d and a diffraction angle θ is expressed by the following Expression (1).

$$m λ = d ( sin θ - sin φ ) \qquad Expression ( 1 )$$

Here, m is a diffraction order, and φ is an incident angle to the diffraction grating. When the incident optical axis is fixed, the incident angle φ is constant in a case where the diffraction grating is fixed. In order to obtain the relationship between the diffraction angle θ and the wavelength λ, the following Expression (2) is obtained by differentiating Expression (1).

$$m Δλ = d cos θ \cdot Δ θ \qquad Expression ( 2 )$$

Let x be the width of the optical receiver and L be the distance to a light receiver (or the focal length of a focusing mirror). Assuming that the light receiver can disperse light in the range of Δθ in Expression (2), the width x is expressed by the following Expression (3).

$$x = Δθ L \qquad Expression ( 3 )$$

In general, m=1. Thus, from Expressions (2) and (3), the wavelength range Δλ that can be dispersed is expressed as follows.

$$Δλ = x d cos θ / L \qquad Expression ( 4 )$$

Assuming that the light receiver width is x=10 mm, d=1 μm, cose=0.5, and L=300 mm, the wavelength range Δλ is 17 nm. Assuming that the number of elements of the light receiver is 256, the wavelength resolution is expressed as follows. 17 nm÷256≈70 pm

As the diffraction grating, either a surface relief diffraction grating having irregularities on an element surface or a planar diffraction grating having a flat element surface and a refractive index or transmittance in the element periodically changing may be applied. In addition, either the transmission type or the reflection type may be applied. The transmissive type is produced by scratching or etching a structure repeatedly parallel to a transparent substrate. In the transmissive type, a region in which light is scattered is formed. An equation of a general diffraction grating in a case of an incident angle of 0 degrees is α[sin θm−sin θi]=mλ (interval α between diffraction gratings, diffraction order m, emission angle θm from surface perpendicular, and incident angle θi).

Reflective molds are made by creating grooves parallel to the surface of traditionally metal-coated optical elements. The reflection-type diffraction grating can also be produced by imprinting a master on epoxy or plastic. The expression of the reflection type diffraction grating is α[sin θm+sin θi]=mλ. In both the reflection type and the transmission type, there is no diffraction pattern in a case of the zeroth-order light, and thus, there is no wavelength dependency. Therefore, both the reflective type and the transmissive type are used in other orders.

An interval between diffraction gratings is d, a depth is h, a refractive index of a diffraction grating portion is n, an incident angle of light on the diffraction grating is θi, a wavelength of light is λ, a thickness of a plane grating is t, p-polarization is obtained when a direction of an electric vector of the incident light is in an incident plane, and s-polarization is obtained when the electric vector is perpendicular to the incident plane. When light having the wavelength λ enters the diffraction grating, the diffracted light is intensified when the optical path difference of light diffracted by adjacent grooves becomes an integral multiple of λ. At this time, the following equation is established between the incident angle and the diffraction angle. ni·(sin θm−sin θi)=mλ/d(m=0, ±1, ±2, ±3 . . . ) Here, θm represents a diffraction angle of the m-th order diffracted light. The angle of the diffracted light is positive when the diffracted light is on the opposite side to the incident light with respect to the normal line of the grating, and is negative when the diffracted light is on the same side as the incident light. In addition, the order m of the diffracted light when the diffraction angle is large with respect to the zeroth-order diffracted light is positive, and the order of the diffracted light when the diffraction angle is small is negative. Normally, since the incident light is in the air, ni=1.

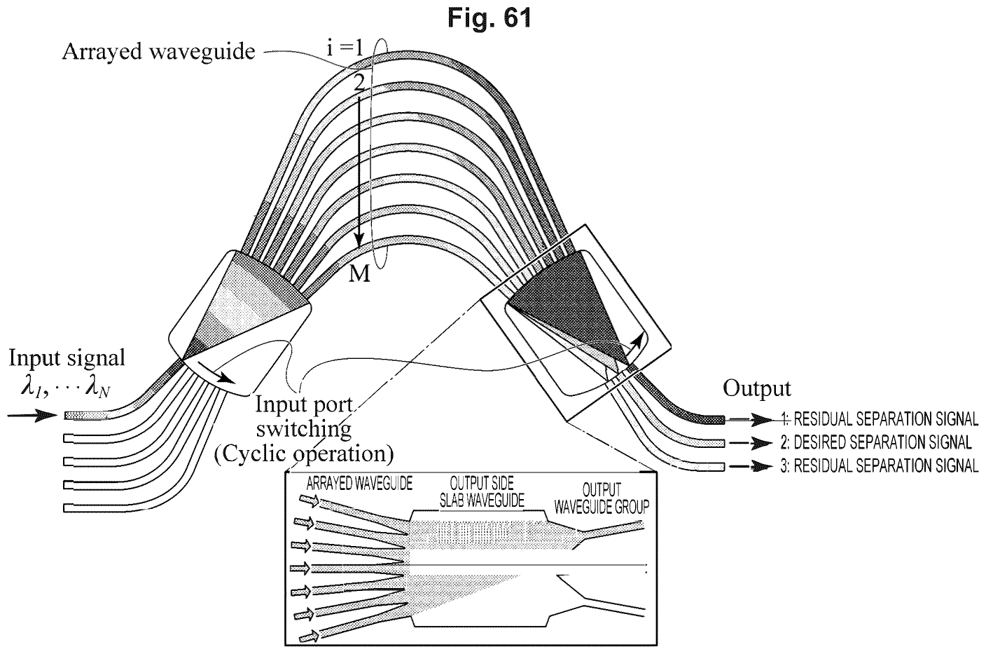

FIG. 61 is a diagram illustrating a modification of the AWG. In the modification of the AWG illustrated in FIG. 61, a plurality of output waveguides is set as a single output. In this embodiment, the AWG may be configured as illustrated in FIG. 61. In the AWG illustrated in FIG. 61, the width of the reception side of the output waveguide that separates the residual wavelength is widened by a plurality of wavelengths or more, and outputs of a plurality of wavelengths that are not desired wavelengths can be collectively output.

The AWG outputs a desired wavelength range and other wavelength ranges from different ports. By applying such an AWG to the separation unit 21, the number of detection units 22, the number of non-reflection termination points, the number of AWGs to be multiplexed, the number of reflection points, and the like can be reduced. In such an AWG, for example, a plurality of outputs may be bundled for each wavelength. In addition, the range of wavelengths to be aggregated is equal to or more than the wavelength range in which light of an improper wavelength component needs to be detected. For example, the output port 2 of the AWG, which is sandwiched between both sides of the desired wavelength by the residual wavelength, may be used for outputting the desired wavelength, and the output port 1 and the output port 3 positioned so as to sandwich the output port 2 may be used for outputting the residual separation wavelength. The outputs of the output port 1 and the output port 3 may be multiplexed. Note that, although an example in which one port from which the residual wavelength is output is provided on the short wavelength side and one port on the long wavelength side has been described, there is no need to limit each of the ports to one. If a plurality of outputs can be bundled (aggregated) and output for each wavelength, the number of ports can be reduced, and thus an effect can be obtained.

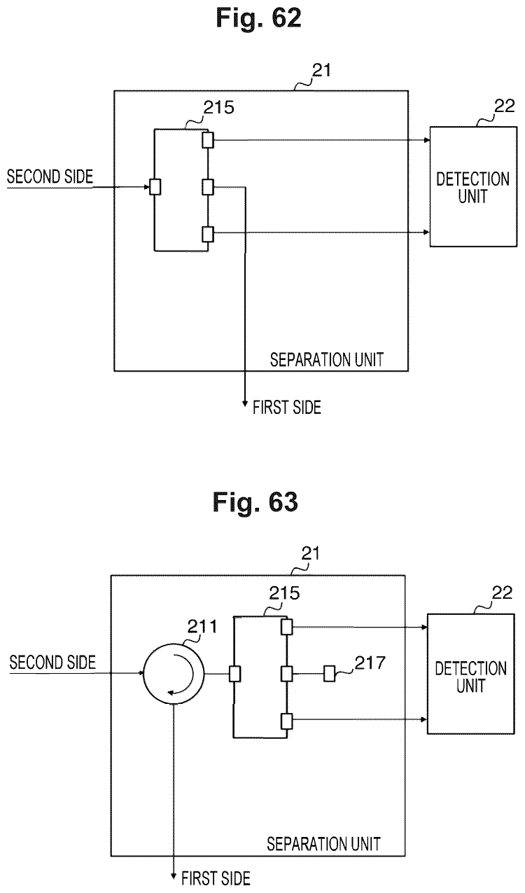

FIGS. 62 and 63 are diagrams illustrating a configuration example of the separation unit 21 using the AWG configured as illustrated in FIG. 61. In FIGS. 62 and 63, the AWG configured as in FIG. 61 is applied to AWGs each indicated as the AWG 215. The configuration illustrated in FIG. 62 is substantially similar to the configuration in which the number of output ports of the AWG 215 to the detection unit 22 is two in the separation unit 21 described as FIG. 44. The configuration illustrated in FIG. 63 is substantially similar to the configuration in which the number of output ports of the AWG 215 to the detection unit 22 is two in the separation unit 21 described as FIG. 46.

This point will be described in detail. In the configuration of FIG. 44, an AWG that demultiplexes and outputs different wavelengths at FSR intervals is assumed. Although five waves are illustrated in FIG. 44, in addition to the wavelength to be separated as the desired wavelength, ports are provided as many as the number of wavelengths to be detected as the residual wavelengths. Assuming that the wavelength band to be detected is 32 waves, one port of the desired wavelength and 31 ports of the residual wavelengths are necessary. Therefore, there is a problem that the number of connection lines with the detection unit 22 becomes large. In order to solve this problem, in the configuration of FIG. 45, the multiplexing unit 216 multiplexes the ports corresponding to the residual wavelengths and then passes the multiplexed ports to the detection unit 22. In such a configuration, detection sensitivity in the detection unit 22 may deteriorate due to a loss in the multiplexing unit 216. For example, when the number of ports is 2\hat{ }N (2 to the N-th power), a branch loss is generated by 3 N dB. As described above, when the number of ports is 32, N=5, and thus the loss is 15 dB (≈ 1/32). As the multiplexing unit, the multiplexing unit 216 whose characteristics substantially match those of the AWG 215 is used. However, also in FIG. 45, there is a problem that the multiplexing unit 216 is needed.

Accordingly, in the modification of the AWG illustrated in FIG. 61, the ports that output the residual wavelengths on the long wavelength side of the desired wavelength and the short wavelength side of the desired wavelength collectively output a plurality of FSRs of wavelengths. In the AWG 215 of FIG. 44, at least one of the upper two ports or the lower two ports of the AWG 215 is combined into one port. Either the upper side or the lower side has a longer wavelength than a desired wavelength, and the opposite side has a shorter wavelength. If each of them can be integrated into one port, the multiplexing unit 216 needed in the configuration of FIG. 45 is unnecessary, and the number of paths to the detection unit 22 is also two, which is half of four paths in FIG. 44.

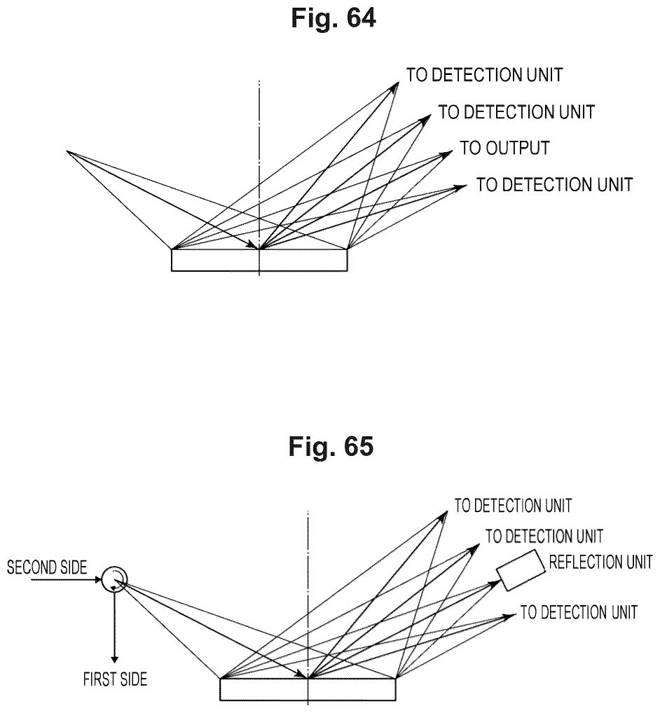

FIGS. 64 and 67 are diagrams illustrating specific examples of the separation unit 21 configured using the reflection type diffraction grating. In the specific example of the diffraction grating illustrated in FIG. 64, the desired separation signal is transmitted through the diffraction grating and output from the right end to the first side in the drawing. In addition, the residual separation signal passes through the diffraction grating and is input to the detection unit 22 from the right end of the drawing. Such a diffraction grating may be applied in place of, for example, the AWG 215 illustrated in FIGS. 44, 45, 47, 50, 51, and 53, or may be applied in place of the AWG 215b in FIG. 48 or the AWG 215 and the AWG 215b in FIG. 54. In the specific example of the diffraction grating illustrated in FIG. 65, the desired separation signal is reflected by the reflection unit 217 disposed at the right end of the diffraction grating illustrated in the drawing, and is output from the left end of the diffraction grating to the first side via the circulator 211. In addition, the residual separation signal passes through the diffraction grating and is input to the detection unit 22 from the right end of the drawing. Such a diffraction grating may be applied in place of, for example, the AWG 215 illustrated in FIGS. 46, 49, 52, and 55, or may be applied in place of the AWG 215a in FIG. 48 or the AWG 215a in FIG. 54. Note that, in these configurations, a plurality of outputs may be bundled and aggregated for each wavelength. At this time, the range of wavelengths to be aggregated is equal to or more than the wavelength range in which improper light needs to be detected. In FIGS. 63 and 64, the single-input multiple-output is illustrated, but if multiple-input multiple-output is used, it can be similarly applied to FIGS. 59 and 60 using the multiple-input multiple-output AWG 215.

### Specific Example 4: Waveguide-Type Ring Resonator

The separation unit 21 may be configured using a waveguide-type ring resonator. For example, a micro ring resonator (MRR) having a resonator length of several 10 μm and a resonant wavelength interval (free spectral range (FSR)) of several 10 nm may be used. As the shape of the ring resonator portion, a racetrack shape in which the coupling portion is a parallel straight waveguide instead of a perfect circular shape may be used. With such a configuration, the coupling coefficient at the coupling portion can be easily designed.

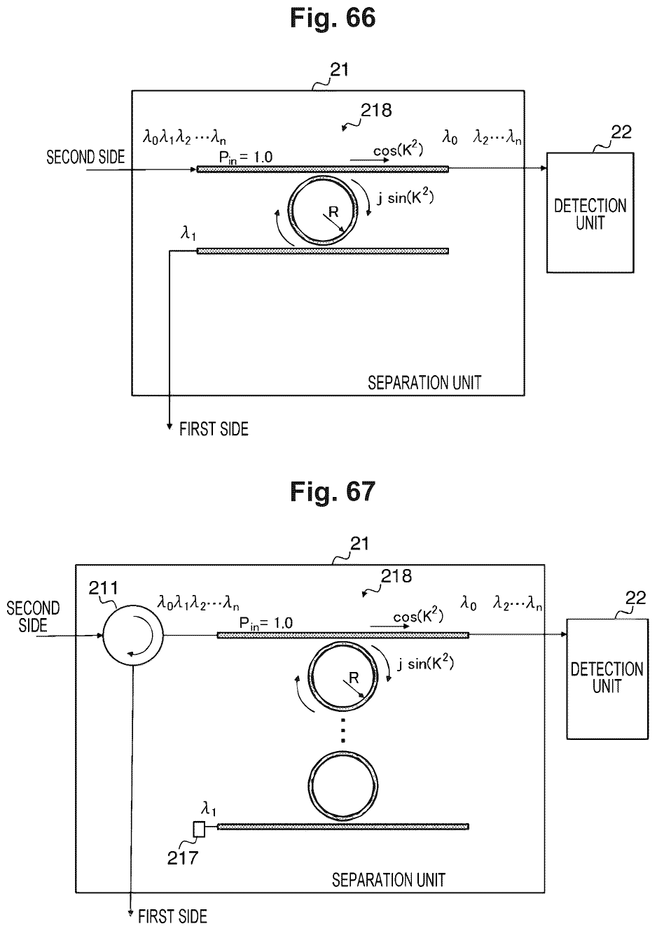

Series coupling may be applied to the waveguide-type ring resonator. In the series coupling, a plurality of rings is provided. In the following description, an example of a waveguide-type ring resonator using one ring will be described in a specific example of FIG. 66, and an example of a waveguide-type ring resonator using a plurality of rings will be described in a specific example of FIG. 67. Note that a plurality of rings may be used in the example illustrated in FIG. 66, or one ring may be used in the example illustrated in FIG. 67. With such a configuration, it is possible to obtain spectral characteristics in which the transmission band is flat, the transition (roll-off) from the transmission band to the cutoff band is steep, and the block amount is sufficient. However, a coupling coefficient between a bus line waveguide and a micro ring and a coupling coefficient between one micro ring and another micro ring satisfy a certain condition called a Butterworth condition. As a specific example of series coupling for increasing a Q factor that is a degree of resonance while widening a pass band (width of a selected wavelength), for example, there is a double ring.

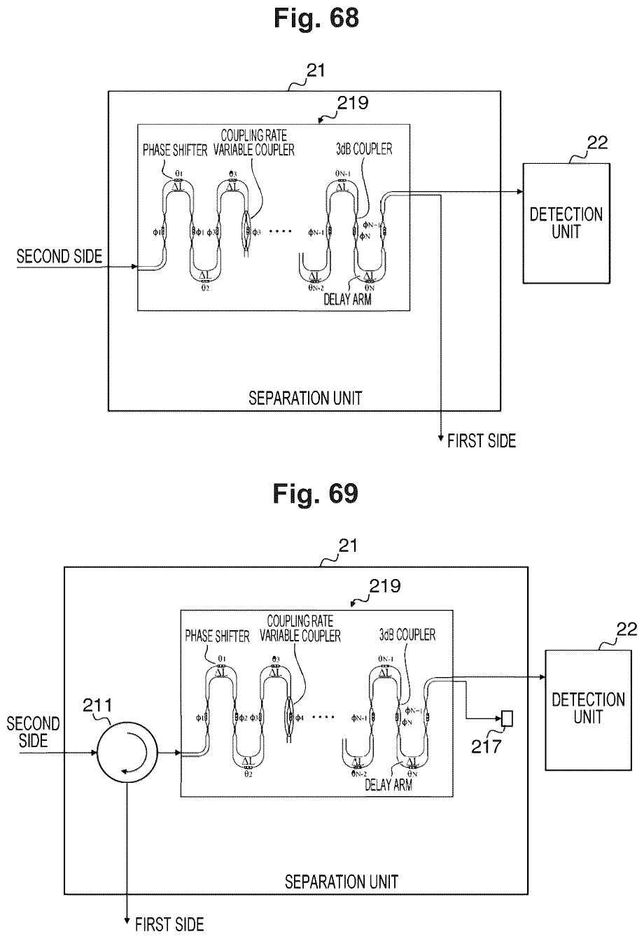

FIG. 66 is a diagram illustrating a first configuration example in which the separation unit 21 is configured using a waveguide-type ring resonator. The separation unit 21 includes a waveguide-type ring resonator 218. The waveguide-type ring resonator 218 receives an optical signal received from the second side from an upper left port, and outputs the desired separation signal and the residual separation signal from different ports. Specifically, the waveguide-type ring resonator 218 outputs the desired separation signal from a lower left port (drop port) to the first side in FIG. 68 and outputs the residual separation signal from an upper right port (through port) to the detection unit 22. Note that it is desirable that a non-reflection termination or an isolator is connected to a lower right port.

FIG. 67 is a diagram illustrating a second configuration example in which the separation unit 21 is configured using the waveguide-type ring resonator. In the example illustrated in FIG. 67, the separation unit 21 includes the circulator 211, the reflection unit 217, and the waveguide-type ring resonator 218. The circulator 211 inputs an optical signal input from the second side to the waveguide-type ring resonator 218. When an optical signal is input from an upper left input port, the waveguide-type ring resonator 218 outputs the desired separation signal and the residual separation signal separated from the input optical signal from respective different ports. Specifically, the waveguide-type ring resonator 218 outputs the desired separation signal from a lower left port (drop port) to the reflection unit 217 in FIG. 67 and outputs the residual separation signal from an upper right port (through port) to the detection unit 22.

When an optical signal (desired separation signal) is input from the waveguide-type ring resonator 218, the reflection unit 217 reflects the input optical signal and outputs the optical signal to the waveguide-type ring resonator 218. The waveguide-type ring resonator 218 inputs a reflected optical signal (desired separation signal) from the lower left drop port and outputs the optical signal to the circulator 211 from an upper left port. The circulator 211 outputs the optical signal (desired separation signal) input from the waveguide-type ring resonator 218 to the first side.

### Specific Example 5: Lattice-Type Optical Filter

The separation unit 21 may be configured using a lattice-type optical filter. The lattice-type optical filter includes, for example, a delay line, a symmetric Mach-Zehnder interferometer type coupling rate variable coupler, and a phase adjustment unit. By changing the phase shift value of the optical filter, an arbitrary filter characteristic whose upper limit is performance determined by the number of asymmetric Mach-Zehnder interferometers can be obtained. A property that a characteristic periodically appears for each free spectral range (FSR) determined by ΔL is used. In the lattice type, a path length difference of each asymmetric MZI constituting the lattice is ΔL. In the transversal type, a length of a delay applying unit between the branches is ΔL. In the AWG, a difference in length between one waveguide constituting the array waveguide and an adjacent waveguide (for example, i and i−1, i and i+1 of the arrayed waveguide of FIG. 61) is ΔL.

When the period is short, similarly to the periodic AWG, it may be implemented by combining a plurality of filters. In order to eliminate the polarization dependence, a circulator and a Faraday rotating mirror having a rotation angle of 90 degrees may be installed at the input and output ends, respectively, to implement a reflection type configuration.

FIG. 68 is a diagram illustrating a first configuration example in which the separation unit 21 is configured using the lattice-type optical filter. The separation unit 21 includes a lattice-type optical filter 219. The lattice-type optical filter 219 receives the optical signal received from the second side, and outputs the desired separation signal and the residual separation signal from different ports. Specifically, the lattice-type optical filter 219 outputs the desired separation signal from the first port to the first side, and outputs the residual separation signal from the second port to the detection unit 22. The delay ΔL of the delay arm of the lattice filter, the coupling factor of the coupling factor variable coupler, and the phase θ of the phase shifter are adjusted such that the first port outputs a proper wavelength component and the second port outputs an improper wavelength component. In addition, in the case of the lattice, the coupling rate between the delay ΔL of the delay applying unit and the tap (coupling rate variable coupler) and the phase of the phase shifter may be adjusted.

FIG. 69 is a diagram illustrating a second configuration example in which the separation unit 21 is configured using the lattice-type optical filter. In the example illustrated in FIG. 69, the separation unit 21 includes the circulator 211, the reflection unit 217, and the lattice-type optical filter 219. The circulator 211 inputs an optical signal input from the second side to the lattice-type optical filter 219. When an optical signal is input from the input port, the lattice-type optical filter 219 outputs the desired separation signal and the residual separation signal separated from the input optical signal from respective different ports. Specifically, the lattice-type optical filter 219 outputs the desired separation signal from the first port to the reflection unit 217, and outputs the residual separation signal from the second port to the detection unit 22.

When an optical signal (desired separation signal) is input from the lattice-type optical filter 219, the reflection unit 217 reflects (at least a proper wavelength component of) the input optical signal and outputs the optical signal to the lattice-type optical filter 219. The lattice-type optical filter 219 inputs the reflected optical signal (desired separation signal) to the circulator 211. The circulator 211 outputs the optical signal (desired separation signal) input from the lattice-type optical filter 219 to the first side.

Note that, in each of the configurations illustrated in FIGS. 66, 67, 68, and 69, the open end in the drawing is desirably non-reflection-terminated in order to suppress the influence of reflection.

### [Modification]

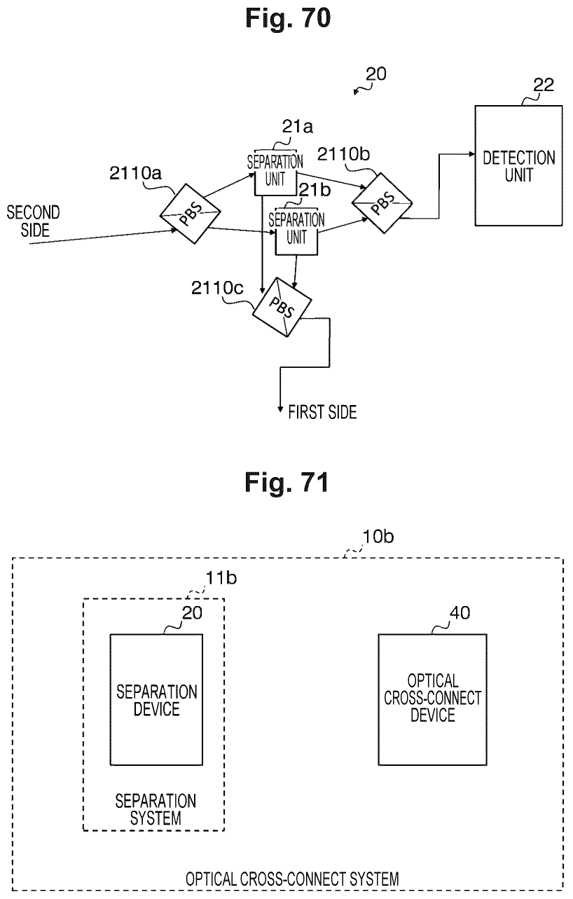

FIG. 70 is a diagram illustrating a specific example of a configuration in a case where the separation unit 21 is configured using separation units having high polarization dependency. In this case, the separation device 20 includes a plurality of separation units 21 and a plurality of polarization beam splitters (PBS) 2110. The optical signal input to the separation device 20 is input to a PBS 2110a. The PBS 2110a separates the optical signal for each predetermined polarization. In the example of FIG. 70, the optical signal is separated into two.

The PBS 2110a inputs one polarized wave to the separation unit 21a and inputs the other polarized wave to the separation unit 21b. The separation unit 21a and the separation unit 21b separate the desired separation signal and the residual separation signal, respectively. The separation unit 21a and the separation unit 21b output the residual separation signal to a PBS 2110b and output the desired separation signal to a PBS 2110c. The PBS 2110b performs polarization synthesis on the residual separation signal input from each separation unit 21, and outputs the resultant signal to the detection unit 22. The PBS 2110c performs polarization synthesis on the desired separation signal input from each separation unit 21, and outputs the resultant signal to the first side. Note that the PBS 2110b may separately output the residual separation signal input from each separation unit 21 to the detection unit 22 without performing polarization synthesis or merging. Note that, instead of the configuration as illustrated in FIG. 70, a ½ wave plate that switches polarization between the first half and the second half and compensates for birefringence of the optical waveguide may be provided in the middle of the path as in AWG.

### Application Example to PG

Hereinafter, a configuration example when the first embodiment (optical cross-connect system 10a) of the optical cross-connect system 10 described above is applied to the PG will be described.

In the optical cross-connect system 10a, the desired wavelength may be a wavelength set for the user device from the PG. In such a configuration, the desired wavelength may be changed before and after the setting. In that case, the wavelengths separated by the separation processing (the wavelength transmitted as proper (desired wavelength) and the wavelength filtered and detected as improper (residual wavelength)) are changed. For example, the optical cross-connect system 10a may be notified of the desired wavelength by communication using a predetermined carrier from a device that controls the wavelength of each user device, may be notified of the desired wavelength by using AMCC, or may be notified of the desired wavelength via a specific communication route. This notification may be performed by electrically or optically multiplexing a signal exchanged between the user equipment and a functional unit that controls the user equipment or an opposing device by time division multiplexing using a control bit or the like of a transmission frame or frequency division multiplexing such as AMCC, notification may be performed by polarization modulation, notification may be performed by orthogonal polarization combining, wavelength division multiplexing, or the like using light different from the signal, or notification may be performed by a route different from the signal such as wireless or wired.

Here, a wavelength at which the separation unit 21 permits communication of the user equipment (wavelength handled as proper: desired wavelength) will be described. In a case where the connection between the user equipment and a control unit of the PG is via a monitoring unit in the subsequent stage of the output of the optical cross-connect device 40, in the separation system 11 disposed on the path to the monitoring unit at least after the output of the optical cross-connect device 40, the wavelength is a wavelength used for the initial connection at the time of the initial connection, and is a set (instructed) wavelength after the wavelength is set to the user equipment.

In a case where the connection between the user equipment and the control unit of the PG is via the inside of the optical cross-connect device 40 (change basic configuration of PG and connection of SW to switch between connection to the control unit and connection to the opposing device), in the separation system 11 disposed on the path to at least the optical cross-connect device 40, the wavelength is a wavelength used for the initial connection at the time of the initial connection, and is a set (instructed) wavelength after the wavelength is set to the user equipment.

In a case where the connection between the user equipment and the control unit of the PG is via the monitoring unit in the preceding stage of the input of the optical cross-connect device 40, in the separation system 11 disposed on the path to the monitoring unit at least before the input of the optical cross-connect device 40, the wavelength is a wavelength used for the initial connection at the time of the initial connection, and is a set (instructed) wavelength after the wavelength is set to the user equipment.

The separation unit 21 or the detection unit 22 may communicate with the control unit of the PG. The control unit of the PG controls a wavelength (desired wavelength) set in the user device. In this case, the separation unit 21 or the detection unit 22 communicates with the control unit by using an optical signal having a wavelength used for initial connection at the time of initial connection (in a state where the wavelength is not set in the user device), and communicates with the control unit by using an optical signal having the wavelength (desired wavelength) after the wavelength is set in the user device. In this case, as described above, in a case where the wavelength set for the user device from the PG is changed, the wavelength of the optical signal used when the control unit of the PG and the separation unit 21 or the detection unit 22 communicate with each other is also changed accompanying the change.

However, the present invention is not limited to such a configuration, and the separation unit 21 or the detection unit 22 may communicate with the control unit of the PG at a wavelength different from the desired wavelength set in the user device. In a case of such a configuration, even if the wavelength set from the PG to the user device is changed, the wavelength of the optical signal used when the control unit of the PG and the separation unit 21 or the detection unit 22 communicate with each other is not changed.

Next, communication between the separation unit 21 and the control unit will be described. In a case where it is not via the wavelength-dependent device including the separation unit 21 itself, and a control signal with the separation unit 21 is not superimposed on signal light from the user equipment or is not multiplexed with light to be processed as the same wavelength as the user equipment, communication can be performed regardless of the wavelength setting for the user equipment.

In a case where it is not via the wavelength-dependent device including the separation unit 21 itself, and the control signal from the separation unit 21 is superimposed on the signal light from the user equipment, communication can be performed at a wavelength set for the user equipment (a case where the separation unit 21 blocks the wavelength other than setting from the user equipment).

In a case where it is via the wavelength-dependent device including the separation unit 21 itself, and the control signal from the separation unit 21 is not multiplexed with the light to be processed as the same wavelength as that of the user equipment without being superimposed on the signal light from the user equipment, the communication can be performed at a wavelength conducted with the control unit by the wavelength-dependent device (a case where the separation unit 21 blocks a wavelength other than the setting from the user equipment).

In a case where it is via a wavelength-dependent device including the separation unit 21 itself, and the control signal from the separation unit 21 is superimposed on the signal light from the user equipment or multiplexed with light to be processed as the same wavelength as that of the user equipment, the communication can be performed at a wavelength conducted with the control unit by the wavelength-dependent device and at a wavelength set for the user equipment (in a case where the separation unit 21 blocks a wavelength other than that set from the user equipment).

For example, in a case where the separation unit 21 does not block at least a wavelength other than the setting from the user equipment at the initial time before setting or the like, and it is not via a wavelength dependent device including the separation unit 21 itself, the communication can be performed regardless of the wavelength setting for the user equipment.

For example, in a case where the separation unit does not block at least a wavelength other than the setting from the user equipment at the initial time before setting or the like, and it is via a wavelength dependent device including the separation unit 21 itself, the communication can be performed at a wavelength conducted with the control unit by the wavelength dependent device.

For example, in a case where the separation device 20 is at the following position, in the communication to the control unit of the PG, the wavelength used for the initial connection is used at the time of the initial connection, and the set wavelength is used after the wavelength is set in the user device. In a case where the connection is made via a function (for example, a monitoring unit) located in the subsequent stage of the optical cross-connect device 40, a position up to at least a monitoring unit located in the subsequent stage of the optical cross-connect device 40. In a case of being connected via the inside of the optical cross-connect device 40, at least the position up to the optical cross-connect device 40. In a case where the connection is made via the monitoring unit on the preceding stage (user device side) of the input of the optical cross-connect device 40, at least the position to the optical cross-connect device 40 is provided.

In a case where the connection between the user equipment and the control unit of the PG is performed in the subsequent stage of the output of the optical cross-connect device 40, in the separation system 11 disposed on the path to the connection point at least after the output of the optical cross-connect device 40, the wavelength is a wavelength used for the initial connection at the time of the initial connection, and is a set (instructed) wavelength after the wavelength is set to the user equipment.

In a case where the connection between the user equipment and the control unit of the PG is performed by switching in the optical cross-connect device 40, in the separation system 11 disposed on the path to at least the optical cross-connect device 40, the wavelength is a wavelength used for the initial connection at the time of the initial connection, and is a set (instructed) wavelength after the wavelength is set to the user equipment.

In a case where the connection between the user equipment and the control unit of the PG is performed in the preceding stage of the input of the optical cross-connect device 40, in the separation system 11 disposed on the path to the connection point at least before the input of the optical cross-connect device 40, the wavelength is a wavelength used for the initial connection at the time of the initial connection, and is a set (instructed) wavelength after the wavelength is set to the user equipment.

In a case where the separation device 20 is disposed in the additional package 41, the wavelength used for the initial connection is used at the time of the initial connection, and after the wavelength is set in the user device, the wavelength set in the user device is used. Even in such a configuration, the desired wavelength may be changed before and after the setting. In that case, the wavelengths separated by the separation processing (the wavelength transmitted as proper (desired wavelength) and the wavelength filtered and detected as improper (residual wavelength)) are changed.

In FIG. 9, if the separation device 20 is installed on the second side of the blocking device 30, and the propagation delay of light from the user device from the separation device 20 to the blocking device 30 can be equal to or more than the total value of the processing time of detecting the intensity of light demultiplexed as the improper wavelength component by the separation device 20 and determining block, the propagation time of a notification needed for a notification of block from the detector to the blocking device 30, and the block processing time of the blocking device 30, it is possible to prevent the improper optical signal from flowing into the blocking device 30 and the subsequent devices.

In order to implement such prevention of inflow, for example, a configuration using a delay device may be used as follows. After the residual separation signal is detected by the detection unit 22 of the separation device 20, the optical signal or the desired separation signal may be delayed by a delay device so that the optical signal itself including the residual signal or the desired separation signal separated from the optical signal can be blocked by the blocking device 30. With such a configuration, it is possible to increase the time needed from the detection of the residual separation signal to the block control and to block the input signal and the desired separation signal related to the detected residual separation signal by the blocking device. This is particularly effective in a configuration in which the separation device 20 is located on the second side of the blocking device 30. Such a configuration example is a configuration example common to the entire first embodiment (optical cross-connect system 10a) of the optical cross-connect system 10 described above.

### Second Embodiment

FIG. 71 is a diagram illustrating a system configuration example of a second embodiment (optical cross-connect system 10b) of the optical cross-connect system 10 of the present invention. The optical cross-connect system 10b includes a separation system 11b and the optical cross-connect device 40. The separation system 11b includes the separation device 20.

The separation device 20 wavelength-separates the desired separation signal and the residual separation signal from an optical signal input to the own device. The separated desired separation signal is output to a route corresponding to the destination. The separation device 20 detects the light intensity of the separated residual separation signal. Upon detecting the residual separation signal with a predetermined light intensity or more, the separation device 20 performs predetermined notification to a predetermined device. The separation unit 21 of the separation device 20 in the second embodiment may be configured similarly to the separation unit 21 of the separation device 20 in the first embodiment. That is, any of the configurations illustrated in FIGS. 27 to 55, 59, 60, and 62 to 70 may be applied to the separation unit 21 of the separation device 20 in the second embodiment.

The optical cross-connect device 40 routes the optical signal input to the own device and outputs the optical signal from a port corresponding to a destination (to a route to which the destination device is connected).

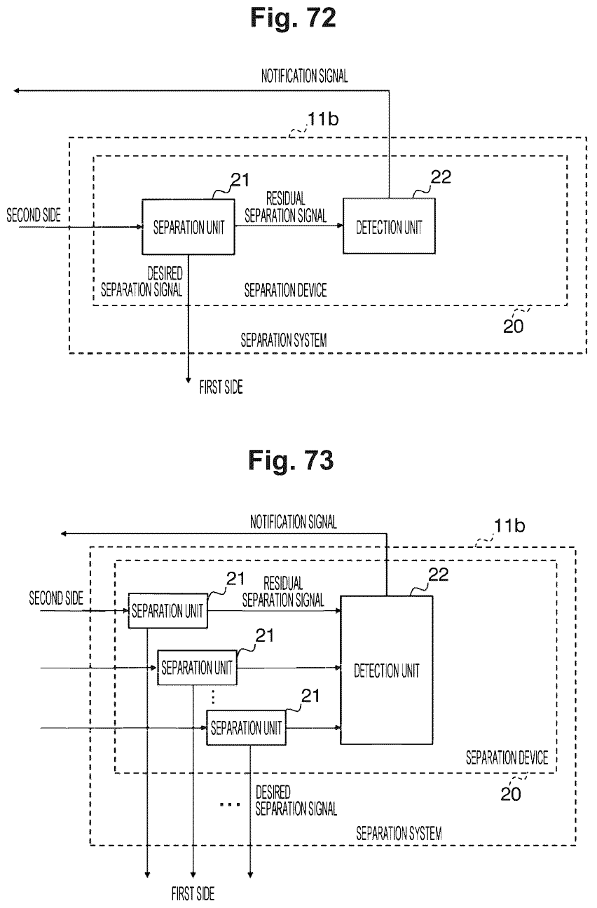

FIG. 72 is a diagram illustrating a first specific example of the configuration of the separation system 11b. The separation device 20 in the first specific example includes the separation unit 21 and the detection unit 22. The separation unit 21 may be configured using, for example, a BDF. The separation unit 21 wavelength-separates the desired separation signal and the residual separation signal from the optical signal input to the optical cross-connect system 10b. The separated desired separation signal is output to the first side.

The detection unit 22 detects the light intensity of the separated residual separation signal. Upon detecting the residual separation signal with a predetermined light intensity or more, the detection unit 22 makes a predetermined notification to a predetermined device determined in advance. For example, the notification may be made by transmitting a predetermined notification signal. More specifically, it is as follows. The detection unit 22 may make a notification to the user device or may make a notification to the user device via a separately provided controller.

The content of the notification may be an instruction indicating that the transmission is stopped, may be an instruction for correcting the wavelength (for example, information indicating the correct wavelength of the desired signal may be further included), or may be an instruction indicating initialization. When the instruction indicates initialization, the notification may further include an instruction indicating correction of the improper state at the time of initialization. The detection unit 22 may be configured to be non-reflective. In this case, the detection unit 22 may record information (log) indicating that the residual separation signal has been detected with a predetermined light intensity or higher or that the residual separation signal has been notified.

In the separation system 11b illustrated in FIG. 72, the presence or absence of the residual signal is detected instead of the ratio of the intensities of the desired signal and the residual signal. In other words, the presence or absence of the residual signal is detected on the basis of whether or not the intensity of the residual signal (in practice, the residual separation signal) exceeds the threshold. Accordingly, even if there is a configuration that detects the ratio of the intensities of the desired signal and the residual signal, the sensitivity can be further improved as compared with such a configuration. In addition, it is also possible to mount the detection unit 22 using a detector with low sensitivity. In the separation system 11b illustrated in FIG. 72, only the desired separation signal can be output.

A second specific example of the configuration of the separation system 11b will be described. The separation device 20 in the second specific example includes the separation unit 21, the detection unit 22, and the isolator 23. The separation unit 21 may be configured using, for example, a BDF. The separation unit 21 wavelength-separates the desired separation signal and the residual separation signal from the optical signal input to the optical cross-connect system 10b. The separated desired separation signal is output to the first side. The residual separation signal is input to the isolator 23.

The isolator 23 passes the optical signal flowing from the separation unit 21 to the detection unit 22 and blocks the optical signal flowing from the detection unit 22 to the separation unit 21. The detection unit 22 receives an input of the residual separation signal via the isolator 23. The detection unit 22 detects the light intensity of the input residual separation signal. Upon detecting the residual separation signal with a predetermined light intensity or more, the detection unit 22 makes a predetermined notification to a predetermined device determined in advance. For example, the notification may be made by transmitting a predetermined notification signal. In this case, the detection unit 22 may record information (log) indicating that the residual separation signal has been detected with a predetermined light intensity or more. The detection unit 22 may be configured to be non-reflective.

FIG. 73 is a diagram illustrating a third specific example of the configuration of the separation system 11b. The separation device 20 in the third specific example includes a plurality of separation units 21 and the detection unit 22. The separation unit 21 may be configured using, for example, a BDF. One of a plurality of optical signals input to the optical cross-connect system 10b is input to each separation unit 21. Each separation unit 21 wavelength-separates the desired separation signal and the residual separation signal from the input optical signal. The separated desired separation signal is output to the first side.

The detection unit 22 detects the light intensity of the separated residual separation signal. Upon detecting the residual separation signal with a predetermined light intensity or more, the detection unit 22 makes a predetermined notification to a predetermined device determined in advance. For example, the notification may be made by transmitting a predetermined notification signal. In this case, the detection unit 22 may record information (log) indicating that the residual separation signal has been detected with a predetermined light intensity or more. The detection unit 22 may be configured to be non-reflective.

A specific example of a positional relationship of each device in the second embodiment (optical cross-connect system 10b) of the optical cross-connect system 10 will be described. In any specific example, it will be described that the optical cross-connect device 40 is installed in the central office as an example, but it is similar to the first embodiment that the optical cross-connect device may be installed in other places.

For example, the separation device 20 may be installed at a position illustrated in FIGS. 9, 10, and 15. That is, the separation device 20 may be installed on the second side and at a place different from the optical cross-connect device 40 (a place other than the central office). For example, the separation device 20 may be installed at the same place as the user device (for example, in the user's home). In this case, the optical signal transmitted from the user device is first input to the separation device 20. The separation device 20 outputs the desired separation signal to the optical cross-connect device 40. The optical cross-connect device 40 receives the desired separation signal and outputs the desired separation signal from the port on the first side. Note that, in FIGS. 9, 10, and 15, the blocking device 30 is also installed, but in the second embodiment, the blocking device 30 is unnecessary.

For example, the separation device 20 may be installed at a position illustrated in FIGS. 11, 12, and 16. That is, the separation device 20 may be implemented within the additional package 41. In this case, the optical signal transmitted from the user device is first input to the optical cross-connect device 40. In particular, in this case, it is input to the upper left port. The optical cross-connect device 40 inputs the input optical signal to the additional package 41. The optical signal input to the additional package 41 is input to the separation device 20 mounted in the additional package 41. The separation device 20 outputs the desired separation signal to the optical cross-connect device 40. The desired separation signal output from the additional package 41 having the function of the separation device 20 is input to the optical cross-connect device 40. Then, the optical cross-connect device 40 outputs the desired separation signal from the port on the first side. Note that, in FIGS. 11, 12, and 16, the blocking device 30 is also installed, but in the second embodiment, the blocking device 30 is unnecessary.

For example, the separation device 20 may be installed at a position illustrated in FIGS. 13 and 17. That is, the separation device 20 may be installed on the second side and at the same place (for example, the central office) as the optical cross-connect device 40. In this case, the optical signal transmitted from the user device is first input to the separation device 20. The separation device 20 outputs the desired separation signal to the optical cross-connect device 40. The optical cross-connect device 40 receives the desired separation signal and outputs the desired separation signal from the port on the first side. Note that, in FIGS. 13 and 17, the blocking device 30 is also installed, but in the second embodiment, the blocking device 30 is unnecessary.

For example, the separation device 20 may be installed at a position illustrated in FIGS. 14 and 18. That is, the separation device 20 may be installed on the first side and at the same place (for example, the central office) as the optical cross-connect device 40. In this case, the optical signal transmitted from the user device is first input to the optical cross-connect device 40. The optical signal output from the port corresponding to the destination in the optical cross-connect device 40 is then input to the separation device 20. The separation device 20 outputs the desired separation signal to the first side. Note that, in FIGS. 14 and 18, the blocking device 30 is also installed, but in the second embodiment, the blocking device 30 is unnecessary.

### Third Embodiment

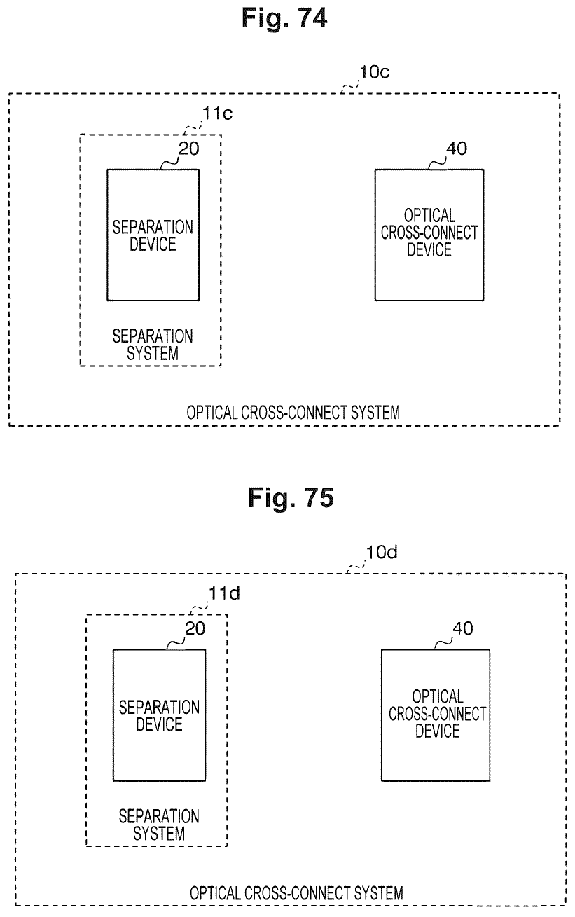

FIG. 74 is a diagram illustrating a system configuration example of a third embodiment (optical cross-connect system 10c) of the optical cross-connect system 10 of the present invention. The optical cross-connect system 10c includes a separation system 11c and the optical cross-connect device 40. The separation system 11c includes the separation device 20.

The separation device 20 wavelength-separates the desired separation signal and the residual separation signal from an optical signal input to the own device. The separated desired separation signal is output to a route corresponding to the destination. The separation device 20 detects the light intensity of the separated residual separation signal. Upon detecting the residual separation signal with a predetermined light intensity or more, the separation device 20 notifies a predetermined device of a detection result. The separation unit 21 of the separation device 20 in the third embodiment may be configured similarly to the separation unit 21 of the separation device 20 in the first embodiment. That is, any of the configurations illustrated in FIGS. 27 to 37, 39 to 55, and 68 to 70 may be applied to the separation unit 21 of the separation device 20 in the third embodiment.

The optical cross-connect device 40 routes the optical signal input to the own device and outputs the optical signal from a port corresponding to a destination (to a route to which the destination device is connected).

A first specific example of the configuration of the separation system 11c will be described. The first specific example of the configuration of the separation system 11c is similar to the configuration of FIG. 72. In FIG. 72, a notification signal is output from the detection unit 22, but in the first specific example of the configuration of separation system 11c, the detection result is output from the detection unit 22. Hereinafter, a specific description will be given.

The separation device 20 in the first specific example includes the separation unit 21 and the detection unit 22. The separation unit 21 may be configured using, for example, a BDF. The separation unit 21 wavelength-separates the desired separation signal and the residual separation signal from the optical signal input to the optical cross-connect system 10c. The separated desired separation signal is output to the first side.

The detection unit 22 detects the light intensity of the separated residual separation signal. Upon detecting the residual separation signal with a predetermined light intensity or more, the detection unit 22 notifies a predetermined device determined in advance of a detection result. For example, the notification may be performed by transmitting a predetermined notification signal including the detection result. In this case, the detection unit 22 may record information (log) indicating that the residual separation signal has been detected with a predetermined light intensity or more.

In the separation system 11c described above, the presence or absence of the intensity of the residual signal is detected instead of the ratio of the intensities of the desired signal and the residual signal. In other words, the presence or absence of the residual signal is detected on the basis of whether or not the intensity of the residual separation signal exceeds the threshold. Accordingly, the sensitivity can be further improved as compared with the configuration in which the ratio of the intensities of the desired separation signal and the residual separation signal is detected. In addition, it is also possible to mount the detection unit 22 using a detector with low sensitivity. In the separation system 11c described above, only the desired separation signal can be output.

A second specific example of the configuration of the separation system 11c will be described. The separation device 20 in the second specific example includes the separation unit 21, the detection unit 22, and the isolator 23. The separation unit 21 may be configured using, for example, a BDF. The separation unit 21 wavelength-separates the desired separation signal and the residual separation signal from the optical signal input to the optical cross-connect system 10c. The separated desired separation signal is output to the first side. The residual separation signal is input to the isolator 23.

The isolator 23 passes the optical signal flowing from the separation unit 21 to the detection unit 22 and blocks the optical signal flowing from the detection unit 22 to the separation unit 21. The detection unit 22 receives an input of the residual separation signal via the isolator 23. The detection unit 22 detects the light intensity of the input residual separation signal. Upon detecting the residual separation signal with a predetermined light intensity or more, the detection unit 22 notifies a predetermined device determined in advance of a detection result. In this case, the detection unit 22 may record information (log) indicating that the residual separation signal has been detected with a predetermined light intensity or more.

A third specific example of the configuration of the separation system 11c will be described. The third specific example of the configuration of the separation system 11c is similar to the configuration of FIG. 73. In FIG. 73, the notification signal is output from the detection unit 22, but in the third specific example of the configuration of separation system 11c, the detection result is output from the detection unit 22. Hereinafter, a specific description will be given.

The separation device 20 in the third specific example includes a plurality of separation units 21 and the detection unit 22. The separation unit 21 may be configured using, for example, a BDF. One of a plurality of optical signals input to the optical cross-connect system 10c is input to each separation unit 21. Each separation unit 21 wavelength-separates the desired separation signal and the residual separation signal from the input optical signal. The separated desired separation signal is output to the first side.

The detection unit 22 detects the light intensity of the separated residual separation signal. Upon detecting the residual separation signal with a predetermined light intensity or more, the detection unit 22 notifies a predetermined device determined in advance of a detection result. In this case, the detection unit 22 may record information (log) indicating that the residual separation signal has been detected with a predetermined light intensity or more. The detection unit 22 may be configured to be non-reflective.

The positional relationship among the devices in the third embodiment (optical cross-connect system 10c) of the optical cross-connect system 10 may be configured as in the second embodiment.

### Fourth Embodiment

FIG. 75 is a diagram illustrating a system configuration example of a fourth embodiment (optical cross-connect system 10d) of the optical cross-connect system 10 of the present invention. The optical cross-connect system 10d includes a separation system 11d and an optical cross-connect device 40. The separation system 11d includes the separation device 20.

The separation device 20 wavelength-separates the desired separation signal and the residual separation signal from an optical signal input to the own device. The separated desired separation signal is output to a route corresponding to the destination. The separation device 20 discards the separated residual separation signal. The separation unit 21 of the separation device 20 in the fourth embodiment may be configured similarly to the separation unit 21 of the separation device 20 in the first embodiment. That is, any of the configurations illustrated in FIGS. 27 to 37, 39 to 55, and 68 to 70 may be applied to the separation unit 21 of the separation device 20 in the fourth embodiment. Note that, in these drawings, the output destination of the residual separation signal is described as the detection unit 22, but in the separation device 20 according to the fourth embodiment, the output destination of the residual separation signal is the discarding unit 24 instead of the detection unit 22.

The optical cross-connect device 40 routes the optical signal input to the own device and outputs the optical signal from a port corresponding to a destination (to a route to which the destination device is connected).

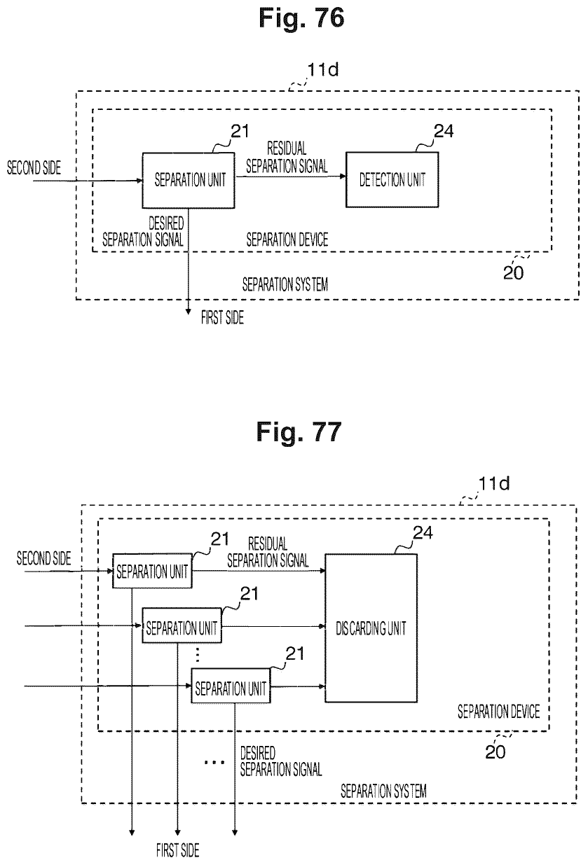

FIG. 76 is a diagram illustrating a first specific example of the configuration of the separation system 11d. The separation device 20 in the first specific example includes the separation unit 21 and the discarding unit 24. The separation unit 21 may be configured using, for example, a BDF. The separation unit 21 wavelength-separates the desired separation signal and the residual separation signal from the optical signal input to the optical cross-connect system 10d. The separated desired separation signal is output to the first side.

The discarding unit 24 discards the separated residual separation signal. In other words, the discarding unit 24 processes the separated residual separation signal so as not to be mixed in the desired separation signal. The discarding unit 24 may be configured as, for example, a non-reflection termination. The discarding unit 24 may be configured using, for example, an isolator that allows an optical signal to pass only in a direction from the separation unit 21 toward the discarding unit 24.

A second specific example of the configuration of the separation system 11d will be described. The separation device 20 in the second specific example includes the separation unit 21, the discarding unit 24, and the isolator 23. The separation unit 21 may be configured using, for example, a BDF. The separation unit 21 wavelength-separates the desired separation signal and the residual separation signal from the optical signal input to the optical cross-connect system 10d. The separated desired separation signal is output to the first side. The residual separation signal is input to the isolator 23.

The isolator 23 passes an optical signal flowing from the separation unit 21 to the discarding unit 24 and blocks the optical signal flowing from the discarding unit 24 to the separation unit 21. The discarding unit 24 receives an input of the residual separation signal via the isolator 23. The discarding unit 24 is configured using, for example, non-reflection termination. The discarding unit 24 discards the input residual separation signal.

FIG. 77 is a diagram illustrating a third specific example of the configuration of the separation system 11d. The separation device 20 in the third specific example includes the plurality of separation units 21 and the discarding unit 24. The separation unit 21 may be configured using, for example, a BDF. One of a plurality of optical signals input to the optical cross-connect system 10d is input to each separation unit 21. Each separation unit 21 wavelength-separates the desired separation signal and the residual separation signal from the input optical signal. The separated desired separation signal is output to the first side.

The discarding unit 24 discards the separated residual separation signal. The discarding unit 24 may be configured as, for example, a non-reflection termination. The discarding unit 24 may be configured using, for example, an isolator that allows an optical signal to pass only in a direction from the separation unit 21 toward the discarding unit 24.

The positional relationship among the devices in the fourth embodiment (optical cross-connect system 10d) of the optical cross-connect system 10 may be configured as in the second embodiment.

### [Modification of Multiple Ports of Second Embodiment]

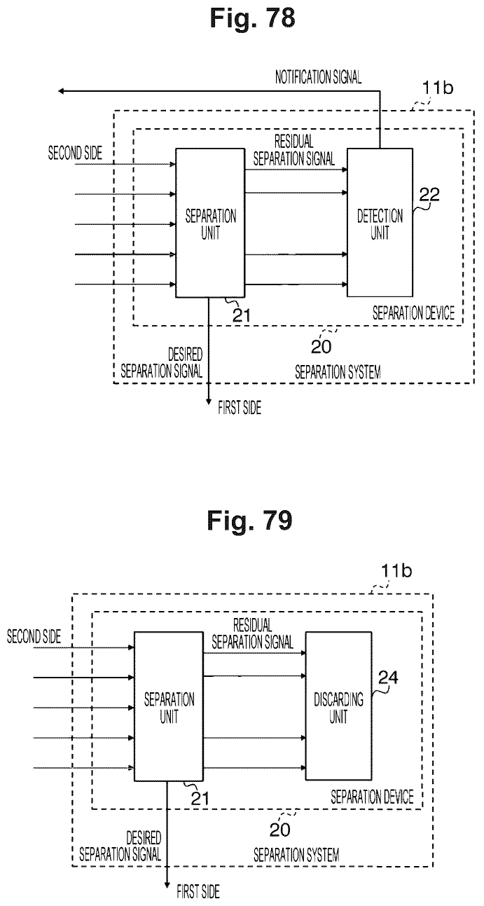

FIG. 78 is a diagram illustrating a modification of the second embodiment of the separation system 11b. The separation unit 21 may be configured using, for example, an AWG. One of a plurality of optical signals input to the optical cross-connect system 10b is input to each input port of the separation unit 21. The separation unit 21 separates the desired separation signal and the residual separation signal by executing the separation processing for wavelength-separating the desired signal and the residual signal from the plurality of input optical signals. The separated desired separation signal is output to the first side.

The detection unit 22 detects the light intensity of the separated residual separation signal. Upon detecting any of the residual separation signals with a predetermined light intensity or higher, the detection unit 22 makes a predetermined notification to a predetermined device determined in advance. For example, the notification may be made by transmitting a predetermined notification signal. More specifically, it is as follows. The detection unit 22 may make a notification to the user device or may make a notification to the user device via a separately provided controller. Since the contents of the notification are the same as those of the second embodiment, the description thereof will be omitted.

### [Modification of Multiple Ports of Third Embodiment]

The separation unit 21 including a plurality of input ports may be applied in the separation system 11c of the third embodiment. In this case, the configuration is similar to that in FIG. 78. In the third embodiment, upon detecting the residual separation signal with a predetermined light intensity or more, the detection unit 22 notifies a predetermined device determined in advance of the detection result. This point is different from the configuration illustrated in FIG. 78. Therefore, other descriptions of the third embodiment will be omitted.

### [Modification of Multiple Ports of Fourth Embodiment]

FIG. 79 is a diagram illustrating a modification of the fourth embodiment of the separation system 11d. The separation unit 21 may be configured using, for example, an AWG. One of a plurality of optical signals input to the optical cross-connect system 10d is input to each input port of the separation unit 21. The separation unit 21 separates the desired separation signal and the residual separation signal by executing the separation processing for wavelength-separating the desired signal and the residual signal from the plurality of input optical signals. The separated desired separation signal is output to the first side. The discarding unit 24 in FIG. 79 has a configuration similar to the discarding unit 24 of the fourth embodiment described above.

As described above, the embodiments of the present invention have been described in detail with reference to the drawings; however, the specific configuration is not limited to the embodiments and includes design and the like within the scope of the present invention.

### INDUSTRIAL APPLICABILITY

The present invention can be applied to optical communication.

### REFERENCE SIGNS LIST

10 Optical cross-connect system
11 Separation system
20 Separation device
21 Separation unit
22 Detection unit
23 Isolator
30 Blocking device
40 Optical cross-connect device
211 Circulator
212 FBG
213 Directional coupler
214 TFF
215 AWG
216 Multiplexing unit
217 Reflection unit
218 Waveguide-type ring resonator
219 Lattice-type optical filter
2110 PBS
91 Optical fuse
92 Optical monitor

1. A separation system comprising:
a separator that separates a first signal having a first wavelength and a second signal having a second wavelength that is a wavelength excluding the first wavelength from an input optical signal; and
a detector that detects intensity of the second signal.

2. The separation system according to claim 1, wherein when the detector detects the second signal with a predetermined intensity determined in advance or more, the detector makes a predetermined notification determined in advance to a predetermined device.

3. The separation system according to claim 1, further comprising a breaker that blocks the input optical signal or the first signal when the detector detects the second signal with a predetermined intensity determined in advance or more.

4. The separation system according to claim 1, further comprising:
a second detector that detects intensity of the input optical signal or a separated first signal, wherein
the second detector makes a predetermined notification determined in advance to a predetermined device when the second detector detects the input optical signal with a predetermined intensity determined in advance or more.

5. The separation system according to claim 1, further comprising:
a second detector that detects intensity of the input optical signal or a separated first signal, and
a breaker that blocks the input optical signal or the first signal when the second detector detects the input optical signal with a predetermined intensity determined in advance or more.

6. A separation system, comprising:
a separator that separates a first signal having a first wavelength and a second signal having a second wavelength that is a wavelength excluding the first wavelength from an input optical signal; and
a discarder that discards the second signal so as not to be mixed with the first signal.

7. The separation system according to claim 1, wherein the first wavelength is, at a time of initial connection of user equipment that is a transmission source of the optical signal, a wavelength used at the time of initial connection, and is a set wavelength after a wavelength is set for the user equipment.

8. The separation system according to claim 1, wherein the separator includes a grating or a multilayer film filter that reflects or transmits the first signal to output the first signal to a path connected to a device different from the detector or the discarder that discards the signal, and transmits or reflects the second signal to output the second signal to a path connected to the detector or the discarder.

9. The separation system according to claim 1, further comprising a grating or a multilayer film filter that transmits the first signal to output the first signal to a path connected to a device different from the detector or the discarder, and reflects the second signal to output the second signal to a path connected to the detector or the discarder.

10. The separation system according to claim 1, wherein the separator includes a grating or a multilayer film filter that outputs the first signal to a path or a port or an angle connected to a device different from the detector or the discarder and outputs the second signal to a path or a port or an angle connected to the detector or the discarder, or a diffraction grating or a spatial modulation element or an interferometric ring resonator having a different angle of a transmission or reflection wavelength according to a wavelength.

11. The separation system according to claim 1, wherein
the separator further includes a multiplexer that inputs, multiplexes, and outputs at least one of a plurality of the first signals connected to a device different from the detector or the discarder that discards the signal, or a plurality of the second signals connected to the detector or the discarder.
